(19) United States
(12) Patent Application Publication
(10) Pub. No.: US 2024/0326702 A1
(43) Pub. Date: Oct. 3, 2024

(54) CARRIER RACK REPOSITIONING MANAGEMENT

(71) Applicant: Ari B. Teman, Miami Beach, FL (US)

(72) Inventor: Ari B. Teman, Miami Beach, FL (US)

(21) Appl. No.: 18/595,354

(22) Filed: Mar. 4, 2024

Related U.S. Application Data
(60) Provisional application No. 63/450,002, filed on Mar. 4, 2023.
(60) Provisional application No. 63/450,003, filed on Mar. 4, 2023.
(60) Provisional application No. 63/450,004, filed on Mar. 4, 2023.
(60) Provisional application No. 63/451,808, filed on Mar. 13, 2023.

(51) Int. Cl. B60R 9/06; B60R 9/10; B60R 11/00

(52) U.S. Cl. CPC B60R 9/06; B60R 9/10; B60R 2011/0082; B60R 2011/0092

(57) ABSTRACT

Systems, methods, and computer-readable media for vehicle object repositioning management, including door control mechanisms, rack control mechanisms, and roof control mechanisms, are provided.

### CROSS-REFERENCE TO RELATED APPLICATION(S)

This application claims the benefit of prior filed U.S. Provisional Patent Application No. 63/450,002, filed Mar. 4, 2023, prior filed U.S. Provisional Patent Application No. 63/450,003, filed Mar. 4, 2023, prior filed U.S. Provisional Patent Application No. 63/450,004, filed Mar. 4, 2023, and prior filed U.S. Provisional Patent Application No. 63/451,808, filed Mar. 13, 2023, each of which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to object control mechanisms and, more particularly, but without limitation, to door, rack, and roof control mechanisms of a vehicle or other suitable carrier and methods for using the same.

### BACKGROUND OF THE DISCLOSURE

Conventional vehicle bike racks require the user to attach the racks, and once attached, remain visible at all times even when not in use.

### SUMMARY OF THE DISCLOSURE

This document describes systems, methods, and computer-readable media for object (e.g., door, rack, roof) control mechanisms.

As an example, a rack control mechanism is provided for connecting a bicycle rack for a vehicle to the body of the vehicle, wherein the mechanism has a closed state in which the rack is closed and hidden inside the vehicle (inside a sleeve) and an open state in which the rack is pushed out from the vehicle and expanded, the rack control mechanism including: (a) a mount to connect the rack to a piston, wherein the mount may tilt to flip the rack up or down, and wherein the rack may include one or more sets of arms, (b) arms which may be curved or bent so that bicycle wheels fit into them, and which may have slots and/or holes and/or teeth such that ratchet down arms and other accessories can attach and be moved along the arms, (c) a mount to connect the piston to the sleeve, (d) a track to guide the piston such that it pushes in/out and stops at designated points, wherein the track may be embedded into the sleeve or attached to the piston, or may be in an outer cylinder, (e) pins on the arms or on levers attached to the arms, which hit stops along the track, such that as the piston or rod reaches a certain point the pins hit stops and this causes the arms to pivot out or in, so as to open or close, and (f) a mechanism for pushing (“pushing mechanism”) out the piston, which may be an electronic linear actuator, hydraulic actuator, or magnetic propulsion, which may push the piston, or which may be attached to an additional piston which pushes the above mentioned piston via a rotating joint.

As yet another example, a rack control mechanism is provided as shown and described herein.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide a vehicle management service in accordance with some embodiments of the disclosure;

FIG. 1A is a more detailed schematic view of a subsystem of the system of FIG. 1, in accordance with some embodiments of the disclosure;

FIG. 1B is a more detailed schematic view of a portion of the system of FIG. 1, in accordance with some embodiments of the disclosure;

FIG. 1C is a more detailed schematic view of another portion of the system of FIG. 1, in accordance with some embodiments of the disclosure;

FIG. 2 is a top, left side, rear perspective view of a vehicle with an object repositioning system, in accordance with some embodiments of the disclosure;

FIG. 2A is a top, left side, rear perspective view of the vehicle of FIG. 2 in another configuration, in accordance with some embodiments of the disclosure;

FIG. 2B is a top, left side, front perspective view of the vehicle of FIG. 2 in another configuration, in accordance with some embodiments of the disclosure;

FIG. 2C is a top, left side, front perspective view of the vehicle of FIG. 2 in another configuration, in accordance with some embodiments of the disclosure;

FIG. 2D is a left side, rear perspective view of the vehicle of FIG. 2 in another configuration, in accordance with some embodiments of the disclosure;

FIG. 2E is a left side, front perspective view of the vehicle of FIG. 2 in another configuration, in accordance with some embodiments of the disclosure;

FIG. 2F is a left side, rear perspective view of the vehicle of FIG. 2 in another configuration, in accordance with some embodiments of the disclosure;

FIG. 2G is a left side, front perspective view of the vehicle of FIG. 2 in another configuration, in accordance with some embodiments of the disclosure;

FIG. 2H is a top, right side, rear perspective view of the vehicle of FIG. 2 in another configuration, in accordance with some embodiments of the disclosure;

FIG. 2I is a top, left side, rear perspective view of the vehicle of FIG. 2 in another configuration, in accordance with some embodiments of the disclosure;

FIG. 2J is a top, left side, rear perspective view of the vehicle of FIG. 2 in another configuration, in accordance with some embodiments of the disclosure;

FIG. 2K is a top, left side, rear perspective view of the vehicle of FIG. 2 in another configuration, in accordance with some embodiments of the disclosure;

FIG. 2L is a top, left side, rear perspective view of the vehicle of FIG. 2 in another configuration, in accordance with some embodiments of the disclosure;

FIG. 2M is a top, left side, rear perspective view of the vehicle of FIG. 2 in another configuration, in accordance with some embodiments of the disclosure;

FIG. 2N is a left side view of the vehicle of FIG. 2 in another configuration, in accordance with some embodiments of the disclosure;

FIG. 2O is a left side view of the vehicle of FIG. 2 in another configuration, in accordance with some embodiments of the disclosure;

FIG. 2P is a left side view of the vehicle of FIG. 2 in another configuration, in accordance with some embodiments of the disclosure;

FIG. 2Q is a left side view of the vehicle of FIG. 2 in another configuration, in accordance with some embodiments of the disclosure;

FIG. 2R is a left side view of the vehicle of FIG. 2 in another configuration, in accordance with some embodiments of the disclosure;

FIG. 2S is a left side view of the vehicle of FIG. 2 in another configuration, in accordance with some embodiments of the disclosure;

FIG. 2T is a left side view of the vehicle of FIG. 2 in another configuration, in accordance with some embodiments of the disclosure;

FIG. 2U is a left side, front perspective view of the vehicle of FIG. 2 in another configuration, in accordance with some embodiments of the disclosure;

FIG. 2V is a left side, front perspective view of the vehicle of FIG. 2 in another configuration, in accordance with some embodiments of the disclosure;

FIG. 2W is a left side, front perspective view of the vehicle of FIG. 2 in another configuration, in accordance with some embodiments of the disclosure;

FIG. 2X is a left side, front perspective view of the vehicle of FIG. 2 in another configuration, in accordance with some embodiments of the disclosure;

FIG. 2Y is a top view of a portion of the vehicle of FIG. 2 in another configuration, in accordance with some embodiments of the disclosure;

FIG. 3 is a top, left side, rear perspective view of a door repositioning actuator subsystem, in accordance with some embodiments of the disclosure;

FIG. 3A is a top, right side, rear perspective view of a portion of the door repositioning actuator subsystem of FIG. 3, in accordance with some embodiments of the disclosure;

FIG. 3B is a right side, rear perspective view of a portion of the door repositioning actuator subsystem of FIG. 3, in accordance with some embodiments of the disclosure;

FIG. 3C is a perspective view of a portion of another door repositioning actuator subsystem, in accordance with some embodiments of the disclosure;

FIG. 3D is a perspective view of a portion of yet another door repositioning actuator subsystem, in accordance with some embodiments of the disclosure;

FIGS. 3E and 3F are side views of a portion of yet another door repositioning actuator subsystem, in different configurations, in accordance with some embodiments of the disclosure;

FIG. 3G is a side view of a portion of yet another door repositioning actuator subsystem, in accordance with some embodiments of the disclosure;

FIG. 3H is a perspective view of a portion of yet another door repositioning actuator subsystem, in accordance with some embodiments of the disclosure;

FIG. 4 is a top, right side, rear perspective view of a rack repositioning actuator subsystem, in accordance with some embodiments of the disclosure;

FIG. 4A is a top, right side, front perspective view of a portion of the rack repositioning actuator subsystem of FIG. 4, in accordance with some embodiments of the disclosure;

FIG. 4B is a right side, front perspective view of a portion of the rack repositioning actuator subsystem of FIG. 4, in accordance with some embodiments of the disclosure;

FIG. 5 is a side cross-sectional view of a portion of a portion of a roof repositioning actuator subsystem, in accordance with some embodiments of the disclosure;

FIG. 5A is a side cross-sectional view of another portion of a roof repositioning actuator subsystem, in accordance with some embodiments of the disclosure; and

FIG. 6 shows perspective views of sensor/actuator packs, in accordance with some embodiments of the disclosure.

### DETAILED DESCRIPTION OF THE DISCLOSURE

Systems, methods, and computer readable media for object (e.g., door, rack, roof) control mechanisms are provided.

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

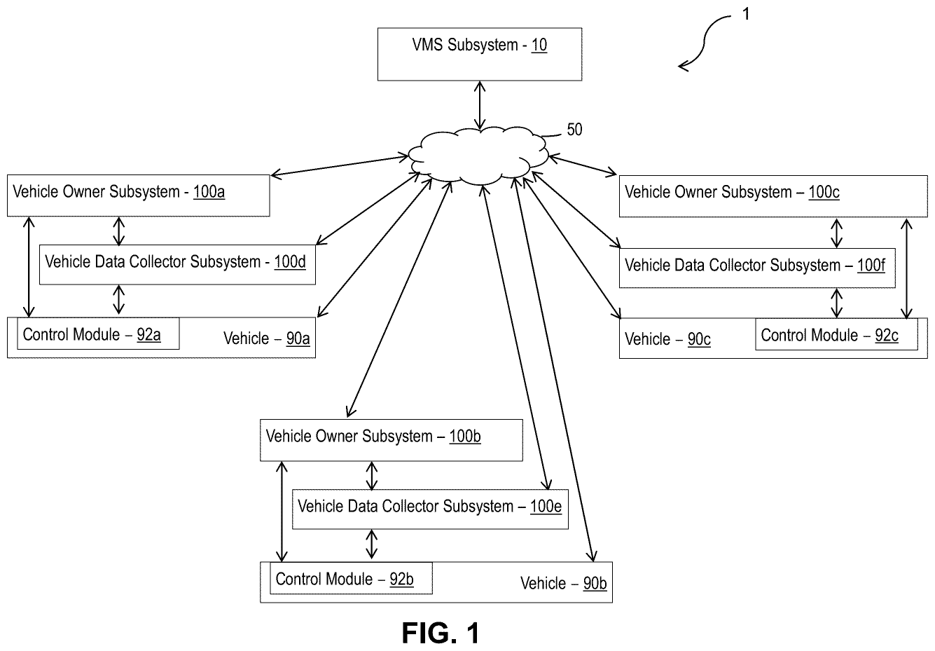

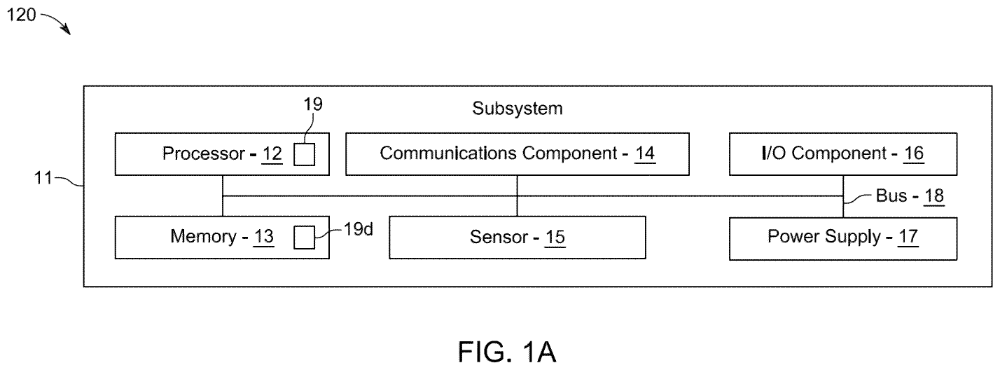

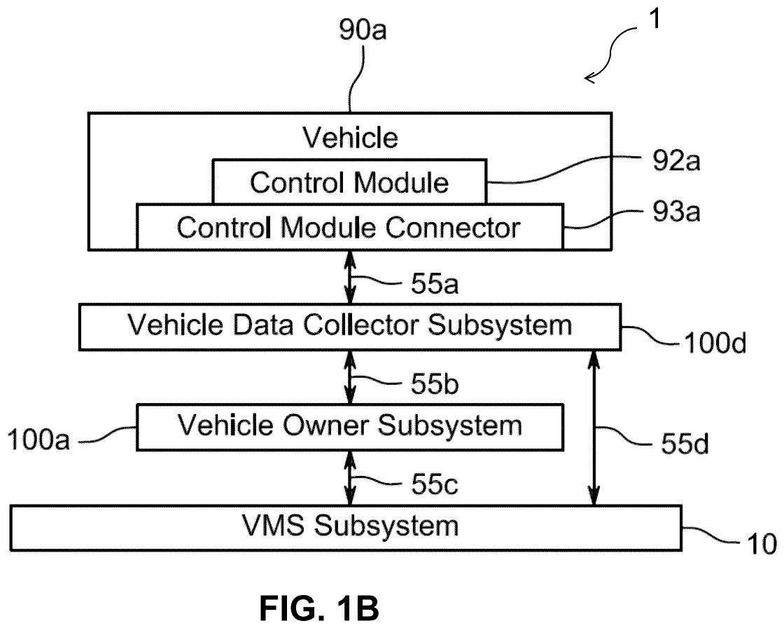

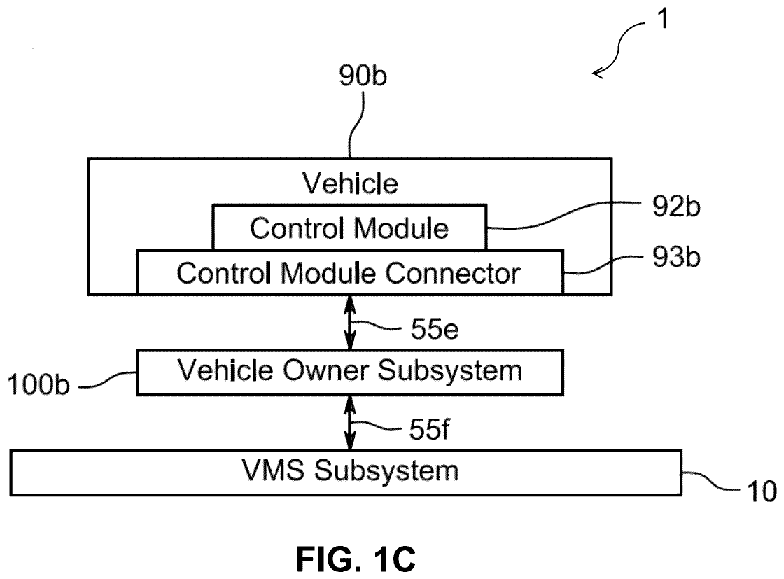

FIG. 1 is a schematic view of an illustrative system 1 in which a vehicle management service, including, but not limited to, vehicle object repositioning management (e.g., vehicle door repositioning management, vehicle rack repositioning management, vehicle roof repositioning management, etc.), vehicle sensory feedback management, and/or the like, may be facilitated amongst one or more various entities. For example, as shown in FIG. 1, system 1 may include a vehicle management service (“VMS”) subsystem 10, various subsystems 100 (e.g., one or more vehicle owner (“VO”) subsystems 100a-100c, one or more vehicle data collector (“VDC”) subsystems 100d-100f, each of which may be communicatively coupled to one or more control modules (“CMs”) or subsystems 92 of a respective vehicle 90 (e.g., CMs 92a-92c of respective vehicles 90a-90c that may be owned or operated or managed or controlled by passengers or owners of respective vehicle owner subsystems 100a-100c), and at least one communications network 50 through which any two or more of the subsystems 10, 92, and 100 may communicate. VMS subsystem 10 may be operative to interact with any of the various subsystems 92 and 100, and/or any two or more subsystems 92 and 100 may be operative to interact with each other, to provide a vehicle management service platform (“VMSP”) that may facilitate various vehicle management services, including, but not limited to, managing and enhancing the vehicle utilization process for vehicle owners, users, buyers, sellers, and/or the like for enabling effective, efficient, safe, and enjoyable vehicle utilization (e.g., vehicle door repositioning management, vehicle rack repositioning management, vehicle roof repositioning management, vehicle sensory feedback management, etc.).

As shown in FIG. 1A, and as described in more detail below, a subsystem 120, which may be exemplary of any one, some, or each of subsystem 10, subsystem 92a-92c, and/or subsystem 100a-100f, may include a processor component 12, a memory component 13, a communications component 14, a sensor component 15, an input/output (“I/O”) component 16, a power supply component 17, and/or a bus 18 that may provide one or more wired or wireless communication links or paths for transferring data and/or power to, from, or between various other components of subsystem 120. In some embodiments, one or more components of subsystem 120 may be combined or omitted. Moreover, subsystem 120 may include other components not combined or included in FIG. 1A and/or several instances of the components shown in FIG. 1A. For the sake of simplicity, only one of each of the components of subsystem 120 is shown in FIG. 1A.

I/O component 16 may include at least one input component (e.g., button, mouse, keyboard, etc.) to receive information from a user or other device or power therefrom and/or at least one output component (e.g., audio speaker, video display, haptic component, lighting element, olfactory output component, movement actuator, etc.) to provide information or power or any other suitable support to a user or other device, such as a touch screen that may receive input information through a user's touch of a display screen and that may also provide visual information to a user via that same display screen, a vehicle door repositioning management system that may be used to control and/or carry out the movement of one or more vehicle doors or other components (e.g., actuators, controllers, gears, etc.), a vehicle rack repositioning management system that may be used to control and/or carry out the movement of one or more vehicle racks or other components (e.g., actuators, controllers, gears, etc.), a vehicle roof repositioning management system that may be used to control and/or carry out the movement of one or more vehicle roofs or other components (e.g., actuators, controllers, gears, etc.), a vehicle sensory feedback management system, and/or the like. In some embodiments, an I/O component 16 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like.

Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., data 19d)).

Communications component 14 may be provided to allow subsystem 120 to communicate with one or more other subsystems 120 (e.g., any communication to/from/between subsystem(s) 10, 92, and 100 of system 1) using any suitable communications protocol(s).

Communications component 14 can be operative to create or connect to a communication network or link of a network. Communications component 14 can provide wireless communications using any suitable short-range or long-range communications protocol, such as Wi-Fi (e.g., an 802.11 protocol), Bluetooth, ultra-wideband, radio frequency systems (e.g., 1200 MHz, 2.4 GHz, and 5.6 GHz communication systems), near field communication (“NFC”), infrared, protocols used by wireless and cellular telephones and personal e-mail devices, or any other protocol supporting wireless communications. Communications component 14 can also be operative to connect to a wired communications link or directly to another data source wirelessly or via one or more wired connections or other suitable connection type(s). Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 15 may be any suitable sensor that may be configured to sense any suitable data for subsystem 120 (e.g., location-based data via a GPS (“Global Positioning System”) sensor system, motion data, environmental data, biometric data, etc.). Sensor 15 may be a sensor assembly that may include any suitable sensor or any suitable combination of sensors operative to detect movements of subsystem 120 and/or of any user thereof and/or any other characteristics of subsystem 120 and/or of its environment (e.g., physical activity or other characteristics of a user of subsystem 120, light content of the environment of subsystem 120, gas content of the environment of subsystem 120, noise content of the environment of subsystem 120, altitude of subsystem 120, speed of subsystem 120, etc.). Sensor 15 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 15 may include any suitable sensor components or subassemblies for detecting any suitable movement of subsystem 120 and/or of a user thereof. For example, sensor 15 may include one or more three-axis acceleration motion sensors (e.g., an accelerometer) that may be operative to detect linear acceleration in three directions (i.e., the Y- or left/right direction, the Z- or up/down direction, and the X- or forward/backward direction). As another example, sensor 15 may include one or more single-axis or two-axis acceleration motion sensors that may be operative to detect linear acceleration only along each of the Y- or left/right direction and the Z- or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to directly or indirectly detect rotation, rotational movement, angular displacement, tilt, position, orientation, motion along a non-linear (e.g., arcuate) path, or any other non-linear motions. Additionally or alternatively, sensor 15 may include one or more angular rate, inertial, and/or gyro-motion sensors or gyroscopes for detecting rotational movement. For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 15 for detecting motion on subsystem 120, such as any suitable pressure sensors, altimeters, or the like. Using sensor 15, subsystem 120 may be configured to determine a velocity, acceleration, orientation, and/or any other suitable motion attribute of subsystem 120 (e.g., a direction and/or strength of an impact (e.g., a crash involving a vehicle 90). One or more biometric sensors may be multi-modal biometric sensors and/or operative to detect long-lived biometrics, modern liveness (e.g., active, passive, etc.) biometric detection, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial or gait) recognition sensor, which may operate in conjunction with a feature-processing application that may be accessible to subsystem 120 for attempting to authenticate a user), line-in connector for data and/or power, and/or combinations thereof. In some examples, each sensor can be a separate device, while, in other examples, any combination of two or more of the sensors can be included within a single subsystem or device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single subsystem or device. Subsystem 120 can further include a timer that can be used, for example, to add time dimensions to various attributes of any detected element(s). Sensor 15 may include any suitable sensor components or subassemblies for detecting any suitable characteristics of any suitable condition of the lighting of the environment of subsystem 120. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 120 (e.g., in lux or lumens per square meter, etc.) and/or for determining the ambient color or white point chromaticity of ambient light in the environment of subsystem 120 (e.g., in hue and colorfulness or in x/y parameters with respect to an x-y chromaticity space, etc.) and/or for determining the UV index or UV radiation in the environment of subsystem 120 (e.g., in UV index units, etc.). Sensor 15 may include any suitable sensor components or subassemblies for detecting any suitable characteristics of any suitable condition of the air quality of the environment of subsystem 120. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 120 (e.g., in O₂% per liter, etc.) and/or for determining the air velocity of the ambient air in the environment of subsystem 120 (e.g., in kilograms per second, etc.) and/or for determining the level of any suitable gas or potentially harmful substance (e.g., VOC (e.g., any suitable gasses, scents, odors, etc.) or particulate or dust or pollen or mold or the like) of the ambient air in the environment of subsystem 120 (e.g., in HG % per liter, etc.) and/or for determining the humidity of the ambient air in the environment of subsystem 120 (e.g., in grams of water per cubic meter, etc. (e.g., using a hygrometer)) and/or for determining the temperature of the ambient air in the environment of subsystem 120 (e.g., in degrees Celsius, etc. (e.g., using a thermometer)). Sensor 15 may include any suitable sensor components or subassemblies for detecting any suitable characteristics of any suitable condition of the sound quality of the environment of subsystem 120. For example, sensor 15 may include any suitable sound quality sensor that may include, but is not limited to, one or more microphones or the like that may determine the level of sound pollution or noise in the environment of subsystem 120 (e.g., in decibels, etc.). Sensor 15 may also include any other suitable sensor for determining any other suitable characteristics about a user of subsystem 120 and/or the environment of subsystem 120 and/or any situation within which subsystem 120 may exist. For example, any suitable clock and/or position sensor(s) may be provided to determine the current time and/or time zone within which subsystem 120 may be located. Sensor 15 may be embedded in a body (e.g., housing 11) of subsystem 120, such as along a bottom surface that may be operative to contact a user, or can be positioned at any other desirable location. In some examples, different sensors can be placed in different locations inside or on the surfaces of subsystem 120 (e.g., some located inside housing 11 (e.g., any suitable component of a vehicle (e.g., along an interior and/or exterior surface of a vehicle door, roof, rack and/or the like)), some coupled to or otherwise provided by an attachment mechanism (e.g., a wrist band coupled to a housing of a wearable device), and/or the like). In other examples, one or more sensors can be worn by a user separately as different parts of a single subsystem 120 or as different subsystems or devices. In such cases, the sensors can be configured to communicate with subsystem 120 using a wired and/or wireless technology (e.g., via communications component 14). In some examples, sensors can be configured to communicate with each other and/or share data collected from one or more sensors.

Power supply 17 can include any suitable circuitry for receiving and/or generating power, and for providing such power to one or more of the other components of subsystem 120. For example, power supply assembly 17 can be coupled to a power grid (e.g., when subsystem 120 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 120 is acting as a portable device). Subsystem 120 may also be provided with a housing 11 that may at least partially enclose one or more of the components of subsystem 120 for protection from debris and other degrading forces external to subsystem 120. Each component of subsystem 120 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 120 may include other components not combined or included in those shown or several instances of the components shown.

Processor 12 may be used to run one or more applications, such as an application 19 that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem), application programming interfaces (“APIs”), software development kits (“SDKs”), proprietary applications (e.g., a web application or a native application) for enabling subsystem 120 to interact with an online service and/or one or more other subsystems and/or the like, which may include applications for routing protocols, SDN modules based on OpenFlow, P4, or other network data plane programming standards, machine learning algorithms, network management functions, etc., any other suitable applications, such as applications for detecting and reacting to and/or adjusting the positioning of components (e.g., doors, roofs, racks, etc.) of and within a vehicle (e.g., to adjust the position of any vehicle feature (e.g., door, roof, rack, etc.)), applications for detecting and reacting to communicative coupling to/decoupling from any suitable portable media device, applications for detecting and reacting to certain vehicle conditions (e.g., safety conditions, such as an object being in the path of a door or rack or roof, occupancy conditions, such as a rack not supporting any objects (e.g., as may be determined by an occupation classification system), movement conditions, such as the vehicle not moving (e.g., as may be determined by a vehicle speedometer), and/or the like), and/or the like. For example, processor 12 may load an application 19 as an interface program to determine how instructions or data received via an input component of I/O component 16 or other component of subsystem 120 (e.g., sensor 15 and/or communications component 14) may manipulate the way in which information may be stored (e.g., in memory 13) and/or provided via an output component of I/O component 16 (e.g., presented to a user on a display or actuator manipulation to adjust the position of any suitable component (e.g., door, roof, rack, etc.)) and/or communicated to another system device via communications component 14. As one example, application 19 may be firmware. As another example, application 14 may be a third party application that may be running on subsystem 120 (e.g., an application associated with the network of system 1) that may be loaded on subsystem 120 in any suitable manner, such as via an application market (e.g., using communications component 14), such as the Apple App Store or Google Play, or that may be accessed via an internet application or web browser (e.g., by Apple Safari or Google Chrome) that may be running on subsystem 120 and that may be pointed to a uniform resource locator (“URL”) whose target or web resource may be managed by or otherwise affiliated with any suitable entity. Any subsystem may include any suitable special purpose hardware (e.g., hardware support of high-speed packet processing, hardware support of machine learning algorithms, etc.).

Subsystem 120 may be any portable, mobile, wearable, implantable, or hand-held electronic device configured to operate with system 1. Alternatively, subsystem 120 may not be portable during use, but may instead be generally fixed (e.g., permanently coupled to a vehicle or in a server center or the like). Subsystem 120 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device, boom box, modem, router, printer, kiosk, beacon, server, object (e.g., door, roof, rack) repositioning management system, and any combinations thereof.

In some embodiments, processor 12 may be used to run one or more applications that may be accessible from memory 13 and/or from any other suitable source (e.g., an application from VMS subsystem 10 via an active internet connection or otherwise at and for use by a subsystem 100). Such an application may include, but is not limited to, one or more operating system applications, firmware applications, communication applications, internet browsing applications (e.g., for interacting with a website provided by VMS subsystem 10 for enabling a subsystem 92 or 100 to interact with an online service of VMS subsystem 10 (e.g., a VMSP)), VMS applications (e.g., a web application or a native application or a hybrid application that may be at least partially produced by VMS subsystem 10 for enabling a subsystem 92 or 100 to interact with an online service of VMS subsystem 10 (e.g., a VMSP)), or any other suitable applications. As one example, an application of a subsystem 100 may provide a user or a communicatively coupled device (e.g., control module 92) with the ability to interact with a vehicle management service or the VMSP of VMS subsystem 10, where such an application may be a third party application that may be running on a subsystem 100 (e.g., an application (e.g., software and/or firmware) associated with VMS subsystem 10 that may be loaded on subsystem 100 from VMS subsystem 10 or via an application market) and/or that may be accessed via an internet application or web browser running on subsystem 100 (e.g., processor 12) that may be pointed to a uniform resource locator (“URL”) whose target or web resource may be managed by VMS subsystem 10 or any other remote subsystem. One, some, or each subsystem 100 may be a portable media device (e.g., a smartphone), a laptop computer, a tablet computer, a desktop computer, an appliance, a wearable electronic device, a virtual reality device, a dongle device, at least one web or network server (e.g., for providing an online resource, such as a website or native online application, for presentation on one or more other subsystems) with an interface for an administrator of such a server, and/or the like.

Some or all portions of VMS subsystem 10 may be operated, managed, or otherwise at least partially controlled by an entity (e.g., administrator) responsible for providing a vehicle management service to one or more clients or other suitable entities. VMS subsystem 10 may communicate with one or more subsystems 100 via communications network 50. Network 50 may be the internet or any other suitable network, such that when intercoupled via network 50, any two subsystems of system 1 may be operative to communicate with one another (e.g., a subsystem 92 or 100 may access information (e.g., from an application 19 or data 19d of VMS subsystem 10, as may be provided as a vehicle management service via processor 12 and communications component 14 of VMS subsystem 10) as if such information were stored locally at that subsystem (e.g., in its memory component 13)).

Various clients and/or partners may be enabled to interact with VMS subsystem 10 for enabling the vehicle management services and the VMSP. For example, at least one vehicle owner subsystem of system 1 (e.g., each one of the one or more vehicle owner subsystems 100a-100c) may be any suitable subsystem (e.g., portable computer and/or infotainment or other suitable device that may be fixed or removably coupled to a vehicle for use by its passenger(s)) operated by any suitable vehicle owner (“VO”) that may own, rent, or otherwise have access to (e.g., appropriately use) a vehicle (e.g., a respective one of the one or more vehicles 90a-90c (e.g., any suitable motor vehicle (e.g., car, truck, bus, motorcycle, etc.), railed vehicle (e.g., train, tram, etc.), watercraft (e.g., ship, boat, jet ski, etc.), aircraft (e.g., airplane, helicopter, drone, etc.), hover vehicle, spacecraft, a drone (e.g., a multirotor drone), and/or the like)). At least one vehicle data collector subsystem of system 1 (e.g., each one of the one or more vehicle data collector subsystems 100d-100f) may be any suitable subsystem (e.g., dongle device) that may be communicatively coupled to a respective vehicle owner subsystem (e.g., via a network 50) and to a respective control module (e.g., via direct installation) of a respective vehicle (e.g., VDC subsystem 100d may be communicatively coupled to VO subsystem 100a and to CM 92a of vehicle 90a that may be owned by the operator of VO subsystem 100a, VDC subsystem 100e may be communicatively coupled to VO subsystem 100b and to CM 92b of vehicle 90b that may be owned by the operator of VO subsystem 100b, and VDC subsystem 100f may be communicatively coupled to VO subsystem 100c and to CM 92c of vehicle 90c that may be owned by the operator of VO subsystem 100c). For example, a VDC subsystem may be any suitable on-board diagnostics (“OBD”) device that may be operative to be communicatively coupled with any suitable control module of any suitable vehicle (e.g., via any suitable OBD-II data link connector of a vehicle (e.g., via a physical connection or wireless path)) that may be operative to monitor any suitable data from an engine control unit and/or electronic control unit (“ECU”) of the vehicle and/or from any other data source of the vehicle that may be made available (e.g., according to the OBD protocol), such as a powertrain control module (“PCM”) or otherwise. A VDC subsystem may be operative to send one or more requests to the CM of a vehicle for one or more specific parameters using one or more specific parameter identification numbers (“PIDs”) (e.g., according to the Society of Automotive Engineers (“SAE”) standard J1979) and then the VDC subsystem may communicate any received parameter data from the vehicle to a VO subsystem that may be communicatively coupled to the VDC subsystem (e.g., via any suitable wired or wireless communication protocol). For example, as shown in FIG. 1B, VDC subsystem 100d may be communicatively coupled to any suitable control module connector 93a via any suitable communications path 55a, which may be a direct physical connection between connector 93a and a connector of VDC subsystem 100d (e.g., a male connector of an I/O component 16 of VDC subsystem 100d may physically mate with a female control module connector 93a (e.g., any suitable OBD-II data link connector)) or any suitable wireless connection, where control module connector 93a may be communicatively coupled to one, some, or all suitable control modules or data sources (e.g., control module 92a) of vehicle 90a, while VDC subsystem 100d may be communicatively coupled to VO subsystem 100a via any suitable communications path 55b (e.g., any suitable wired or wireless communications path using any suitable communications protocol (e.g., Bluetooth between a communications component 14 of VDC subsystem 100d and a communications component 14 of VO subsystem 100a)), while VO subsystem 100a may be communicatively coupled to VMS subsystem 10 via any suitable communications path 55c (e.g., any suitable wired or wireless communications path (e.g., of network 50 of FIG. 1) using any suitable communications protocol). Alternatively or additionally, as shown in FIG. 1B, VDC subsystem 100d may be communicatively coupled to VMS subsystem 10 via any suitable communications path 55d (e.g., any suitable wired or wireless communications path (e.g., of network 50 of FIG. 1) using any suitable communications protocol (e.g., any suitable long-range communications protocol between a communications component 14 of VDC subsystem 100d and a communications component 14 of VMS subsystem 10 (e.g., using a low power communications component and/or any suitable telemetry functionality)) without VO subsystem 100a as an intermediary). Additionally or alternatively, in some embodiments, a VO subsystem may be configured to communicate directly with a CM of a vehicle without the need for a distinct intermediary VDC subsystem. For example, as shown in FIG. 1C, VO subsystem 100b may be communicatively coupled to any suitable control module connector 93b via any suitable communications path 55e, which may be a direct wired connection between connector 93b and a connector of VO subsystem 100b (e.g., a connector of an I/O component 116 of VO subsystem 100b may be communicatively coupled to a first connector of a cable of communications path 55e and a second connector of such a cable may be communicatively coupled with control module connector 93b (e.g., any suitable OBD-II data link connector)) or any suitable wireless path, where control module connector 93b may be communicatively coupled to one, some, or all suitable control modules or data sources (e.g., control module 92b) of vehicle 90b, while VO subsystem 100b may be communicatively coupled to VMS subsystem 10 via any suitable communications path 55f (e.g., any suitable wired or wireless communications path (e.g., of network 50 of FIG. 1) using any suitable communications protocol). In some embodiments, communications path 55e may be a wireless communications path between control module 92b and VO subsystem 100b (e.g., a wireless (e.g., Bluetooth) communication path between a communications component 14 of VO subsystem 100b and a communications component of control module 92b of vehicle 90b), such that a data connection may be facilitated directly between a user's portable electronic device and a computer of a vehicle directly through a wireless connection.

Each subsystem 92 and 100 of system 1 (e.g., each one of subsystems 92a-92c and 100a-100f) may be operated by any suitable entity for interacting in any suitable way with VMS subsystem 10 (e.g., via network 50) for deriving value from and/or adding value to a service of the VMSP of VMS subsystem 10. For example, a particular subsystem 100 may be a server operated by a client/partner entity that may receive any suitable data from VMS subsystem 10 related to any suitable vehicle management enhancement of the VMSP provided by VMS subsystem 10 (e.g., via network 50). Additionally or alternatively, a particular subsystem 100 may be a server operated by a client/partner entity that may upload or otherwise provide any suitable data to VMS subsystem 10 related to any suitable vehicle management service of the VMSP provided by VMS subsystem 10 (e.g., via network 50).

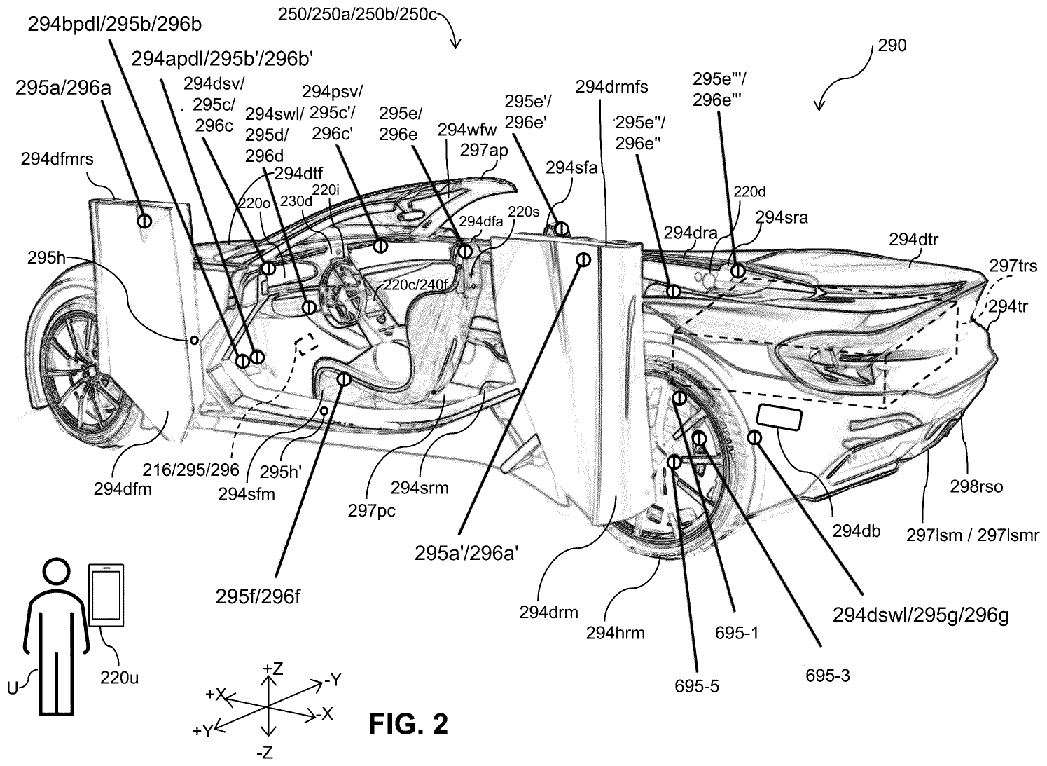

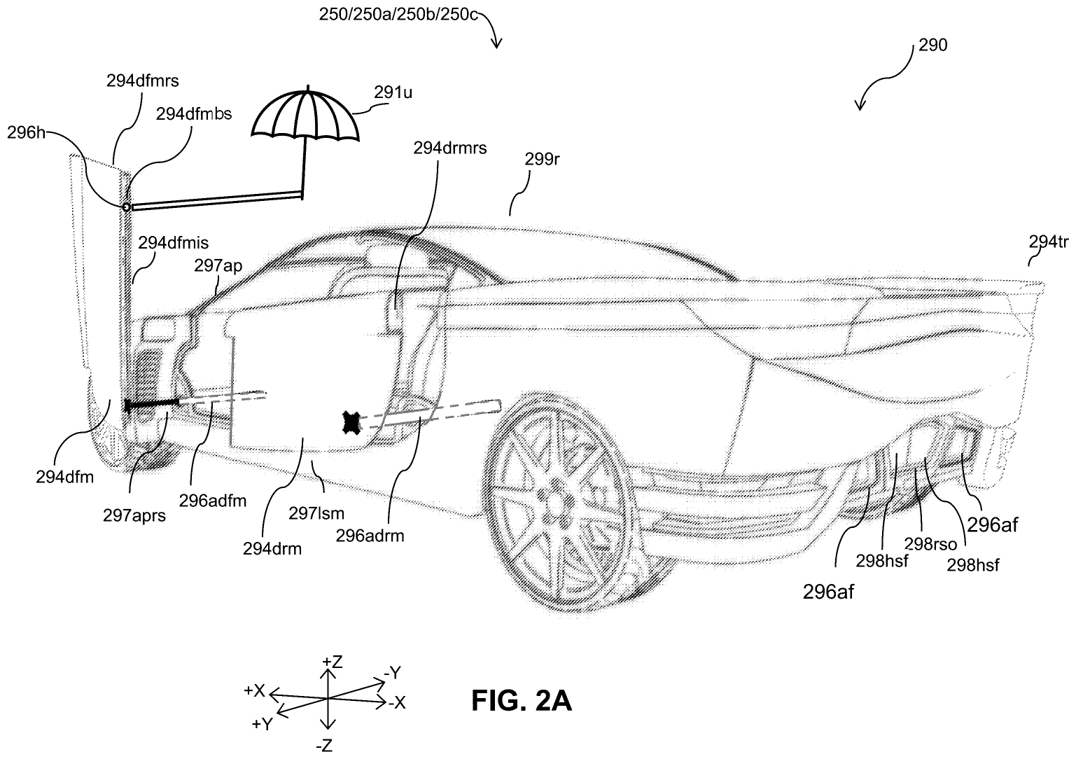

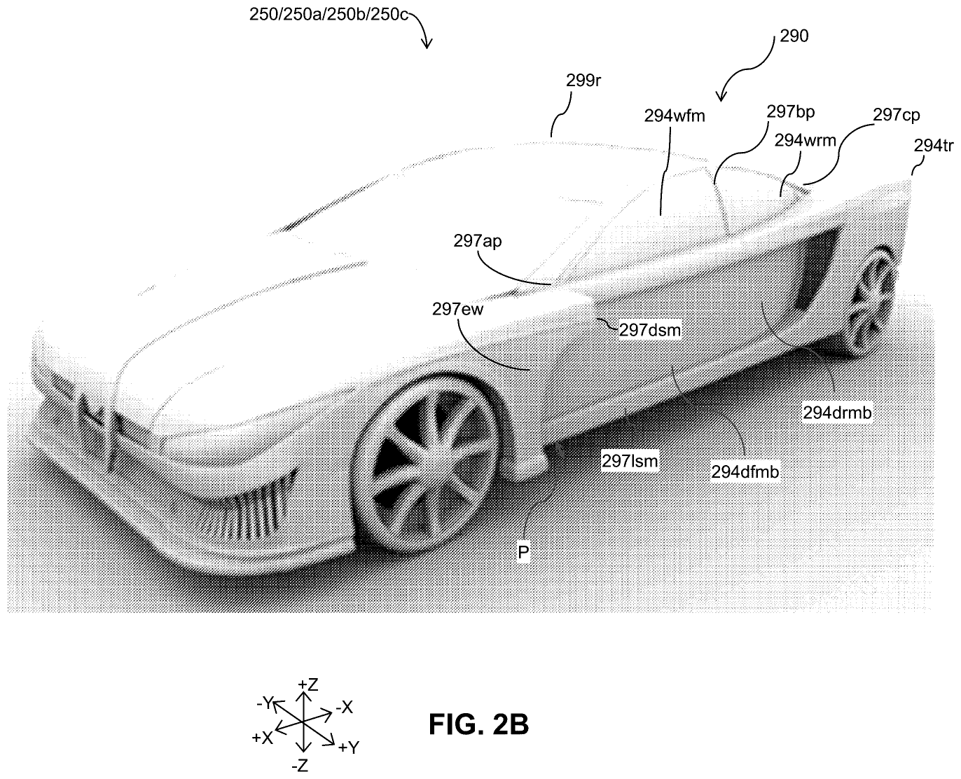

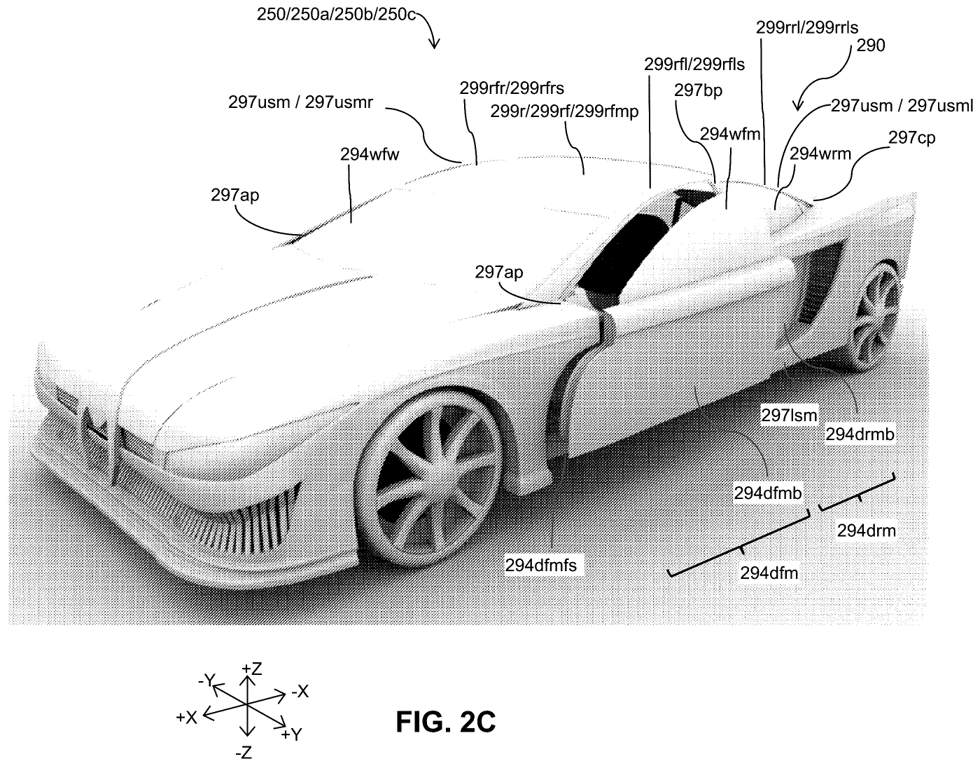

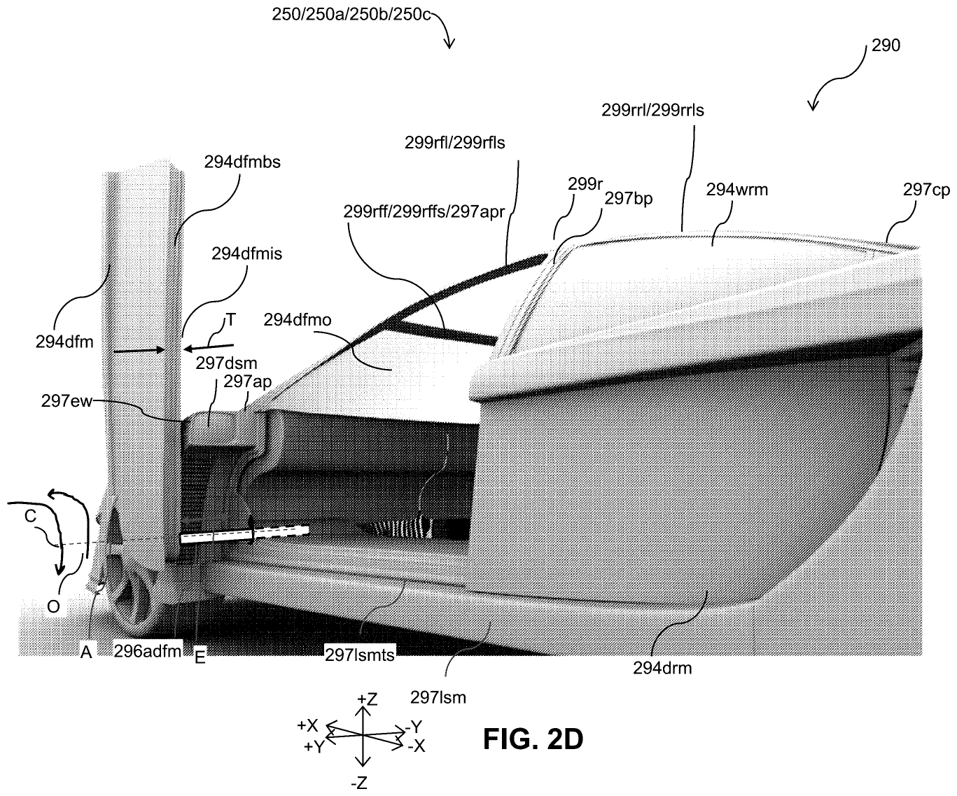

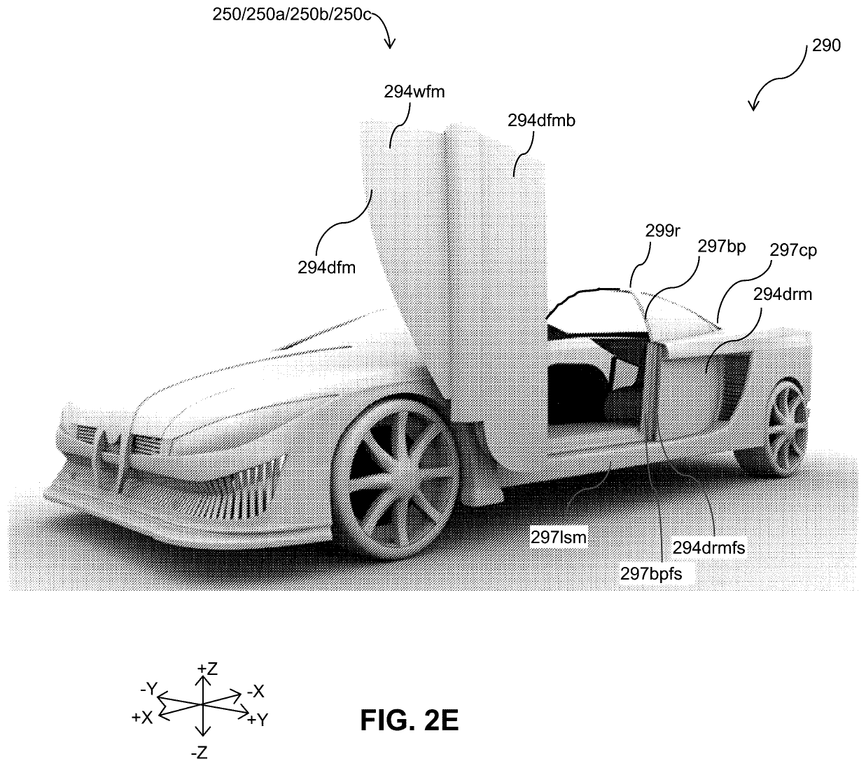

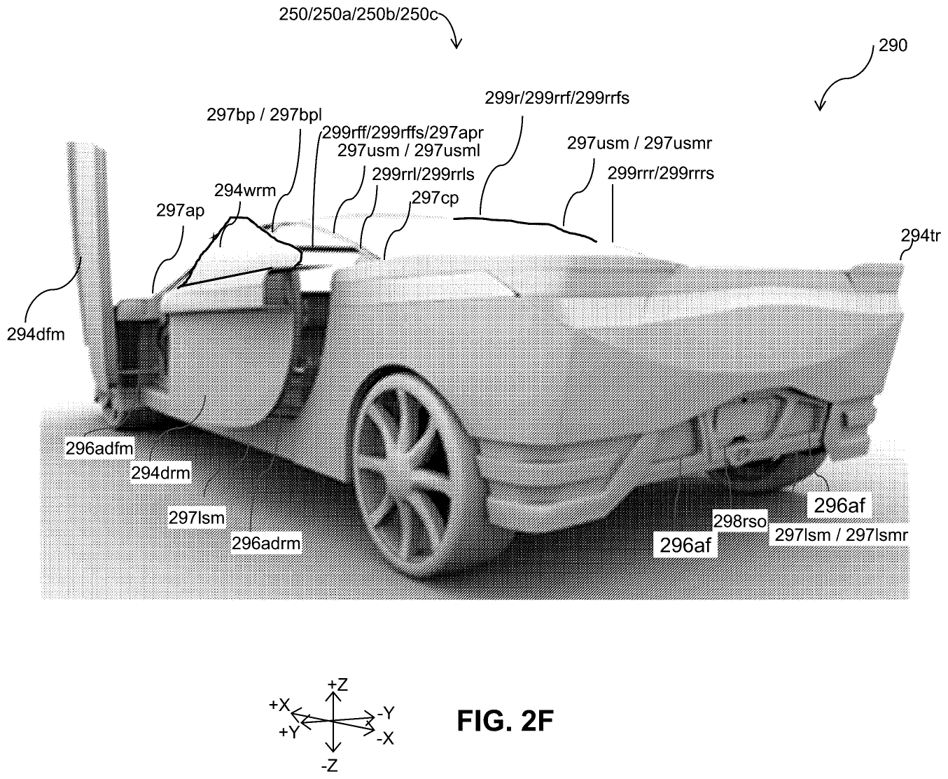

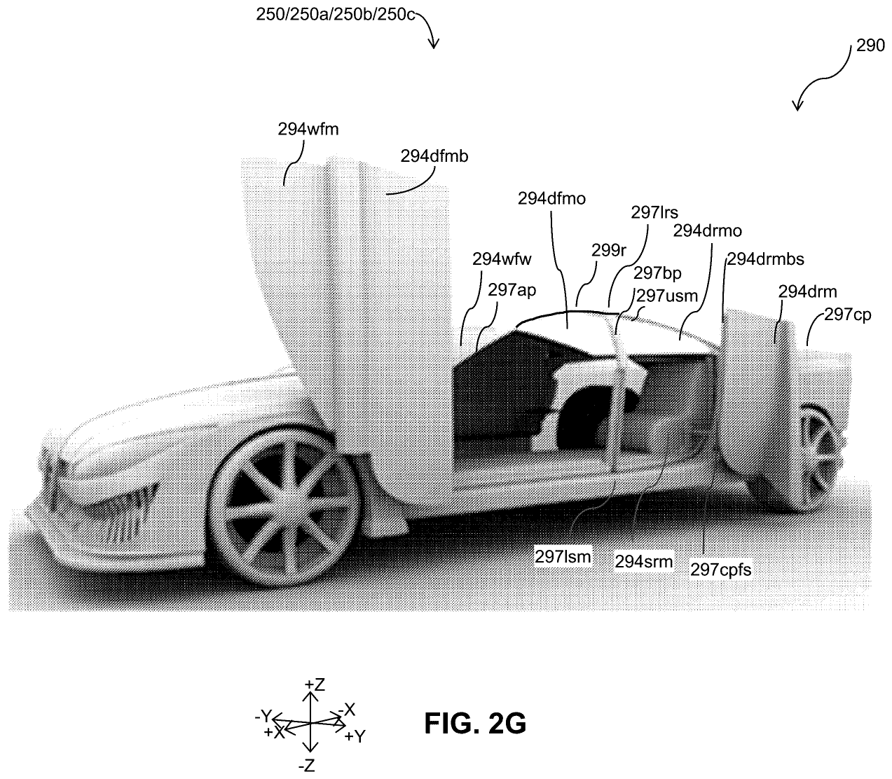

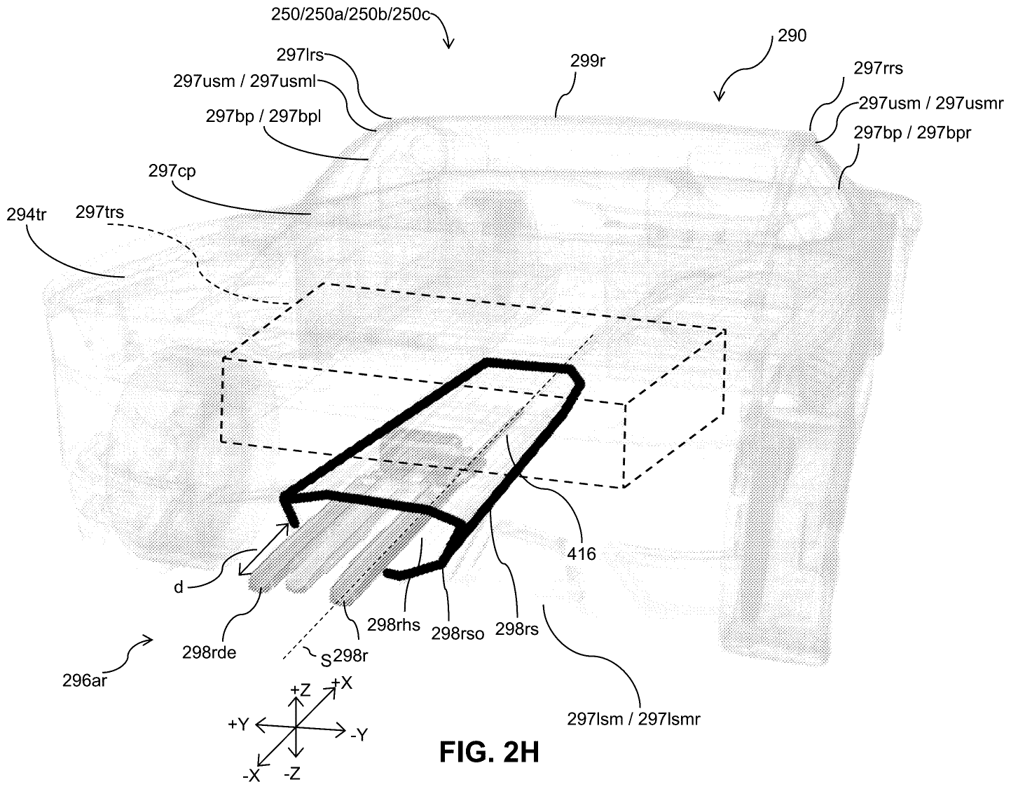

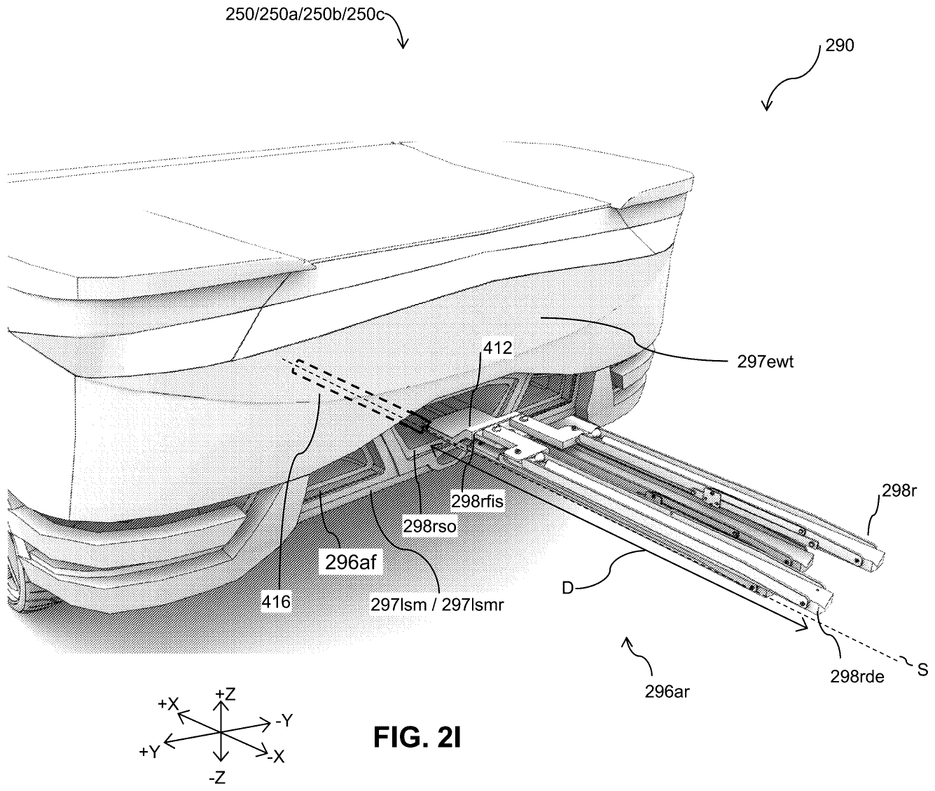

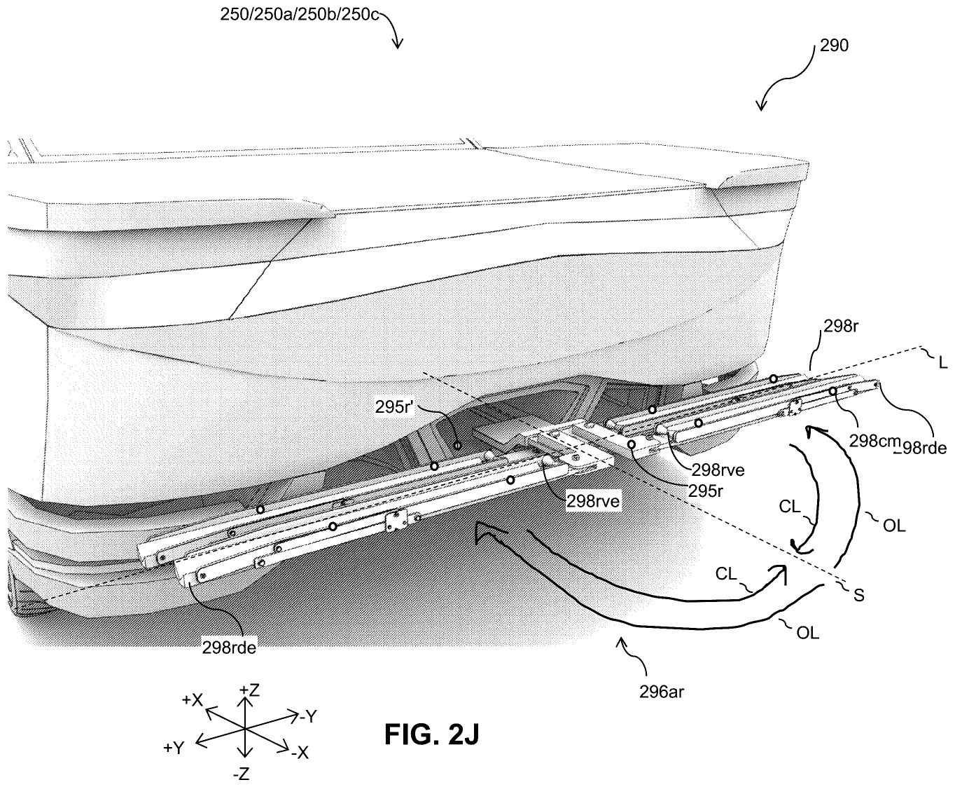

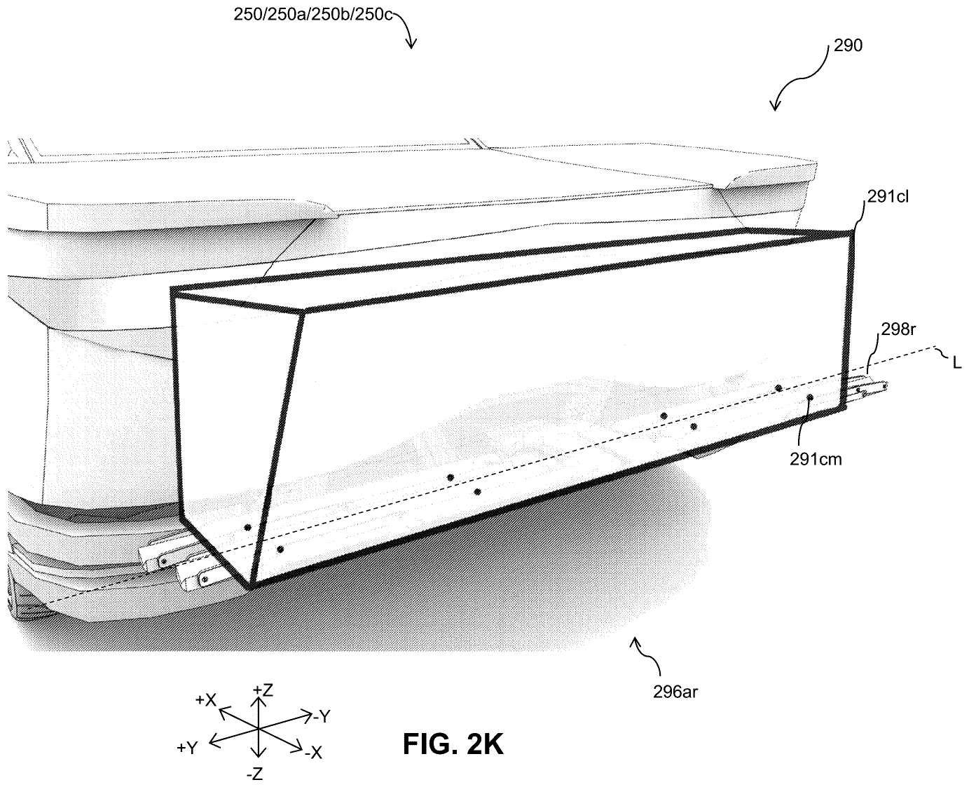

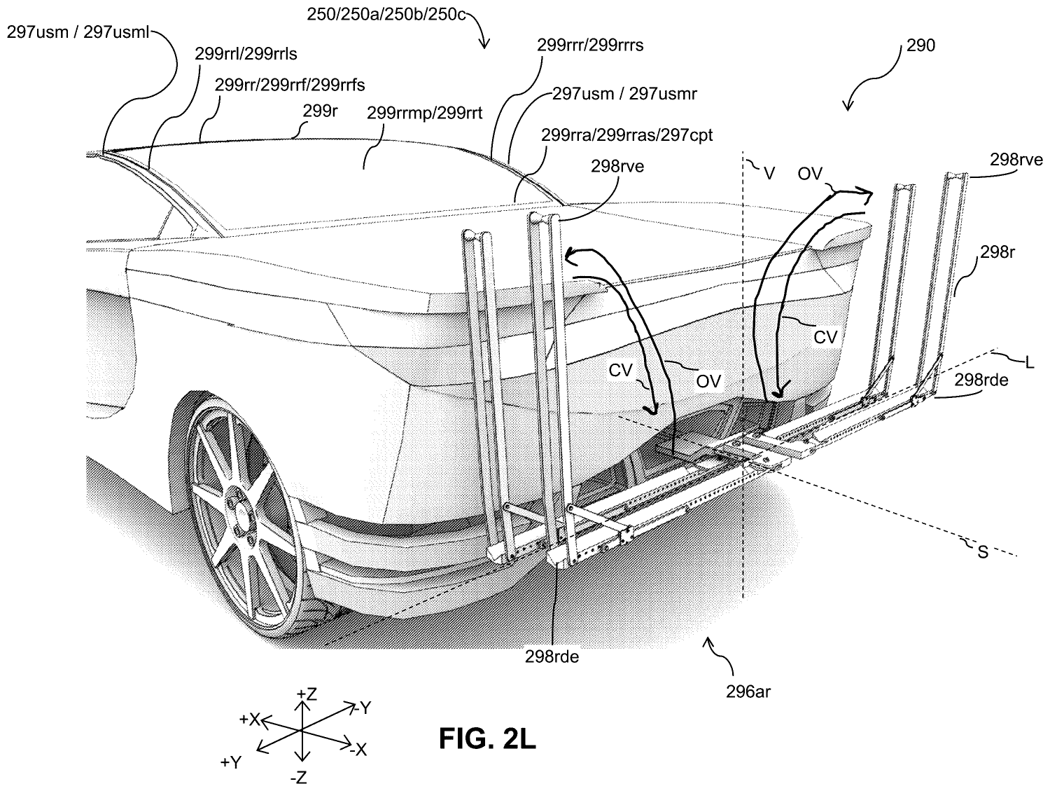

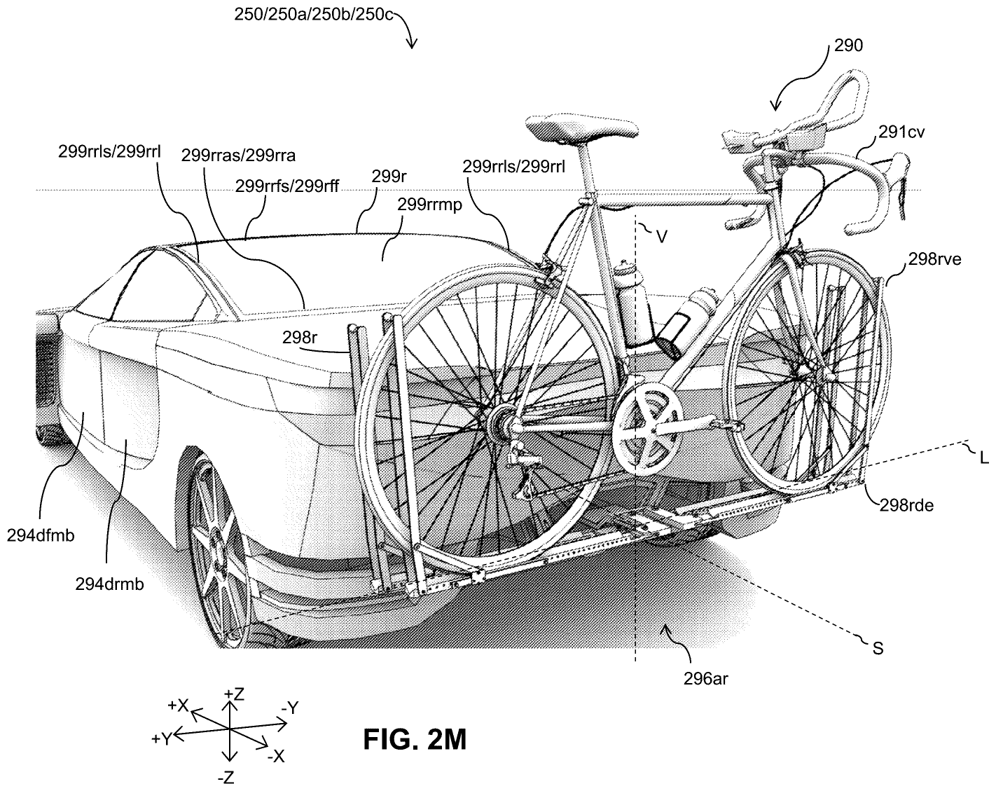

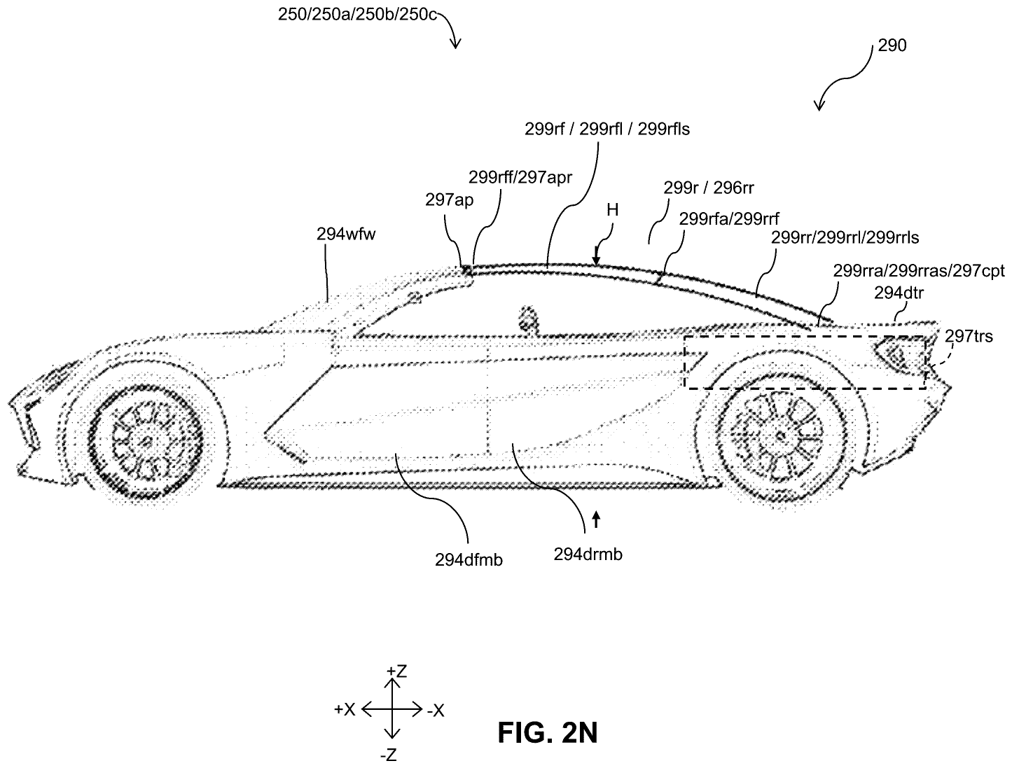

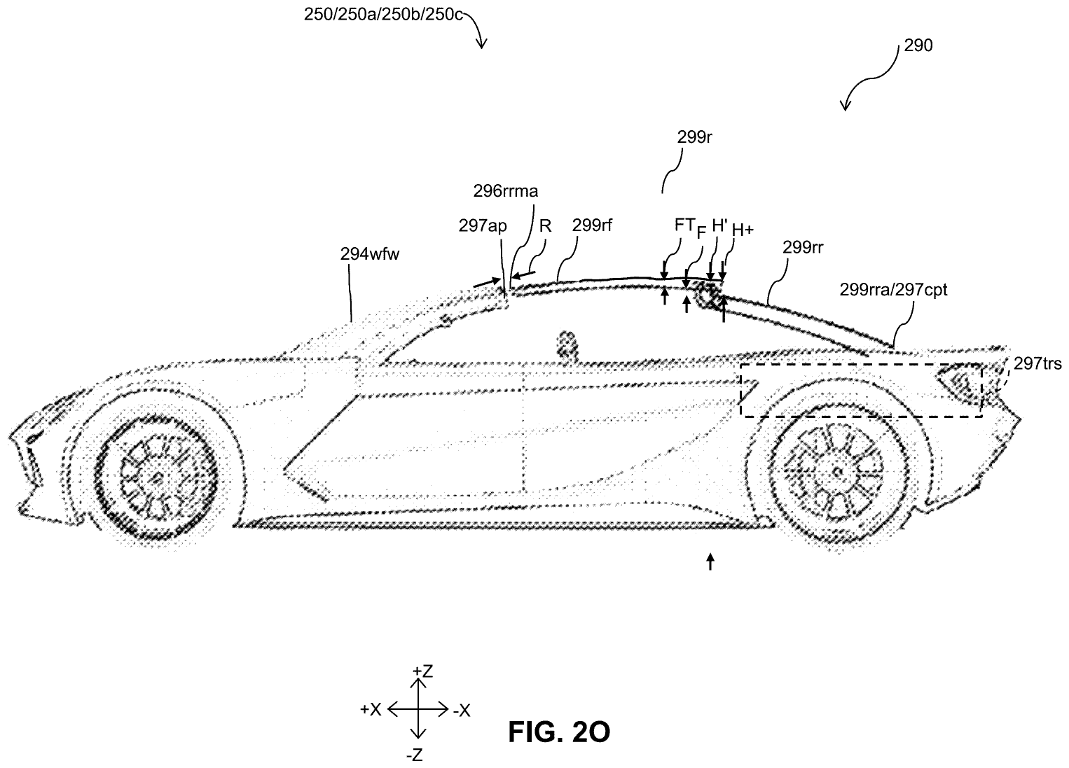

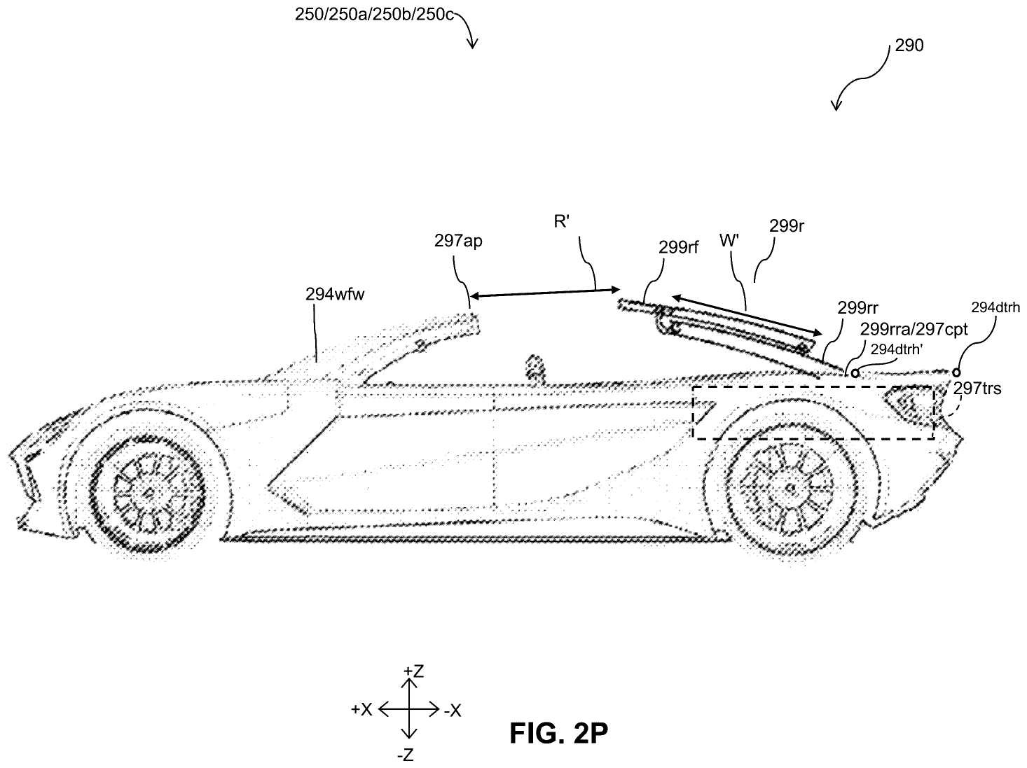

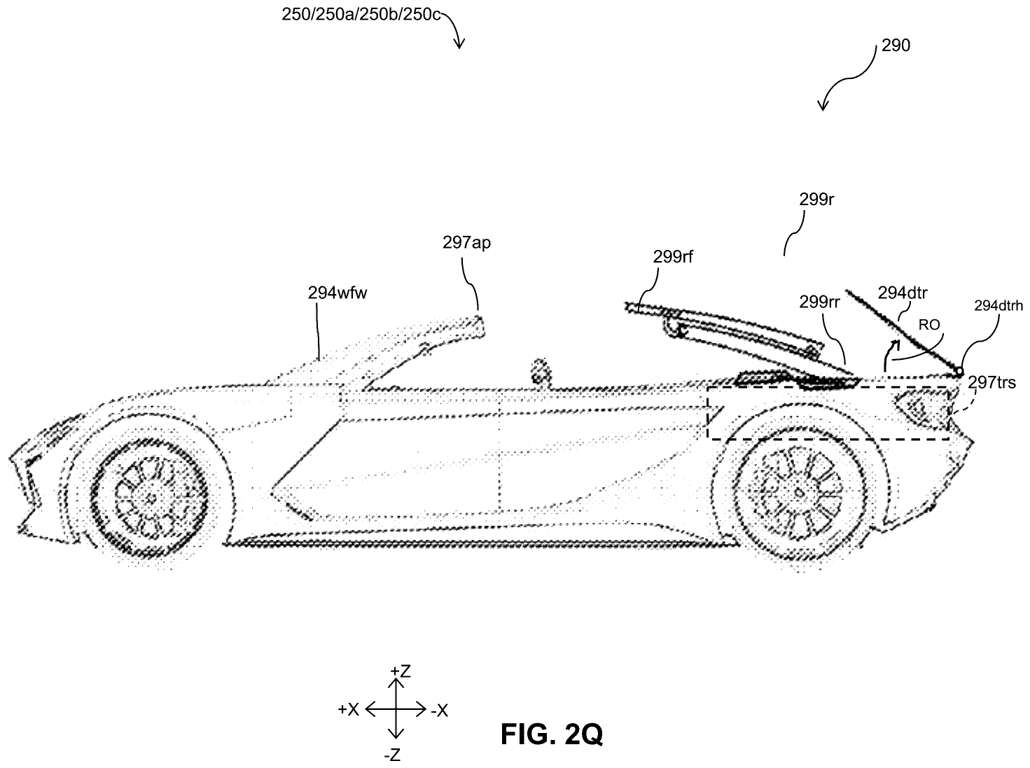

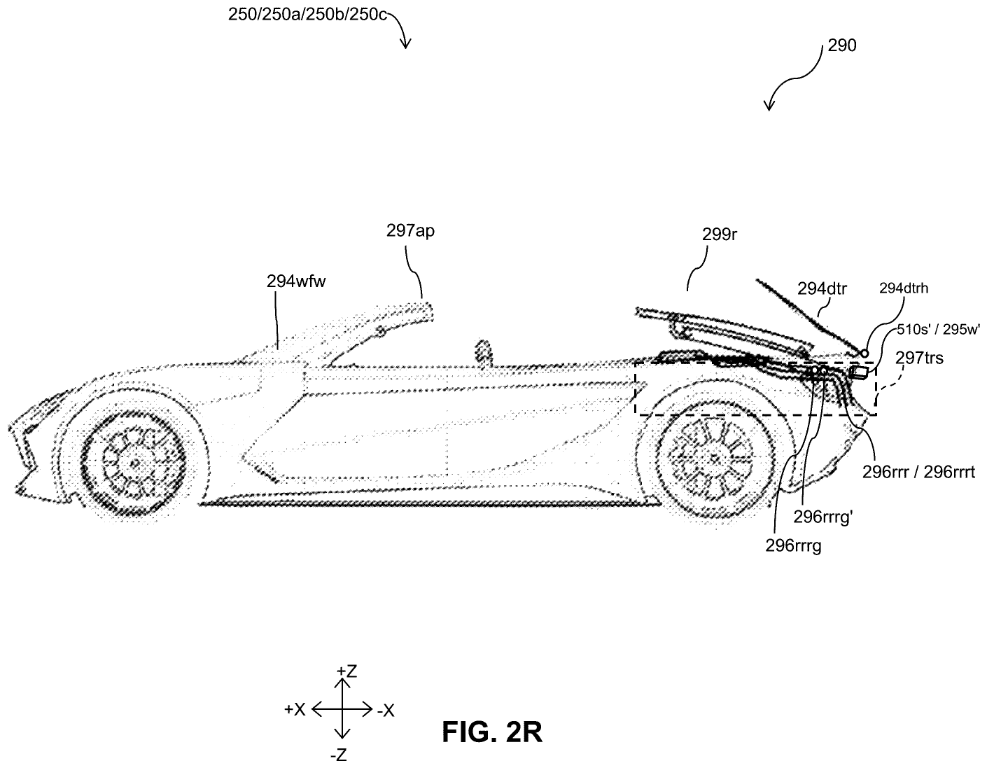

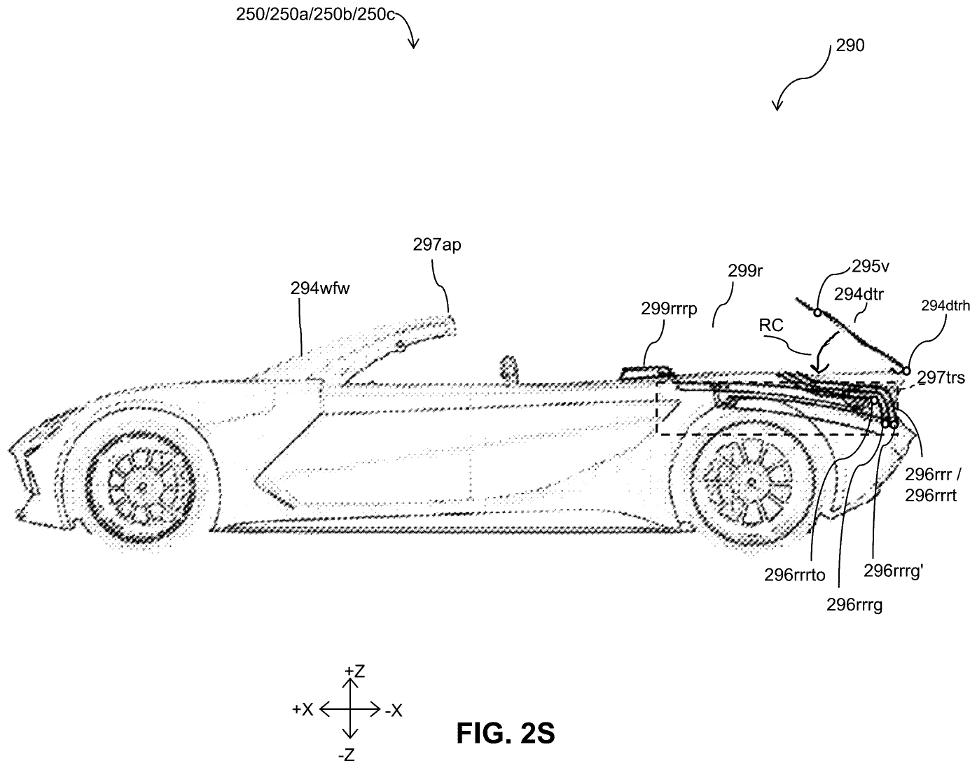

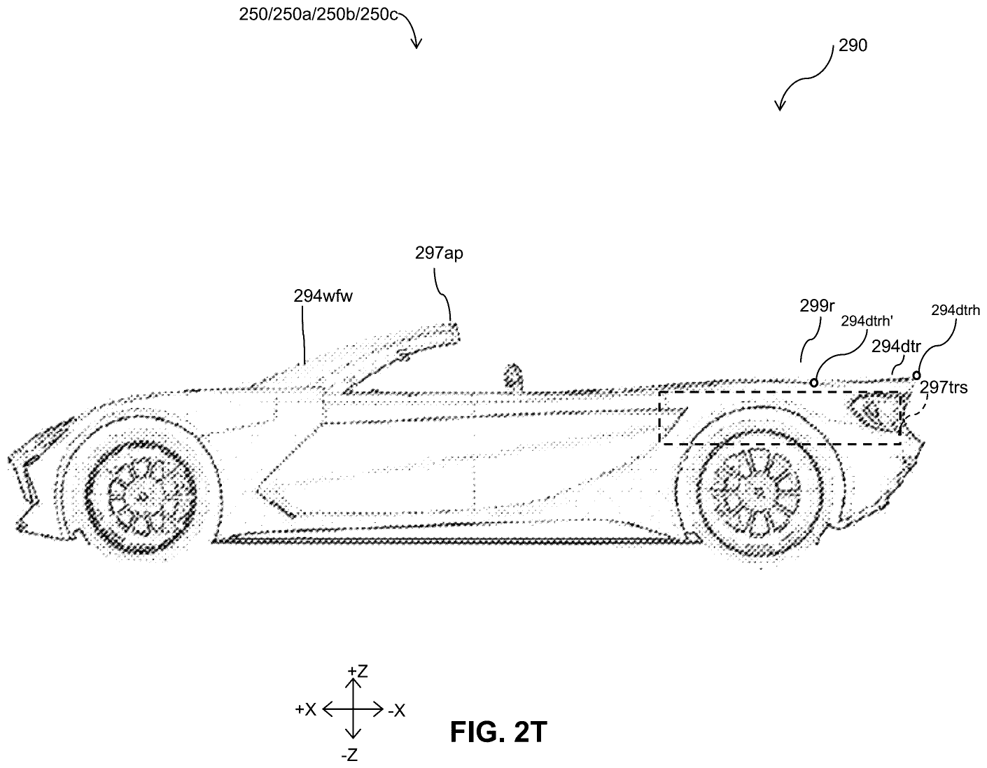

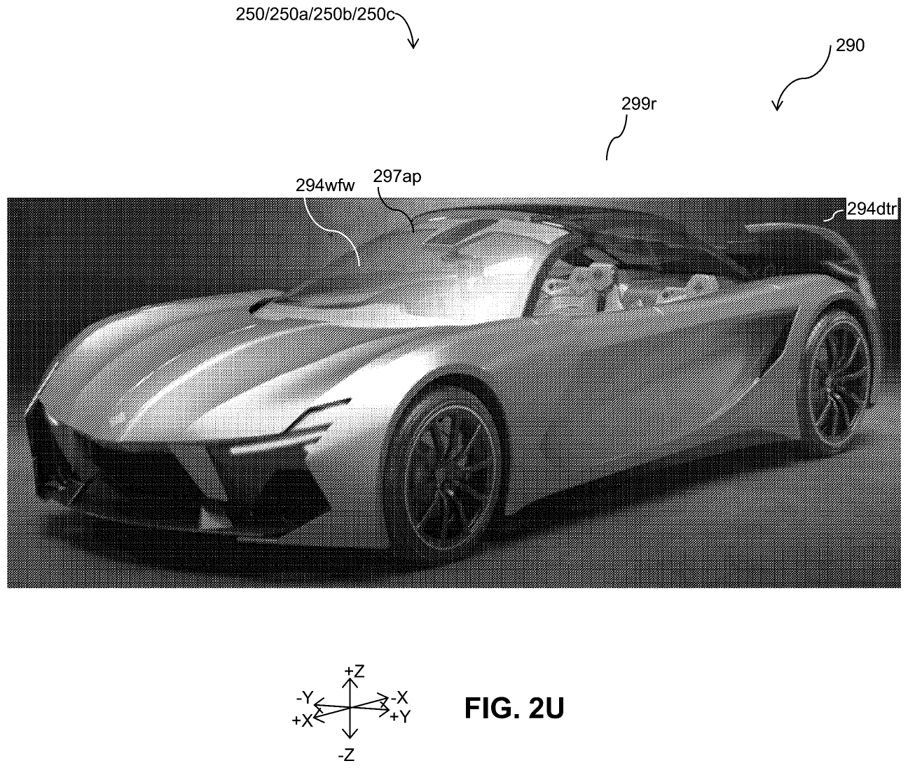

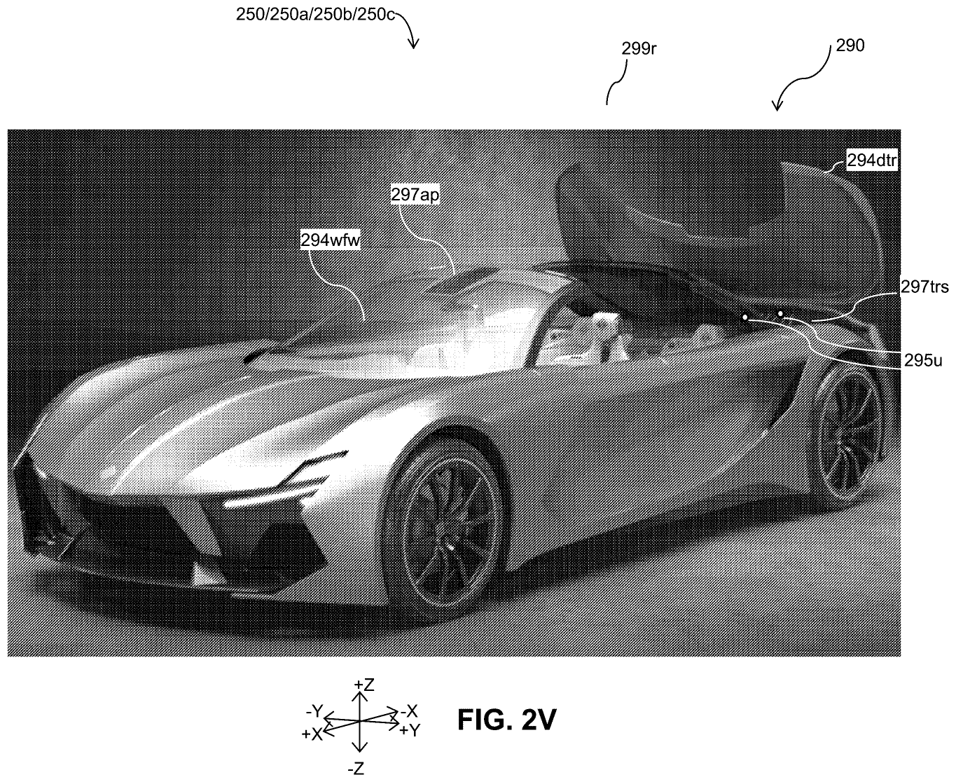

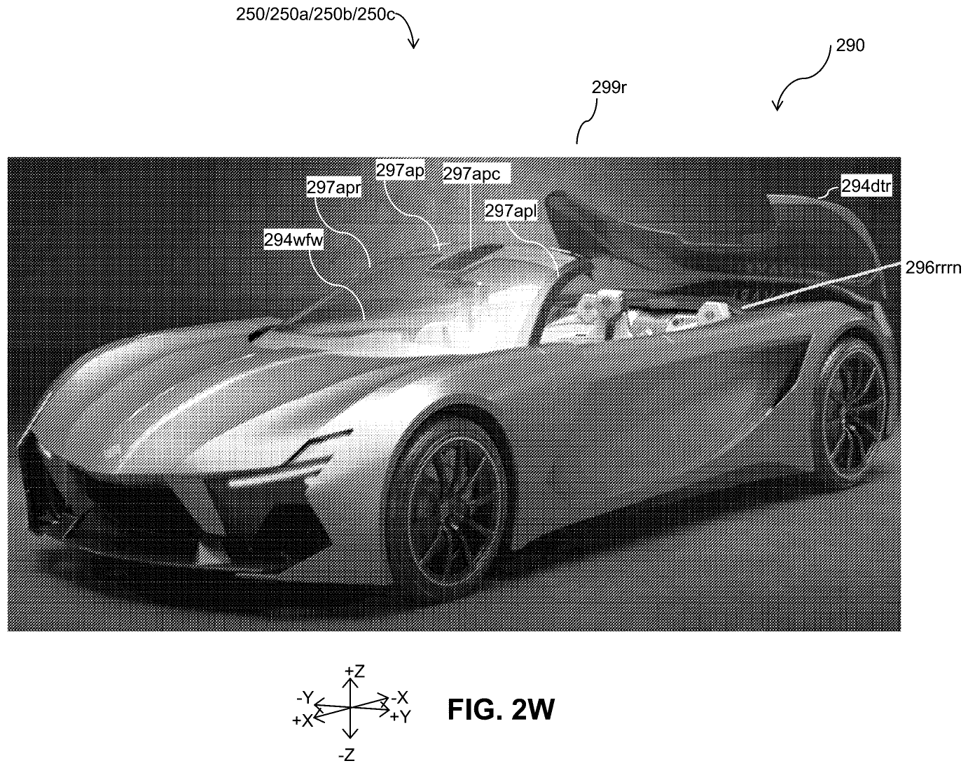

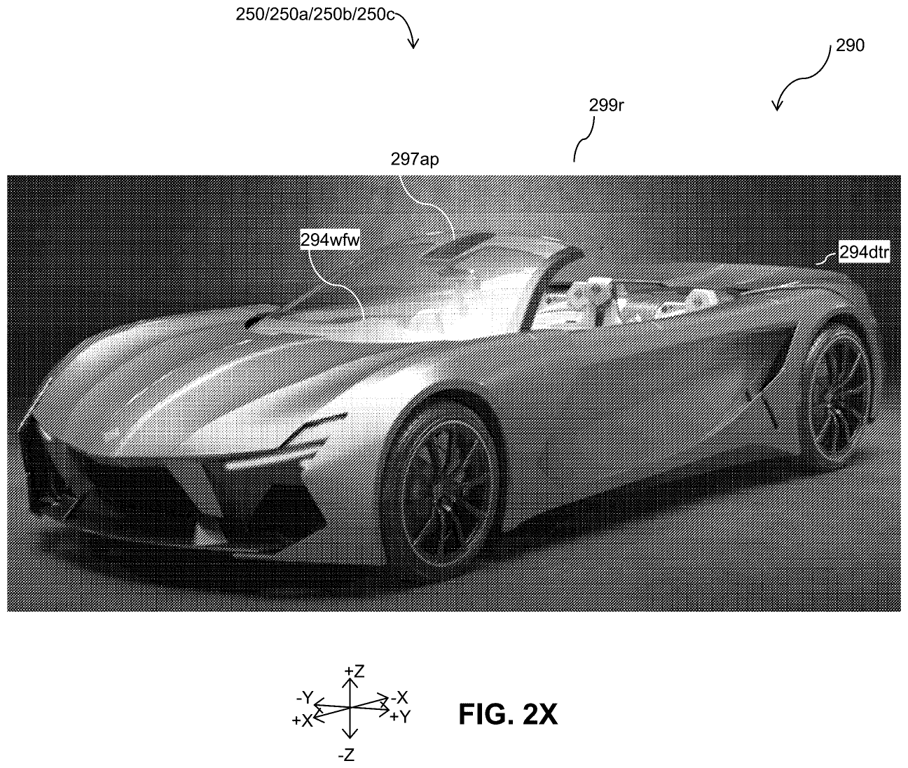

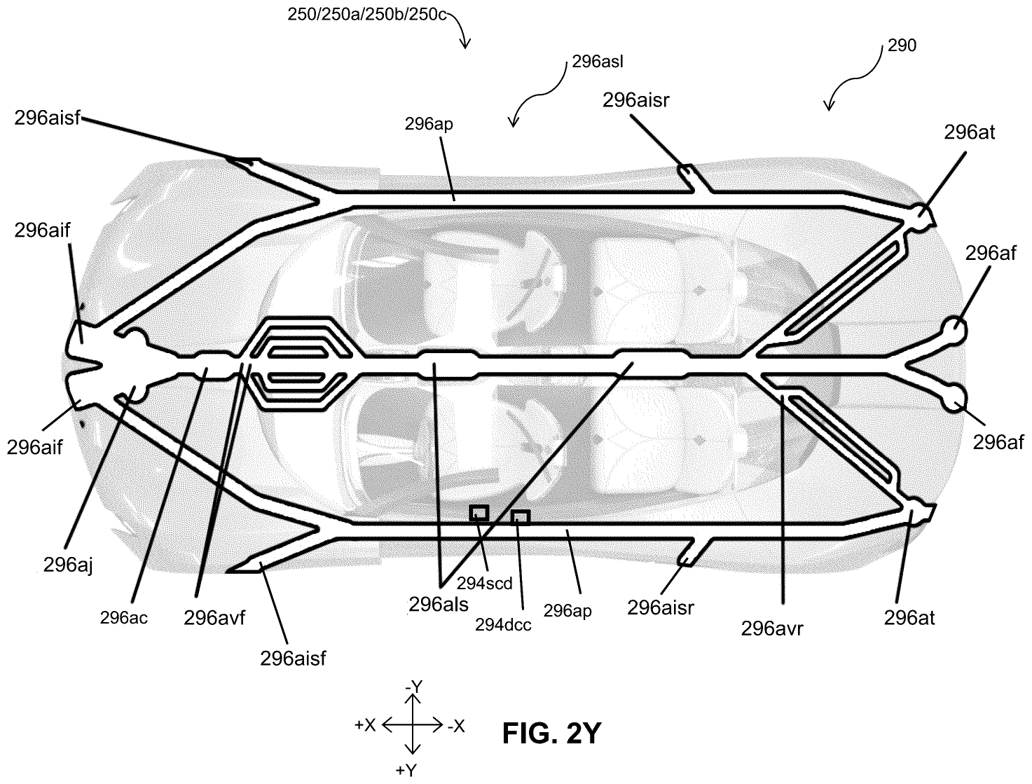

FIGS. 2 and 2A-2Y show an illustrative vehicle 290 that may include at least one object repositioning management system 250, such as a vehicle door repositioning management system 250a, a vehicle rack repositioning management system 250b, vehicle roof repositioning management system 250c, and/or the like, in accordance with various embodiments of the disclosure, which may be similar to any suitable subsystem 120 and/or which may incorporate or utilize any suitable subsystem(s) of the vehicle. Vehicle 290 may be any suitable vehicle, which may be similar to any vehicle 90 (e.g., vehicles 90a-90c) described herein. In some embodiments, as shown, vehicle 290 may be any suitable automobile with at least one seat that may be used by any suitable user (e.g., user U). For example, as shown, vehicle 290 may include at least a front main seat 294sfm (e.g., a driver seat if the vehicle is able to be driven) for a front main passenger (not shown). Additionally, in some embodiments, as shown, vehicle 290 may also include at least one front auxiliary seat 294sfa for a front auxiliary passenger (not shown), and at least one rear seat for one or more rear passengers, such as a rear main seat 294srm for a rear main passenger (not shown) and/or a rear auxiliary seat 294sra for a rear auxiliary passenger (not shown). Although each seat for each passenger may be distinct in one or more ways from one another, any vehicle may be provided with a single seat that may be used simultaneously by two or more adjacent passengers (e.g., a bench type rear seat).

Vehicle 290 may include at least one door assembly (e.g., exterior door). For example, as shown, in some embodiments, vehicle 290 may include at least one passenger door for selectively providing a user access to a passenger cabin space 297pc provided by the vehicle, a trunk door for selectively providing access to a cargo or trunk space provided by the vehicle, a charging/fuel door for selectively providing access to a fuel tank or battery of the vehicle, and/or the like. For example, as shown, vehicle 290 may include a front main seat door assembly 294dfm that may be associated with providing passenger access to front main seat 294sfm, a front auxiliary seat door assembly 294dfa that may be associated with providing passenger access to front auxiliary seat 294sfa, a rear main seat door 294drm that may be associated with providing passenger access to rear main seat 294srm, a rear auxiliary seat door 294dra that may be associated with providing passenger access to rear auxiliary seat 294sra, a front trunk door 294dtf that may be associated with providing access to a front trunk or cargo space provided by the vehicle, a rear trunk door 294dtr that may be associated with providing access to a rear trunk or cargo space 297trs defined by a trunk assembly structure or trunk 294tr provided by the vehicle, a boost door 294db that may be associated with providing access to a fuel tank or battery of the vehicle (e.g., when at a gas station or charging station), and/or the like.

One or more door assemblies may be provided with a window, such as a window that may be selectively lowered or raised (e.g., automatically based on certain events, in response to a user command, etc.). For example, as shown in FIG. 2C, front main seat door assembly 294dfm may include a front main seat door body 294dfmb and a front main seat door window 294wfm that may be selectively lowered (e.g., in the −Z direction) into a space defined by door body 294dfmb (e.g., an interior pocket thereof) and raised (e.g., in the +Z direction) out from such a space, and/or rear main seat door assembly 294drm may include a rear main seat door body 294drmb and a rear main seat door window 294wrm that may be selectively lowered (e.g., in the −Z direction) into a space defined by door body 294drmb (e.g., an interior pocket thereof) and raised (e.g., in the +Z direction) out from such a space.

A structural assembly 297 of vehicle 290 may include at least one front structural support, which may include apron(s) and/or a fire wall and/or A-pillar(s) or post(s), such as a front structural support or A-pillar assembly 297ap that may be configured to extend up from a rocker panel or sills or floorplan or chassis or any other suitable lower structural member 297lsm and support the lower (e.g., front), left, right, and/or upper (e.g., rear) periphery portions of a front windshield 294wfw (e.g., left and right A-pillars and aprons and the like about the entire periphery of the windshield) and/or support a front periphery portion of the front seat assemblies (e.g., the front side of front auxiliary seat door assembly 294dfa and the front side of front main seat door assembly 294dfm (e.g., front side 294dfmfs of door body 294dfmb)). Such an A-pillar 297ap may be configured to support at least a portion of a roof assembly of the vehicle (e.g., when the roof assembly is fully closed). In some embodiments, structural assembly 297 of vehicle 290 may include one or more B-pillars or posts, such as a full height B-pillar 297bp that may extend up between portions of adjacent doors from a rocker panel or sills or floorplan or chassis or any other suitable lower structural member 297lsm of the vehicle on each of the left and right sides of the vehicle and/or that may extend down from a roof rail or panel or any other suitable upper structural member 297usm of the vehicle on each of the left and right sides of the vehicle (e.g., a driver side B-pillar 297bpl extending up from lower structural member 297lsm and between front main seat door assembly 294dfm and rear main seat door assembly 294drm to a driver side roof rail 297usml, and a passenger side B-pillar 297bpr extending up from lower structural member 297lsm and between front auxiliary seat door assembly 294dfa and rear auxiliary seat door assembly 294dra to a passenger side roof rail 297usmr), as shown, for example in FIGS. 2B-2H. In some embodiments, structural assembly 297 of vehicle 290 may include at least one rear structural support, which may include quarter panel(s) and/or a rear support and/or C-pillar(s) or post(s), such as a rear structural support or C-pillar assembly 297cp that may be configured to extend up from a rocker panel or sills or floorplan or chassis or any other suitable lower structural member 297lsm and support trunk 294tr and/or support a rear periphery portion of the rear seat assemblies (e.g., the rear side of rear auxiliary seat door assembly 294dra and the rear side of rear main seat door assembly 294drm (e.g., rear side 294drmrs of door body 294drmb)), as shown, for example in FIGS. 2B-2H. Such B-pillar and C-pillar structures may be configured to provide structural and/or security support for one or more doors (e.g., for providing structural support to and/or for latching door 294dfm and/or door 294drm when closed) and/or to provide structural support for at least a portion of a roof assembly of the vehicle (e.g., when the roof assembly is not fully open). For example, left upper structural member 297usml may be configured to couple a top rear left portion of A-pillar 297ap with a top front portion of B-pillar 297bpl and to couple a top rear portion of B-pillar 297bpl with a top front left portion of C-pillar 297cp, such that upper structural member 297usml and pillar structures 297ap, 297bpl, and 297cp may provide a continuous left roof support structure 297lrs for the left side of the roof assembly when at least partially over passenger cabin space 297pc, while right upper structural member 297usmr may be configured to couple a top rear right portion of A-pillar 297ap with a top front portion of B-pillar 297bpr and to couple a top rear portion of B-pillar 297bpr with a top front right portion of C-pillar 297cp, such that upper structural member 297usmr and pillar structures 297ap, 297bpr, and 297cp may provide a continuous right roof support structure 297rrs for the right side of the roof assembly when at least partially over passenger cabin space 297pc. Alternatively, in some embodiments, a structural assembly of the vehicle may include only a half-height B-pillar that may extend up from lower structural member 297lsm only to a height of doors 294dfm and 294drm with their windows lowered but not the height of the doors with their windows raised up (see, e.g., a 1976 Chrysler New Yorker, where continuous left and right roof support structures may be provided between A- and C-pillars without any B-Pillars). Additionally or alternatively, in some embodiments, a structural assembly of the vehicle may include only a half-height C-pillar that may extend up from lower structural member 297lsm only to a height of doors 294drm and 294dra with their windows lowered but not the height of the doors with their windows raised up. For example, as shown in FIGS. 2, 2A, and 2N-2X, a structural assembly of vehicle 290 may not include any full height (or any) B-pillar structures nor any upper structural members 297usm and only a half-height C-pillar structure (e.g., no continuous left roof support structure and no continuous right roof support structure may be provided for the roof assembly). An A-pillar and/or any B-pillar(s) and/or any C-pillar(s) and/or upper structural members of structural assembly 297 may combine to provide any suitable structural support for any suitable door(s) and/or windows and/or roof of the vehicle. In some embodiments, a door (e.g., door 294dfm) may include not only a window (e.g., window 294wfm) that may be retractable into a main body (e.g., body 294dfmb) of the door, but also a window frame structure (not shown) that may permanently extend up from the main body structure of the door and about the periphery of the window (e.g., to provide support for the window when the window is in a non-retracted position and/or to engage with an A-Pillar and/or B-Pillar and/or C-Pillar and/or upper structural member of the vehicle's structural assembly (e.g., when the door is closed, but that may move with the door when the door is moved between its open and closed positions)).

Vehicle 290 may include a roof assembly, such as a roof 299r. The roof may be a permanent roof that is not retractable from a permanent position (e.g., a hardtop roof). Alternatively, the roof may be retractable or removable, such as a retractable or removable hardtop roof or a retractable or removable soft top roof. Alternatively, the roof may be a T-top roof, a targa top, and/or the like. In some embodiments, when roof 299r is configured to be retractable, roof 299r may be configured to be retractable into a portion of or a space adjacent to a rear trunk or cargo space 297trs provided by the vehicle (e.g., a space under rear trunk door 294dtr).

Vehicle 290 may include a rack assembly, such as a rack 298r, that may be selectively made accessible to a user when desired to mount any suitable cargo (e.g., a bicycle, cooler, etc.) exterior to the housing of the vehicle, but that may be selectively retracted into (e.g., in a +X direction) a rack holding space 298rhs of a rack sleeve 298rs that may be positioned at least partially interior to and/or under the housing of the vehicle (e.g., a sleeve that may be coupled to any suitable portion of the vehicle, such as a floorboard or lower structural member 297lsm (e.g., underneath rear trunk or cargo space 297trs)). For example, as shown in FIG. 2H, rack 298r may be extended out from rack holding space 298rhs of rack sleeve 298rs via an exterior rack sleeve opening 298rso (e.g., in a −X direction).

Vehicle 290 may include at least one vehicle information subsystem, which may be similar to any subsystem 120, that may be positioned in any suitable position with respect to the vehicle and that may be configured to provide at least one suitable type of user interface (e.g., graphic user interface (“GUI”), audible user interface, haptic user interface, etc.) for providing any suitable information to and/or receiving any suitable information from one or more passengers of the vehicle (e.g., a touch screen or any other suitable I/O component(s) that may be coupled (e.g., permanently coupled) to vehicle 290), including, but not limited to, a GUI of an odometer vehicle information subsystem 220o, a GUI of an infotainment vehicle information subsystem 220i, a GUI of a central display vehicle information subsystem 220c, a GUI of a seatback vehicle information subsystem 220s, and/or the like. For example, odometer vehicle information subsystem 220o may be provided by or along a portion of a dashboard 230d that may be in front of a front main passenger (e.g., if operating the vehicle) and may be configured to provide any suitable information (e.g., speed information (e.g., rotations per minute (“RPM”) information), odometer information, battery charge level information (e.g., for electric powered vehicles), fuel level information (e.g., for fossil fuel powered vehicles), etc.). As another example, infotainment vehicle information subsystem 220i may be provided by or along another portion of a dashboard 230d that may be in front of a front main passenger (e.g., if operating the vehicle) but also towards a front auxiliary passenger and may be configured to provide any suitable information (e.g., infotainment information (e.g., audio media information, etc.), map information, weather information, time information, etc.). As another example, central display vehicle information subsystem 220c may be provided rear of dashboard 230d towards a front of a front center console 240f that may extend in front of and/or at least partially between front seats 294sfm and 294sfa, and subsystem 220c may be configured to receive (e.g., from any front or (stretching) rear passenger (e.g., if touch input)) any suitable information (e.g., object (e.g., door, roof, rack) repositioning control information, movie control information, map control information, etc.) and/or to provide any suitable information (e.g., map information, object (e.g., door, roof, rack) repositioning control information, theater information or video media information, etc. (e.g., for a vehicle movie theater mode when the vehicle is stationary (e.g., for passengers positioned in the rear seat(s) for a more relaxing experience (e.g., during vehicle charging))) and/or the like) that may be directed towards or otherwise accessible not only to any passenger(s) of front seat(s) 294sfm and/or 294sfa but additionally or alternatively to any passenger(s) of rear seat(s) 294srm and/or 294sra. As yet another example, seatback vehicle information subsystem 220s may be provided at least partially in or on or along a back portion (e.g., rearward facing surface) of a front seat (e.g., as shown with respect to front seat 294sfm) and/or the like that may be facing and proximate a passenger of a rear seat (e.g., a passenger of seat 294srm), and subsystem 220s may be configured to provide any suitable information (e.g., rear media information, object (e.g., door, roof, rack) repositioning control information, etc.) and/or receive (e.g., from a rear passenger) any suitable information (e.g., object (e.g., door, roof, rack) repositioning control information, etc.). As yet another example, a door vehicle information subsystem 220d may be provided at least partially in or on or along a portion (e.g., inward facing surface) of a passenger door (e.g., as shown by FIG. 2 with respect to door 294dra) that may be facing and proximate a passenger of a rear seat (e.g., a passenger of seat 294sra), and subsystem 220d may be configured to provide any suitable information (e.g., rear media information, object (e.g., door, roof, rack) repositioning control information, etc.) and/or receive (e.g., from a passenger) any suitable information (e.g., object (e.g., door, roof, rack) repositioning control information, etc.). Additionally or alternatively, in some embodiments, vehicle 290 may be considered to temporarily include at least one vehicle information subsystem similar to any subsystem 120 that may provide at least one type of user interface (e.g., GUI) for providing any suitable information to one or more users of the vehicle (e.g., a screen or other UI that may not be permanently coupled to vehicle 290), including, but not limited to, a UI of a portable user vehicle information subsystem 220u (e.g., a portable media device (e.g., smart phone)) of a user (e.g., user U) that may be selectively communicatively coupled (e.g., wirelessly (e.g., via Bluetooth, RFID, NFC, Wi-Fi, etc.) or via any suitable wired connector (e.g., via USB port)) to another (e.g., permanent) subsystem of vehicle 290, where subsystem 220u may be configured to provide any suitable information to a user (e.g., speed information, odometer information, object (e.g., door, roof, rack) repositioning control information, etc.) and/or receive (e.g., from a user) any suitable information (e.g., object (e.g., door, roof, rack) repositioning control information, user preference information, etc.).

Object (e.g., door, roof, rack) repositioning management system 250 may be provided in any suitable way such that any suitable object of vehicle 290, such as one, some, or each door, rack, roof, and/or the like, may be repositioned (e.g., automatically or in response to a control from a user) to reconfigure the vehicle for a particular use case. Object (e.g., door, roof, rack) repositioning management system 250 (e.g., vehicle door repositioning management system 250a, vehicle rack repositioning management system 250b, vehicle roof repositioning management system 250c, and/or the like) may include any suitable object adjusting or repositioning actuator subsystem(s) 296, each of which may include any suitable gears, motors (e.g., linear motors, rotary motors, etc.), and/or other suitable actuators (e.g., soft, hydraulic, pneumatic, thermal, magnetic, etc.) that may be configured to adjust a position or other suitable orientation of an appropriate object of vehicle 290 in one or more ways (e.g., automatically, in response to any suitable control signals (e.g., from any suitable vehicle information subsystem(s) 220), etc.) for enabling any suitable power object (e.g., a power door, a power roof, a power rack, etc.). Additionally, object (e.g., door, roof, rack) repositioning management system 250 (e.g., vehicle door repositioning management system 250a, vehicle rack repositioning management system 250b, vehicle roof repositioning management system 250c, and/or the like) may include any suitable vehicle sensor subsystem(s) 295, each of which may include any suitable sensor(s) that may be configured to detect certain status information about the vehicle and/or its users and/or its environment, and any suitable vehicle status classification subsystem(s) 216, each of which may be configured to analyze such status information and any other suitable accessible information to determine when certain conditions are satisfied (e.g., safety conditions, such as a seat being occupied (e.g., as may be determined by an occupation classification subsystem), the vehicle not moving (e.g., as may be determined by a vehicle speedometer classification subsystem), a vehicle door being closed (e.g., as may be determined by a door open/closed status classification subsystem), and/or the like). Object repositioning management system 250 may be configured to allow or otherwise enable control of any suitable repositioning actuator subsystem(s) 296 (e.g., automatically, in response to any suitable control signals (e.g., from any suitable vehicle information subsystem(s) 220)) for enabling any suitable power object (e.g., a power door, a power roof, a power rack, etc.) or automatically carry out a particular repositioning of a particular object (e.g., a door, roof, rack, etc.) with any suitable repositioning actuator subsystem(s) 296 only when certain conditions are satisfied (e.g., as may be determined by any suitable vehicle status classification subsystem(s) 216 (e.g., based on any suitable status information from any suitable vehicle sensor subsystem(s) 295)).

FIG. 2 may show some exemplary illustrative non-limiting examples of sensors of any suitable vehicle sensor subsystem(s) 295 and actuators of any suitable vehicle actuator subsystem(s) 296 for vehicle 290. For example, a sensor or pack of sensors 295a may be provided at any suitable position(s) along, on, and/or within door assembly 294dfm and may be configured to detect any suitable information associated with the door (e.g., any suitable sensor(s) to detect the vibration of the door panel and/or the sound and/or smell and/or light at that location and/or the presence of a remote object and/or the presence of a user touch at the location and/or the like), while a similar sensor or pack of sensors 295a′ may be provided at any suitable position(s) along, on, and/or within door assembly 294drm. Any suitable sensory replication mechanism(s) or an actuator or pack of actuators 296a may be provided at any suitable position(s) along, on, and/or within door assembly 294dfm and may be configured to replicate or generate any suitable vibrations, sounds, movement, lights, smells, and/or the like at or with the door (e.g., any suitable output component(s) to generate a vibration of the door panel and/or a sound at that location and/or a smell at that location and/or the like), while a similar actuator or pack of actuators 296a′ may be provided at any suitable position(s) along, on, and/or within door assembly 294drm.

Additionally or alternatively, a sensor or pack of sensors 295b may be provided at any suitable position(s) along, on, and/or within a brake pedal 294bpdl or any other suitable pedal and may be configured to detect any suitable information associated with the brake pedal (e.g., any suitable sensor(s) to detect the vibration, movement, and/or resistance of the pedal and/or the sound and/or smell and/or light at that location and/or the presence of a remote object and/or the presence of a user touch at the location and/or the like), while a similar sensor or pack of sensors 295b′ may be provided at any suitable position(s) along, on, and/or within an acceleration pedal 294apdl. Any suitable sensory replication mechanism(s) or an actuator or pack of actuators 296b may be provided at any suitable position(s) along, on, and/or within brake pedal 294bpdl that may be configured to replicate or control any suitable vibrations, movement, resistance, sounds, lights, smells, and/or the like at or with or of the brake pedal (e.g., any suitable output component(s) to generate a vibration or movement or resistance or sound or smell or light at that location and/or the like), while a similar actuator or pack of actuators 296b′ may be provided at any suitable position(s) along, on, and/or within acceleration pedal 294apdl.

Additionally or alternatively, a sensor or pack of sensors 295c may be provided at any suitable position(s) along, adjacent, on, and/or within a driver side heating, ventilation, and air conditioning (“HVAC”) system vent 294dsv or any other suitable vehicle vent and may be configured to detect any suitable information associated with the vent (e.g., any suitable sensor(s) to detect the temperature, fluid speed, fluid direction, fluid content, smell, sound, light, and/or the like of the environment at the vent location and/or the like), while a similar sensor or pack of sensors 295c′ may be provided at any suitable position(s) along, on, and/or within a passenger side HVAC system vent 294psv. Any suitable sensory replication mechanism(s) or an actuator or pack of actuators 296c may be provided at any suitable position(s) along, adjacent, on, and/or within vent 294dsv that may be configured to replicate or control any suitable vibrations, movement, resistance, sounds, lights, smells, and/or the like at or within or adjacent the vent (e.g., any suitable output component(s) to generate a vibration, movement, resistance, sound, smell, light, and/or the like at that location), while a similar actuator or pack of actuators 296c′ may be provided at any suitable position(s) along, on, and/or within vent 294psv.

Additionally or alternatively, a sensor or pack of sensors 295d may be provided at any suitable position(s) along, on, adjacent, and/or within a steering wheel 294swl and may be configured to detect any suitable information associated with the steering wheel (e.g., any suitable sensor(s) to detect the speed and rate of turn, vibrations, resistance and/or the like of the wheel and/or the smell, sound, light, and/or the like of the environment at the wheel and/or the like). Any suitable sensory replication mechanism(s) or an actuator or pack of actuators 296d may be provided at any suitable position(s) along, on, adjacent, and/or within steering wheel 294swl that may be configured to replicate or control any suitable vibrations, movement, resistance, sounds, lights, smells, and/or the like at or within or of the vent (e.g., any suitable output component(s) to control the feel and response and vibration of the wheel and/or the sound or smell at that location and/or the like).

Additionally or alternatively, a sensor or pack of sensors 295e may be provided at any suitable position(s) along, on, adjacent, and/or within a headrest of seat 294sfm and may be configured to detect any suitable information associated with the seat headrest (e.g., any suitable sensor(s) to detect the vibration, smell, sound, light, and/or the like of or at the headrest and/or the like), while a similar sensor or pack of sensors 295e′ may be provided at any suitable position(s) along, on, adjacent, and/or within a headrest of seat 294sfa, while a similar sensor or pack of sensors 295e″ may be provided at any suitable position(s) along, on, adjacent, and/or within a headrest of seat 294srm, while a similar sensor or pack of sensors 295e′″ may be provided at any suitable position(s) along, on, adjacent, and/or within a headrest of seat 294sra. Any suitable sensory replication mechanism(s) or an actuator or pack of actuators 296e may be provided at any suitable position(s) along, on, adjacent, and/or within a headrest of seat 294sfm that may be configured to replicate or control any suitable vibrations, sounds, lights, smells, and/or the like at or within or of the headrest (e.g., any suitable output component(s) to generate a vibration, sound, smell, light, and/or the like at that location), while a similar actuator or pack of actuators 296e′″ may be provided at any suitable position(s) along, on, adjacent, and/or within a headrest of seat 294sfa, while a similar actuator or pack of actuators 296e″ may be provided at any suitable position(s) along, on, adjacent, and/or within a headrest of seat 294srm, while a similar actuator or pack of actuators 296e′″ may be provided at any suitable position(s) along, on, adjacent, and/or within a headrest of seat 294sra.

Additionally or alternatively, a sensor or pack of sensors 295f may be provided at any suitable position(s) along, on, adjacent, and/or within a seat base of seat 294sfm and may be configured to detect any suitable information associated with the seat base (e.g., any suitable sensor(s) to detect the vibration, smell, sound, light, and/or the like of or at the seat base and/or the like), while a similar sensor or pack of sensors may be provided at any suitable position(s) along, on, adjacent, and/or within a seat base of seat 294sfa, seat 294srm, and/or seat 294sra. Any suitable sensory replication mechanism(s) or an actuator or pack of actuators 296f may be provided at any suitable position(s) along, on, adjacent, and/or within a seat base of seat 294sfm that may be configured to replicate or control any suitable vibrations, sounds, lights, smells, and/or the like at or within or of the seat base (e.g., any suitable output component(s) to generate a vibration, sound, smell, light, and/or the like at that location), while a similar actuator or pack of actuators may be provided at any suitable position(s) along, on, adjacent, and/or within a headrest of seat 294sfa, while a similar actuator or pack of actuators 296e″ may be provided at any suitable position(s) along, on, adjacent, and/or within a seat base of seat 294sfa, seat 294srm, and/or seat 294sra.

Additionally or alternatively, a sensor or pack of sensors 295g may be provided at any suitable position(s) along an exterior of the vehicle (e.g., adjacent a rear driver side wheel 294dswl and/or any other suitable position(s) (e.g., adjacent a tailpipe, engine, battery, suspension, etc.)) and may be configured to detect any suitable information associated with the exterior location (e.g., any suitable sensor(s) to detect the vibrations, temperature, fluid speed, fluid direction, fluid content, smell, sound, light, and/or the like of the environment at the location). Any suitable sensory replication mechanism(s) or an actuator or pack of actuators 296g may be provided at any suitable position(s) along the exterior of the vehicle (e.g., adjacent rear driver side wheel 294dswl and/or any other suitable position(s) (e.g., adjacent a tailpipe, engine, battery, suspension, etc.)) that may be configured to replicate or control any suitable vibrations, movement, sounds, lights, smells, and/or the like at that location (e.g., any suitable output component s) to generate a vibration, movement, sound, smell, light, and/or the like at that location).

Additionally or alternatively, any suitable sensor(s) and/or sensor pack(s) may be provided at any suitable positions with respect to a wheel of the vehicle (e.g., sensors 695-1, 695-3, and 695-5 at a wheel 294hrm), for any suitable purpose, including, but not limited to monitoring the behavior of the vehicle's suspension, brakes, and wheels. Such sensor packs may include one or a multitude of sensors, such as gyroscopes, accelerometers, barometers, microphones, lasers/laser readers, light sensors, vibration sensors, cameras, and/or the like. Such camera(s) may be placed in one or multiple locations and may include one or multiple cameras and lenses, and may be configured to monitor the movement of one or multiple components, including, but not limited to, the wheels, tires, tire deflection and/or distortion, brakes, brake pads, suspension arms, control arms, actuators, hydraulic pistons and/or actuators, actuators, fasteners, and/or the like, which may be capable of monitoring and/or determining and/or providing information on any suitable characteristics, including, but not limited to, vibration, spin, rates of acceleration and/or deceleration, wear-and-ear, distortion, lateral movement, vertical movement, foreign objects, dirt, dust, water, debris, and/or other behaviors.

Vehicle 290 may include any suitable system layout of pipes and chambers for moving fluid through a system 296asl (e.g., for generating certain sound and/or movement with the vehicle), where system 296asl may be provided along any suitable portions of the vehicle (e.g., along (e.g., adjacent, just above, just below, or within) lower structural member 297lsm, etc.). For example, as shown in FIG. 2Y, vehicle 290 may include any suitable air intakes 296aif at the front of the vehicle, any suitable air intakes 296aisf towards the front of the sides of the vehicle, and/or any suitable air intakes 296aisr towards the rear of the sides of the vehicle that may be fluidly communicatively coupled with each other and that may be configured to allow fluid (e.g., air) from the vehicle's environment to enter system 296asl, be passed through any suitable pipes 296ap and/or any suitable chambers 296ac, and/or being directed by any suitable valves 296avf and 296avr. At or near or along a center console (e.g., center console 240f of vehicle 290), one or more portals 296als may be provided to add specific sound and/or vibration options to the vehicle. Turbo fans and/or any other suitable fluid (e.g., air) propulsion devices (e.g., jets 296aj, turbines 296at, fans 296af, etc.) may be provided and configured to move fluid (e.g., air) through system 296asl via blowing and/or suction or otherwise. It should be noted that this is just one example of a layout of the pipes and chambers and they might be laid-out differently depending on the shape and purposes of the vehicle into which such a system is installed.

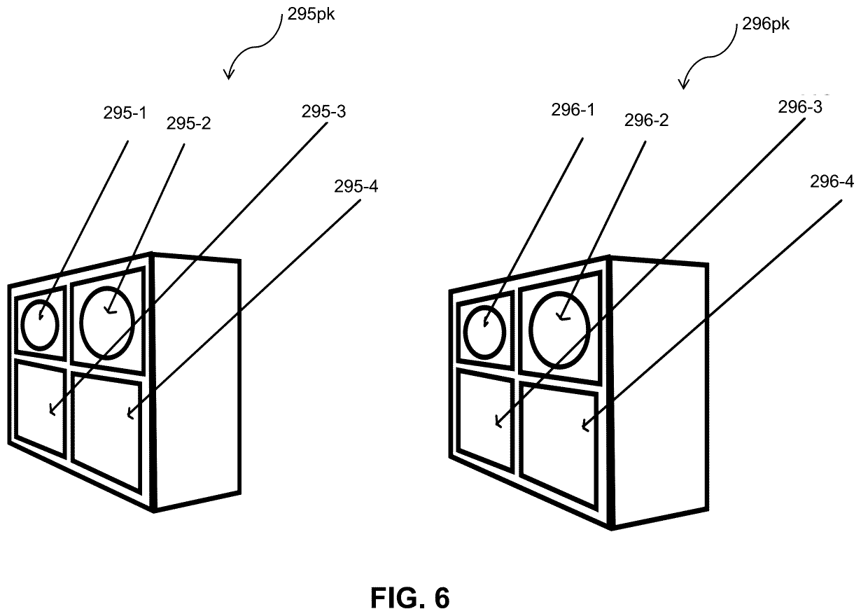

As shown in FIG. 6, for example, an exemplary illustrative non-limiting example of a pack of sensors 295pk may include any suitable number of sensors and can be coupled to any suitable component(s) of a vehicle at any suitable location(s). As just one example, pack of sensors 295pk of FIG. 6 may include a laser sensor 295-1, a camera 295-2, an accelerometer 295-3, and a gyroscope 295-4, However, it should be noted that different packs for placement on different components of the vehicles may contain different selections of components. In this example, such a sensor pack may be placed on a suspension arm of a vehicle and monitor the chance in distance between the arm and wheel well to detect accurate movement by measuring the distance of the laser (e.g., time to reflect), as well as measuring vibrations via the camera, accelerometer, and gyroscope. Additionally, as shown in FIG. 6, an exemplary illustrative non-limiting example of a pack of actuators 296pk may include any suitable number of actuators and/or output components and can be coupled to any suitable component(s) of a vehicle at any suitable location(s). As just one example, pack of actuators 296pk of FIG. 6 may include a light output component 296-1, a smell output component 296-2, a sound output component 296-3, and a movement output component 296-4. However, it should be rioted that different packs for placement on different components of the vehicles may contain different selections of components.

As just one example, seat 294sfm may be repositioned or moved in any suitable manner(s) by any suitable actuator(s) of any suitable actuator(s) of any suitable seat repositioning actuator subsystem(s) 296 that may be associated with seat 294sfm, including, but not limited to, actuator(s) 296e and/or actuator(s) 296f. At least one actuator 296f may be any suitable actuator that may be configured to move seat 294sfm (e.g., a seat base and/or seat backrest and/or seat headrest) in any suitable side to side or front to back or top to bottom or rotation motion and/or the like (e.g., with respect to lower structural member 297lsm of the vehicle), such as towards the left side of the vehicle in the +Y direction, towards the right side of the vehicle in the −Y direction, towards the front of the vehicle in the +X direction, towards the rear of the vehicle in the −X direction, towards the top of the vehicle in the +Z direction, towards the bottom of the vehicle in the −Z direction, about the Z-axis (e.g., with the seat base in an X-Y plane (e.g., such that the seat back rest may be rotated to extend along an interior side wall (e.g., door) of the vehicle)), and/or the like (e.g., the Z-axis may be perpendicular to a surface (e.g., road) supporting the vehicle)). Additionally or alternatively, at least one actuator 296e may be any suitable actuator that may be configured to move a headrest of seat 294sfm in any suitable side to side or front to back or top to bottom motion or rotation motion about the Y-axis with respect to the seat backrest of seat 294sfm (e.g., towards the left side of the vehicle in the +Y direction, towards the right side of the vehicle in the −Y direction, towards the front of the vehicle in the +X direction, towards the rear of the vehicle in the −X direction, towards the top of the vehicle in the +Z direction, towards the bottom of the vehicle in the −Z direction, about the Y-axis so a rear surface of the seat headrest may be positioned parallel or substantially parallel to the ground, about the Z-axis so a rear surface of the seat headrest may be positioned parallel or substantially parallel to a sidewall of the vehicle, and/or the like).

In addition to any suitable object repositioning actuator subsystem(s) 296, object repositioning management system 250 may include any suitable vehicle information subsystem(s) 220, one, some, or each of which may be communicatively coupled to any object repositioning actuator subsystem(s) 296 and operative to receive any suitable input instructions from a user or otherwise (e.g., via any suitable input component and/or sensor) and, in response, generate any suitable output control instruction(s), and then communicate such output control instruction(s) to object repositioning actuator subsystem(s) 296 for adjusting a position or other suitable orientation of an object (e.g., seat, door, roof, rack) of vehicle 290 in one or more ways (e.g., automatically, in response to any suitable output control instruction(s)). For example, front seat 294sfm may be repositioned in any suitable manner(s) by any suitable actuator(s) of any suitable seat repositioning actuator subsystem(s) 296 in response to receiving any suitable output control instruction(s) generated by and transmitted from any suitable vehicle information subsystem(s) 220, including, but not limited to, any suitable subsystems 220.

In some embodiments, an object repositioning management system 250 may be configured to allow or otherwise enable such control of any suitable object repositioning actuator subsystem(s) 296 by any suitable vehicle information subsystem(s) 220 and/or to control automatically any suitable object repositioning actuator subsystem(s) 296 only when certain conditions are satisfied (e.g., safety conditions, such as a seat not being occupied (e.g., as may be determined by a vehicle occupation status classification subsystem), the vehicle not moving (e.g., as may be determined by a vehicle movement status classification subsystem), a vehicle door being closed (e.g., as may be determined by a vehicle door open/closed status classification subsystem), and/or the like). For example, object repositioning management system 250 may include any suitable vehicle status classification subsystem(s) 216 (e.g., a passenger presence detection subsystem, a vehicle speed classification subsystem, a door open/closed status classification subsystem, etc.), one, some, or each of which may be communicatively coupled to one or more vehicle sensor subsystems 295 (e.g., for receiving sensor data to be analyzed for making a determination of any suitable status classification), as well as one or more object repositioning actuator subsystem(s) 296 and/or one or more vehicle information subsystem(s) 220 of system 250, and a subsystem 216 may be operative to detect (e.g., automatically) a vehicle status classification (e.g., an occupancy state of a particular seat of vehicle 290 (e.g., an occupancy state or a vacancy state, such as whether or not a passenger is currently sitting in a particular seat of vehicle 290 (e.g., via any suitable input component and/or sensor (e.g., weight sensor, camera sensor, etc.) and/or processing (e.g., occupant classification application processing, etc.))) and, in response, may be operative to generate (e.g., automatically) any suitable output control instruction(s), and then may be operative to communicate (e.g., automatically) such output control instruction(s) for selectively enabling an object repositioning actuator subsystem 296 to be controlled by a vehicle information subsystem 220 of object repositioning management system 250 (e.g., allow or disallow user control via subsystem 220 based on whether or not a status classification is determined (e.g., when a door is detected to be soon opened)) and/or for automatically controlling an object repositioning actuator subsystem 296 (e.g., based on any suitable programmed settings (e.g., of an application 19), such as move a front seat as far away from its associated door when the door is about to be opened, whereby no active user control via a subsystem 220 may be utilized for such a repositioning).

Object repositioning management system 250 may be configured (e.g., using any suitable application(s) and/or any suitable processor(s) of any suitable subsystem(s) (e.g., subsystem(s) 216, 295, 296, and/or 220)) to allow (e.g., automatically or via user control (e.g., via user interaction with one or more subsystem(s) 220) object repositioning only if one or more conditions (e.g., status classifications) have been determined.

A vehicle information subsystem 220 of object repositioning management system 250 that may be used to receive instructions (e.g., user instructions) for repositioning an object may include any suitable user interface (e.g., I/O component(s)) operative to receive such instructions (e.g., touch screen, physical button(s), physical slider(s), microphone(s) for detecting audible voice activated commands, motion sensors and/or light sensors and/or the like for detecting waving or other suitable physical gestures in space, and/or the like). One specific example of a subsystem 220 may be an electronic device, such as a smart phone type device, which may include a touch screen I/O component (e.g., an output component may be a display that can be used to display a visual or graphic user interface (“GUI”), which may allow a user to interact with subsystem 220). A screen of the GUI of such an I/O component may include various layers, windows, screens, templates, elements, menus, and/or other components of a currently running application (e.g., object repositioning management application) that may be displayed in all or some of the areas of the display output component. One or more of any suitable user input components of the subsystem may be used to navigate through the GUI (e.g., a scroll wheel that may allow a user to select one or more graphical elements or icons of the GUI, and/or icons of the GUI may be selected via a touch screen I/O component, where such a touch screen I/O component may employ any suitable type of touch screen input technology, such as, but not limited to, resistive, capacitive, infrared, surface acoustic wave, electromagnetic, or near field imaging, and/or may employ single point or multi-point (e.g., multi-touch) input sensing).

The GUI icons may represent various applications, layers, windows, screens, templates, elements, and/or other components that may be displayed in some or all of the areas of a display component of the subsystem upon selection by the user. Furthermore, selection of a specific icon may lead to a hierarchical navigation process. For example, selection of a specific icon may lead from one screen to screen to a new screen of the GUI that may include one or more additional icons or other GUI elements of the same application or of a new application associated with that icon. Textual indicators may be displayed on or near one, some, or each icon to facilitate user interpretation of the graphical element icon. It is to be appreciated that a GUI may include various components arranged in hierarchical and/or non-hierarchical structures. When a specific icon is selected, the subsystem may be configured to open a new application associated with that icon and display a corresponding screen of the GUI associated with that application. For each application, screens may be displayed on a display output component of the subsystem and may include various user interface elements. Additionally or alternatively, for each application, various other types of non-visual information may be provided to a user via various other output components of the subsystem (e.g., audible, tactile, etc.).

Although many aspects of repositioning management systems may be described with respect to repositioning objects (e.g., doors, roofs, racks, etc.) of a vehicle, it is to be understood that these systems may be used with respect to repositioning such objects of any suitable object carrier, such as a cabinet (e.g., a kitchen cabinet), a home or room (e.g., with a retractable roof or door or exterior rack), a wall with a rack or door, and/or the like.

A particular object repositioning management system may be a vehicle door repositioning management system 250a that may be configured to manage the movement of front main seat door assembly 294dfm between various positions with respect to structural assembly 297 of vehicle 290 (e.g., with respect to A-pillar 297ap, B-pillar 297bp, lower structural member 297lsm, roof 299r, and/or the like). For example, door assembly 294dfm may be moved between (i) a fully closed position (e.g., as shown by FIGS. 2B and 2M-2Y) whereby at least door body 294dfmb may be securely held (e.g., latched) in a position against portion(s) of A-pillar 297ap, any B-pillar 297bp, lower structural member 297lsm, roof 299r, rear main seat door assembly 294drm, and/or the like for protecting a passenger seated in seat 294sfm from being injured by a side collision in the −Y direction or from falling out of the vehicle in the +Y direction, and (ii) a fully open position (e.g., as shown by FIGS. 2, 2A, and 2D-2G) whereby door body 294dfmb may be securely held in a position with respect to structural assembly 297 of vehicle 290 that is substantially or completely out of the path of a user when entering into passenger cabin space 297pc from a left exterior side of the vehicle and seating themself in seat 294sfm. Such movement of door assembly 294dfm may be enabled by any suitable door repositioning actuator subsystem 296adfm of vehicle door repositioning management system 250a that may be coupled to and extend between any suitable portion of door assembly 294dfm and structural assembly 297 of vehicle 290. Similarly, door assembly 294drm may be moved between (i) a fully closed position (e.g., as shown by FIGS. 2B-2E and 2M-2Y) whereby at least door body 294drmb may be securely held (e.g., latched) in a position against portion(s) of C-pillar 297cp, any B-pillar 297bp, lower structural member 297lsm, roof 299r, front main seat door assembly 294dfm, and/or the like for protecting a passenger seated in seat 294srm from being injured by a side collision in the −Y direction or from falling out of the vehicle in the +Y direction, and (ii) a fully open position (e.g., as shown by FIGS. 2 and 2G) whereby door body 294drmb may be securely held in a position with respect to structural assembly 297 of vehicle 290 that is substantially or completely out of the path of a user when entering into passenger cabin space 297pc from a left exterior side of the vehicle and seating themself in seat 294srm. Such movement of door assembly 294drm may be enabled by any suitable door repositioning actuator subsystem 296adrm of vehicle door repositioning management system 250a that may be coupled to and extend between any suitable portion of door assembly 294drm and structural assembly 297 of vehicle 290.

When both door assembly 294dfm and door assembly 294drm are closed (e.g., as shown by FIGS. 2B and 2M-2Y), a rear side 294dfmrs of door body 294dfmb may align with and/or latch with (e.g., using any suitable latching mechanism(s)) a front side 297bpfs of B-pillar 297bp and/or with a front side 294drmfs of door body 294drmb, a front side 294dfmfs of door body 294dfmb may align with and/or latch with (e.g., using any suitable latching mechanism(s)) a rear side 297aprs of A-pillar 297ap, a bottom side 294dfmbs of door body 294dfmb may align with and/or latch with (e.g., using any suitable latching mechanism(s)) a top side 297lsmts of a left portion lower structural member 297lsm, a top side of door 294dfm may align with and/or latch with upper structural member 297usm, a front side 294drmfs of door body 294drmb may align with and/or latch with (e.g., using any suitable latching mechanism(s)) a rear side of B-pillar 297bp and/or with a rear side 294dfmrs of door body 294dfmb, a rear side 294drmrs of door body 294drmb may align with and/or latch with (e.g., using any suitable latching mechanism(s)) a front side 297cpfs of C-pillar 297cp, a bottom side 294drmbs of door body 294drmb may align with and/or latch with (e.g., using any suitable latching mechanism(s)) top side 297lsmts of a left portion of lower structural member 297lsm, and/or a top side of door 294drm may align with and/or latch with upper structural member 297usm. In some embodiments, as shown, for example, in FIG. 2B, at least a portion of B-pillar 297bp (e.g., at least the portion of B-pillar 297bp that is below the height of door body 294dfmb and below the height of door body 294drmb) may be obfuscated (e.g., concealed or hidden from a user exterior to the left side of the vehicle) by door body 294dfmb and door body 294drmb when those door bodies are closed, while another portion B-pillar 297bp (e.g., a portion of B-pillar 297bp above the height of door body 294dfmb and above the height of door body 294drmb) may not be obfuscated by windows 294wfm and 294wrm when door assemblies 294dfm and 294drm are closed. It is to be noted that an additional door repositioning actuator subsystem for each one of the other doors of the vehicle (e.g., door 294dfa, door 294dra, etc.).

While some vehicle doors may be opened by swinging a door outward about a hinge that may be positioned between the door and a structural assembly of the vehicle (e.g., a hinge along a front surface of the door (e.g., along a Z-axis for rotation about that axis significantly in the +Y direction when opening), such as along front side 294dfmfs of door body 294dfmb and rear side 297aprs of A-pillar 297ap, where such a hinge may be hidden when the door is closed but visible along those sides when the door is open), and/or while some other vehicle doors may be opened by swinging a door upwards and forward by a hinge that may be positioned between the door and a structural assembly of the vehicle (e.g., a hinge along a top surface of the door (e.g., along an X-axis for rotation about that axis significantly in the +Y direction when opening), such as along a top side of door body 294dfmb and a bottom side of roof 299r, where such mechanisms may include multiple pivot points such that the door tilts or pivots out and up, and where such hinges leaves the door hanging over the entryway to the vehicle, potentially endangering users (e.g., their heads) as they enter or exit the vehicle), door repositioning actuator subsystem 296adfm and/or door repositioning actuator subsystem 296adrm of vehicle door repositioning management system 250a may enable the controlled opening and closing of its door assembly with minimal extension in the +Y direction while exposing a maximum space of access to passenger cabin space 297pc (e.g., opening the door first by moving door body 294dfmb away from structural assembly 297 of vehicle 290 in the +Y direction by an extension distance E when a length of actuator subsystem 296adfm is extended by distance E along an axis A of actuator subsystem 296adfm and then by rotating door body 294dfmb about axis A in the direction of arrow O, and closing the door first by rotating door body 294dfmb about axis A in the direction of arrow C and then by moving door body 294dfmb towards from structural assembly 297 of vehicle 290 in the −Y direction by extension distance E when a length of actuator subsystem 296adfm is reduced by distance E along axis A of actuator subsystem 296adfm).

Therefore, vehicle door repositioning management system 250a may include technologies relating to door control mechanisms for controlling the opening and closing of doors or panels, and, more particularly, to door control assemblies for controlling the opening and closing of vehicle doors and other doors, such as cabinet doors, where minimal extension (e.g., outward extension) and maximum access to the interior compartment are desirable. The technologies can also be implemented as door control mechanisms and hinge systems for controlling the opening and closing of doors or panels and, more particularly, to door control assemblies for controlling the opening and closing of large or heavy doors. The technologies of vehicle door repositioning management system 250a (e.g., door repositioning actuator subsystem 296adfm) may be configured to achieve a door opening that may completely open the entryway without the door protruding deep into a curb or street or otherwise endangering passengers or pedestrians. The technologies of vehicle door repositioning management system 250a may be configured to control the angle and pivot of the door and the depth of extension of the door, and to be able to control the movement of the door (e.g., based on any suitable sensors (e.g., based on any suitable vehicle sensor subsystem(s) 296) and/or based on any suitable vehicle status classification(s) of the current state of the vehicle (e.g., based on any vehicle status classification subsystem(s) 216)). In addition to operational improvement provided by door repositioning management system 250a, its technologies may be configured to allow for a more compact door control mechanism that does not detract from the aesthetic appearance of the door and/or the remainder of the vehicle. In addition to these improvements, the technologies of door repositioning management system 250a may be configured to utilize any suitable cavity of the door (e.g., as may be access from any suitable side thereof) to protect the users from rain and other elements upon entering and exiting the vehicle when the door is open (e.g., using an umbrella that may be configured to extend therefrom).

In some embodiments, a door repositioning actuator subsystem of a door repositioning management system may include a longitudinally extending and retracting rod that may also be configured to rotate with respect to a structural assembly of the vehicle as guided by a track and pin, such that a door coupled to the rod (e.g., to a free end of the rod) may be pushed out from the door opening past any adjacent side walls of the vehicle's support structure that may define the door opening (e.g., pillars, lower structural members, upper structural members, any adjacent door(s), etc.) and then rotated so that the door is positioned to the side of the door opening (e.g., a door opening 294dfmo of door assembly 294dfm (e.g., as may be defined by front side 297bpfs of B-pillar 297bp and/or front side 294drmfs of door body 294drmb, rear side 297aprs of A-pillar 297ap, top side 297lsmts of lower structural member 297lsm, and a bottom side of upper structural member 297usm), a door opening 294drmo of door assembly 294drm (e.g., as may be defined by a rear side of B-pillar 297bp and/or rear side 294dfmrs of door body 294dfmb, front side 297cpfs of C-pillar 297cp, top side 297lsmts of lower structural member 297lsm, and a bottom side of upper structural member 297usm), etc.).

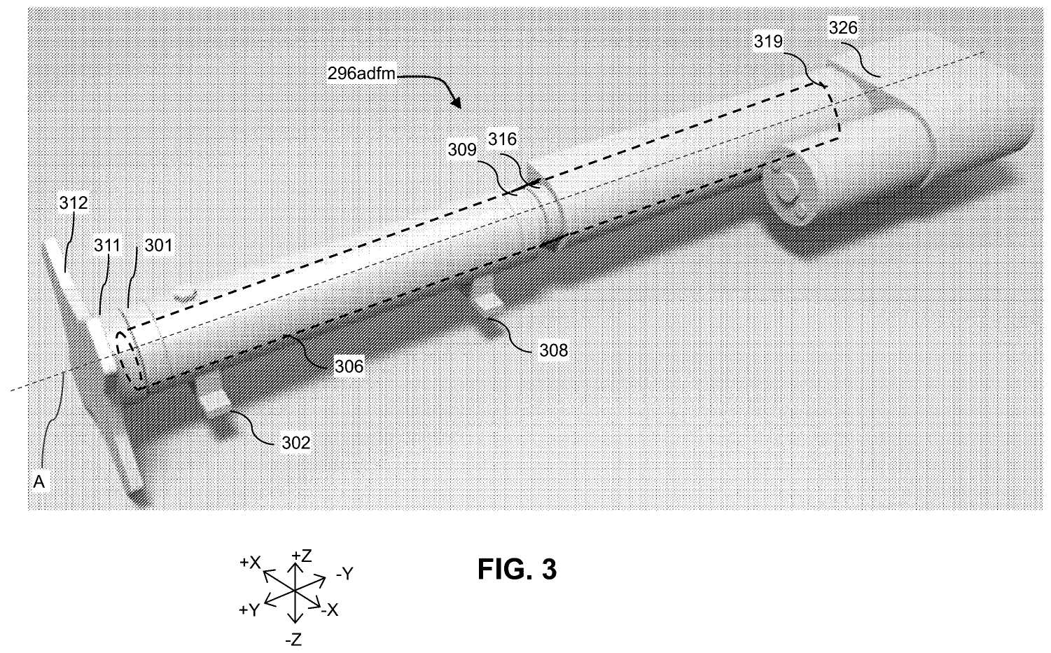

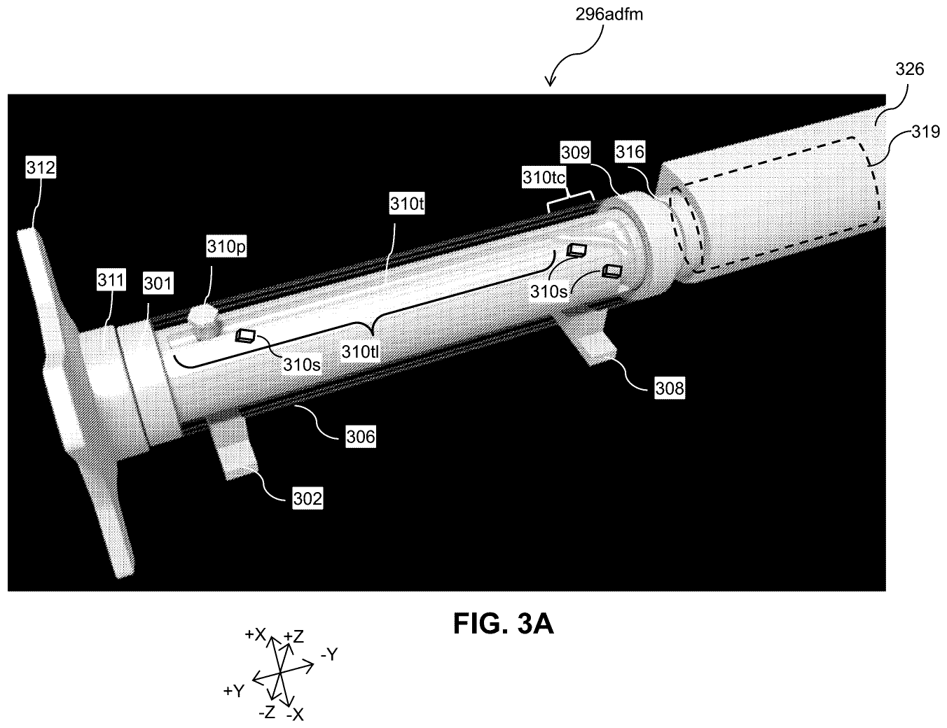

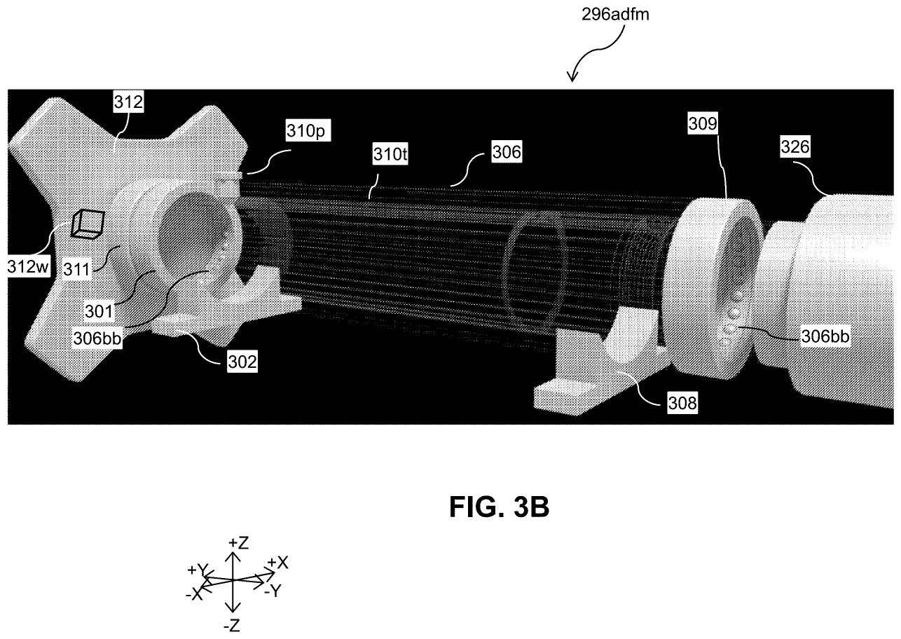

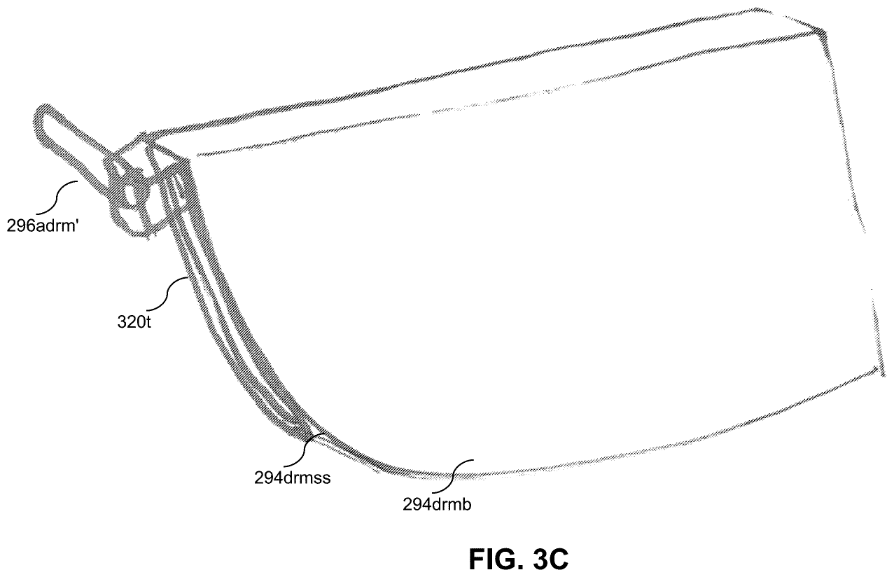

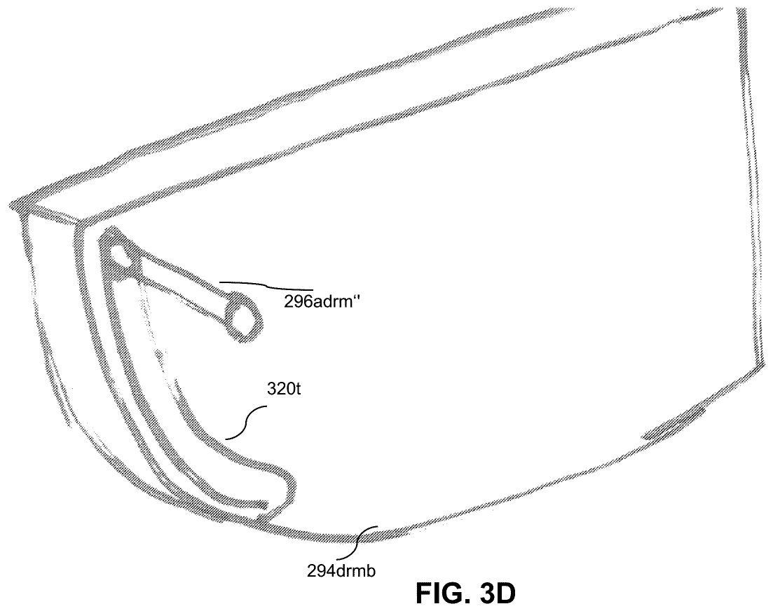

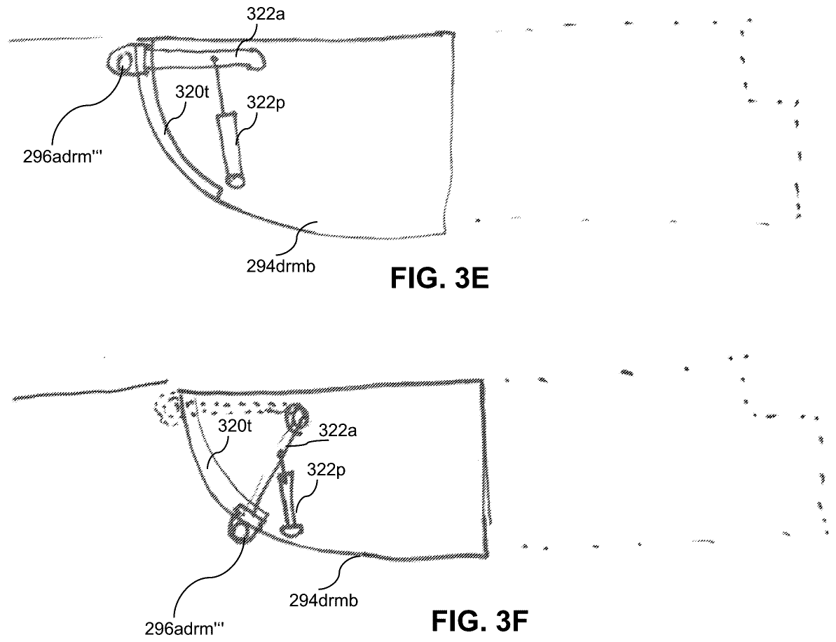

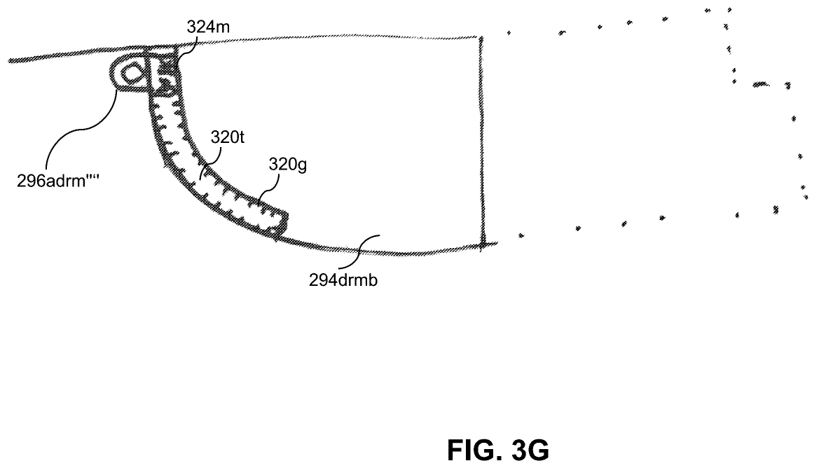

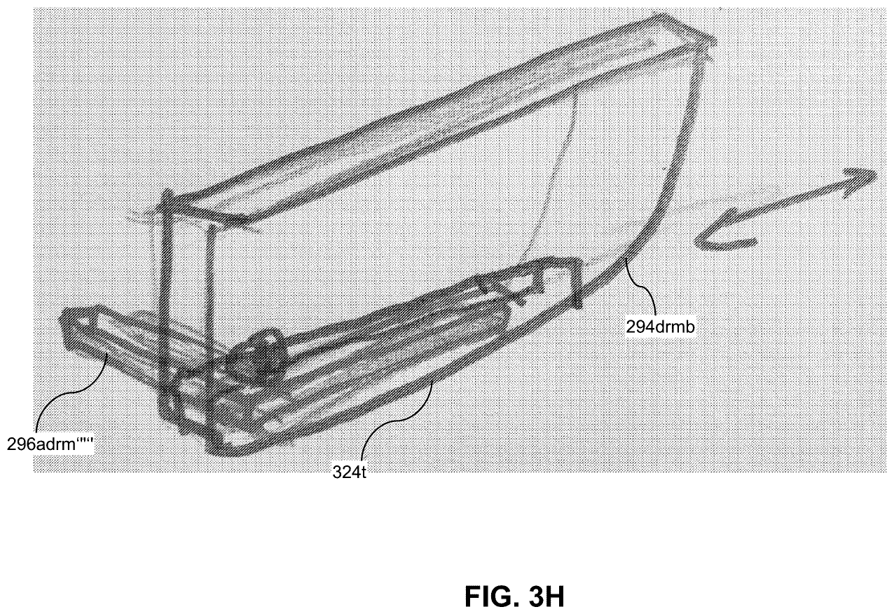

For example, as shown in FIGS. 2A, 2D, 2F, 3, 3A, and 3B, door repositioning actuator subsystem 296adfm may include one or more vehicle mounting plates (e.g., plates 302 and 308 (e.g., U-shaped mounting plates)) that may be coupled to any suitable portion(s) of the structural assembly of the vehicle (e.g., to top side 297lsmts of lower structural member 297lsm in front of pedals 294bpdl and 294apdl (e.g., below a floor board), or higher up (e.g., behind a dashboard) or otherwise (e.g., within passenger cabin space 297pc or hidden from a passenger by some decorative surfaces) that may be adjacent a wall of door opening 294dfmo). Door repositioning actuator subsystem 296adfm may also include a hollow outer tube 306 that may extend between an exterior end 301 and an interior end 309 along axis A of actuator subsystem 296adfm and define a hollow passageway 305 therealong. Hollow outer tube 306 may be coupled to and supported by vehicle mounting plates (e.g., plates 302 and 308) for fixing the position of hollow outer tube 306 with respect to the structural assembly of the vehicle. Door repositioning actuator subsystem 296adfm may also include an inner piston rod or actuator rod 316 that may extend between an exterior end 311 and an interior end 319 and may be positioned to pass through hollow passageway 305 of hollow outer tube 306 along axis A of actuator subsystem 296adfm. Door repositioning actuator subsystem 296adfm may also include a door mounting plate 312 provided by exterior end 311 of rod 316 that may be coupled to any suitable portion(s) of door assembly 294dfm (e.g., to an interior or right side 294dfmis of door body 294dfmb or to an internal structure of door body 294dfmb or otherwise). Door repositioning actuator subsystem 296adfm may also include any suitable actuator assembly 326 (e.g., any suitable hydraulic actuator, electric actuator, mechanical actuator, linear actuator, and/or the like) that may be configured to push and pull rod 316 along axis A (e.g., using any suitable power sourced by vehicle 290 and under the control of any suitable processor capability of vehicle 290). Door repositioning actuator subsystem 296adfm may also include any suitable pin 310p that may be configured to travel within and with respect to any suitable track 310t. In some embodiments, track 310t may be defined by and/or through an exterior surface of rod 316 between ends 311 and 319, while pin 310p may be coupled to and extend from tube 306 between ends 301 and 309 and into track 310t, such that when rod 316 is pushed or pulled along axis A, pin 310p of tube 306 may interact with moving track 310t of moving rod 316 to dictate any limits or direction or orientation of the movement of rod 316. For example, track 310t may include a linear portion 310tl that extends longitudinally along a portion of tube 306 parallel to axis A (e.g., along a Y-axis) and then transitions into a curved portion 310tc that may extend about at least a portion of a tube 306 about axis A. In some embodiments, a length of linear portion 310tl (see, e.g., FIG. 3A) may be equal to distance E (see, e.g., FIG. 2D), such that movement of pin 310p along linear portion 310tl of track 310t may define the amount that door body 294dfmb may be pushed away from or pulled towards door opening 294dfmo when door assembly 294dfm is being opened or closed. Additionally or alternatively, a circumferential amount by which curved portion 310tc may extend about axis A of tube 306 may be equal to the amount by which door body 294dfmb may be rotated about axis A in the direction of arrow O and/or arrow C when door assembly 294dfm is being opened or closed. Alternatively, in some embodiments, track 310t may be defined by and/or through tube 306 between ends 301 and 309, while pin 310p may be coupled to and extend from an exterior surface of rod 316 between ends 311 and 319 and into track 310t, such that when rod 316 is pushed or pulled along axis A, track 310t of tube 306 may interact with moving pin 310p of moving rod 316 to dictate any limits or direction or orientation of the movement of rod 316. Therefore, a design of door repositioning actuator subsystem 296adfm may be such that the piston can be installed under the floorboard of a vehicle so no door mechanism may be exposed (e.g., visible to a user) until the door is at least partially opened, and then only rod 316 may be exposed. The rod may be a hydraulic, electric, mechanical, or other linear actuator that has a pin and pushes itself out through a track that may curve at the time the door rotates and is guided by the pin, or that has a track that curves at the time the door should rotate and pushes itself out through an opening with a pin that guides the track. Any suitable counterweight 312w may be coupled to door body 294dfmb (e.g., attached thereto via door mounting plate 312 or otherwise), such as to the side of the door mounting plate opposite the longer side of the door (e.g., on the inside of the turning radius), such that actuator assembly 326 may require less force to push or pull rod 316 through the turn (e.g., the turn that may be defined by curved portion 310tc of track 310t). In some embodiments, repositioning actuator subsystem 296adfm may include or have access to any suitable sensors to monitor any characteristics of the status of the vehicle (e.g., any suitable vehicle sensor subsystems 295) and such monitoring may be configured (e.g., through any suitable application(s)) to adjust the position or functionality of any suitable switches 310s that may be provided by repositioning actuator subsystem 296adfm (e.g., along or adjacent track 310t) to selectively adjust a functional geometry of track 310t (e.g., to selectively adjust a length of linear portion 310tl of track 310t and/or to selectively adjust a circumferential amount by which curved portion 310tc may extend about axis A). Therefore, repositioning actuator subsystem 296adfm may be configured to monitor travel and control the start and stop of the actuator rod travel, such that the travel distance may be adjusted by moving the switches or adjusting settings (e.g., to adjust the distance the door extends or rotates during opening or closing or otherwise).

In some embodiments, one or more sensors of vehicle 290 may be provided to detect additional tension on the door such that a voice or alarm system can warn someone to remove their hand from the door so it may move safely. For example, door assembly 294dfm may include any suitable sensor(s) at the bottom and/or sides of the door (e.g., sensor 295h) and/or in the frame of the door (e.g., along the door opening) (e.g., sensor 295h′) to detect any objects that may be positioned within the path of the door when it is opening or closing (e.g., to ensure no fingers or other items are crushed by the door closing), and this may also be monitored by sensing additional tension while closing the door, which a safety algorithm can then utilize to cause the door to stop its motion and reverse direction slightly.

In some embodiments, one or more sensors of vehicle 290 may be provided to detect a current on the door (e.g., a change in current from a human touching a door surface, which may be metallic or treated with conductive metallic material or coated in such a conductive paint or resin) (e.g., sensor 295a), whereby a voice or alarm system can warn someone to remove their hand from the door so it may move safely.

In some embodiments, an automated umbrella opener actuator 296h may be provided by a door (e.g., along bottom side 294dfmbs of door body 294dfmb) that may be configured to automatically open and/or make available an umbrella 291u to a user (e.g., once the door is completely opened and when any suitable subsystem of the vehicle has determined that the weather is rainy or sunny or otherwise demanding of shade or protection for a passenger and/or upon request by a passenger that may be exiting the vehicle via the opened door). For example, the door can be configured to include a tube and an actuator or piston that may push the umbrella opening button causing the umbrella to open or close, and another actuator that may pulls the umbrella back into the door or out of it when appropriate.

Door repositioning actuator subsystem 296adfm may be configured to provide a door opening and closing mechanism that enables the opening and closing of an automotive or other door via a single, fluid motion by extending or retracting a rod that rotates as guided by a track and pin, such that the door pushes out past any exterior side walls of the vehicle (e.g., in the +Y direction past any suitable exterior side wall(s) 297ew of vehicle 290 (e.g., of a driver side mirror 297dsm (e.g., as may be coupled to or provided by A-pillar assembly 297ap))) and then rotates so the door is to the side of the door opening (e.g., door body 294dfmb is to the side of opening 294dfmo), with only the thickness of the door (e.g., thickness T of door body 294dfmb) plus a small gap (e.g., an amount of dimension E that is greater than dimension T) added to the width of the vehicle once the door is open (e.g., a width of the vehicle along the Y axis).

Door repositioning actuator subsystem 296adfm of door repositioning management system 250a may be configured to provide considerable technical advantages and improvements over other solutions. For example, the vehicle can be opened without needing the significant clearances required by hinged doors (e.g., hinged by a hinge extending along the Z-axis and by a hinge extending along the X-axis). Doing so can enable parking or placement in narrower areas. As another example, the vehicle door can be opened without complex and heavy mechanisms, such as those required for “scissor doors” or “Lamborghini doors.” As another example, door repositioning actuator subsystem 296adfm may be configured to provide the ability to hide the mechanisms entirely under the floorboard of the vehicle (e.g., out of reach of dirt, debris, or fingers, thus protecting fingers from being caught in mechanisms). The described technologies may allow fully powered, automatic opening and closing of the side doors at a controlled and safe pace, providing additional comfort and convenience to passengers. The described technologies may protect hands and other body parts from being “jammed” by doors. The described technologies may move the door to the side of the opening, rather than other solutions that may block full access to the opening and can be an obstacle to a user's leg (or, in the case of “scissor doors” or “Lamborghini doors”, can come into contact with a passenger's head). The described technologies may allow doors to be recessed into the vehicle so that any suitable side walls (e.g., exterior side walls 297ew (e.g., around one or more wheels of the vehicle)) may protrude out by a distance P (e.g., inches (e.g., along the Y axis)) from where the doors are located, ensuring that side impact accidents may cause the impacting vehicle (e.g., in the −Y direction) to hit the wheel areas (e.g., hood and boot/trunk) and not the doors, so that the “crumple zones” of the hood and/or boot or otherwise may absorb the impact. As the described technologies may enable movement of the doors to be electronically controlled, sensors can determine if a finger or other object is caught between the door and door sill or wall, to stop and reverse movement to prevent injury. As the described door can rotate (e.g., 90 degrees (e.g., in the direction of arrow C and/or arrow O)), an automatic extending umbrella can be included. Passengers can take such an umbrella once it is released without being exposed to rain or sun while exiting the vehicle. The described technologies may prevent doors from swinging out into bicycle traffic, which is a frequent cause of injury to cyclists who can come into contact and flip over the door and smash into pavement at high speed. It can therefore be appreciated that the described technologies provide numerous advantages and improvements over existing solutions.

FIG. 2A may depict an example implementation of door repositioning actuator subsystem 296adfm and door repositioning actuator subsystem 296adrm installed into a four door sedan vehicle 290. As shown, these door repositioning actuator subsystems may enable the doors to swing open, allowing unobstructed access to the passenger cabin. These door repositioning actuator subsystems may be mounted or affixed to the bottom or side or top of a vehicle structural assembly.

FIG. 3 is a close-up depiction of door repositioning actuator subsystem 296adfm in accordance with certain implementations.

FIG. 3A depicts internal components of door repositioning actuator subsystem 296adfm (e.g., including an interior rod and a cutaway showing the pin that may guide a track, as described herein).

FIG. 3B depicts the referenced pin and the tracks rendered in outlines, as well as ball bearings 306bb (e.g., within end 301 and/or end 309 of tube 306), which may allow rod 316 to rotate smoothly therein.

As described and depicted herein, the door control mechanism can include components to push a piston out, and components to guide the piston to rotate at designated time(s), and components for the piston to connect to the door. In this way, the piston may be pushed out such that the sides of the door may clear the opening and sides of the vehicle and then rotate such that the door is rotated out of the way of the opening of the door.

FIG. 2D depicts an example implementation of door repositioning actuator subsystem 296adfm, which may be concealed under the floor of the vehicle (or positioned even lower so the floor may be flat). As also shown in FIG. 2D, the door may clear even a very wide “side” of the car. For example, when implemented to open the driver's door of a vehicle, the door control mechanism can be mounted to the bottom of the vehicle at the front of the driver's door opening (e.g., beneath and/or in front of the position of the driver's pedals). When the piston is pushed outwards and rotates towards the front of the vehicle, the door may rotate in front of the front fender of the vehicle and out of the way of the driver's seat and wheel well, thereby allowing the driver to enter and exit the vehicle without a door in the way.

FIG. 2C depicts another view of the door first being pushed out (e.g., when it is opening or closing). FIG. 2E shows the door further rotated (e.g., after it clears the side of the vehicle). As shown in FIG. 2E, since the door may rotate upwards (e.g., instead of outwards), very little clearance may be needed.

FIG. 2F depicts a rear-side perspective of the doors, according to some implementations. Also shown in FIG. 2F is the rod of door repositioning actuator subsystem 296adfm and the rod of door repositioning actuator subsystem 296adrm that may be opening its respective door by being pushed out (e.g., in the +Y direction) and rotated (e.g., about the Y-axis (e.g., via track and pin)).

FIG. 2G depicts a side perspective view of a vehicle with the doors (e.g., driver side front and rear) pushed out and rotated open by the door repositioning actuator subsystems.

FIG. 2B depicts the doors in a closed position. As shown in FIG. 2B, the doors may be able to clear wide sidewalls while also being deeply embedded for safety and aerodynamics (e.g., allowing mirror 297dsm to be part of the front of the car and not stick out to cause additional air displacement or disturbance).

In certain implementations, the door can be pushed in or pulled out and rotated with manual power (e.g., by a user). Alternatively, a piston can be powered by an electric motor (e.g., comparable to a linear actuator), hydraulics, electromagnets, or other such components (e.g., actuator 326).

Any suitable power source can be integrated with feedback mechanisms, including stop switches. Such components can be configured to stop pushing (e.g., opening) and/or pulling (e.g., closing) the door once the door has reached a desired position. Any suitable sensors, such as pressure sensors and motion sensors, can also be integrated. Such components can be configured to adjust or stop the motion of the door upon determining whether the door is likely to come into contact with a curb or human (e.g., to prevent it from closing on a hand or smashing into a curb).

A piston or mechanism can incorporate a position sensor or sensors that may provide feedback for other components. For example, lighting of the vehicle (e.g., lighting output components or lighting actuator subsystems 296) can be configured to change based on a determined position of the door (e.g., to light the ground around the vehicle as the door opens and/or to turn the lights off as it closes). In another example, the vehicle may be configured to change the color and/or intensity of the lighting inside and/or outside as a door opens and/or closes (e.g., to provide stylized and dramatic effects, where such effects can be customized (e.g., via the vehicle's app or infotainment system on any suitable subsystem 220)).

In some embodiments, the vehicle can be configured to adjust a climate control system and air vents and blowers or any combination of them (e.g., an HVAC system) as the door opens and/or closes. For example, in cold weather, as the door opens, the vehicle may be configured to automatically increase the heat blown as the door opens and decrease it as the door closes. In another example, the door can be configured to close and/or lock storage component(s) (e.g., a storage component door 294scd (e.g., on an interior side 294dfmis of door 294dfmb)) so items do not fall out from the storage component when the vehicle door moves between a closed and open position. In another example, the vehicle door can retract components 294dcc (e.g., such as an armrest) into the door (e.g., in the +Y direction) so the door is narrower when it is opened and the vehicle does not need as much space on the side to open the door (e.g., along the Y axis). In another example, a vehicle door can lower its window into the door (e.g., window 294wfm down into door body 294dfmb and/or window 294wrm down into door body 294drmb (e.g., in the −Z direction)) before or as the door opens (e.g., to prevent the window from hitting anything) and/or raise the windows before or as the door closes or after the door closes. In some embodiments, in response to initiating a door opening event, vehicle door repositioning management system 250a may be configured to automatically lower a door window (e.g., at least partially or completely) before or while rotating the door during a door opening event (e.g., prior to first moving the door outwardly from the vehicle (e.g., along the Y-axis), while moving the door outwardly from the vehicle, after moving the door outwardly from the vehicle but prior to rotating the door, and/or while rotating the door during a door opening event), which may reduce the chance of or prevent the window from impacting an object and breaking the window. Additionally or alternatively, in some embodiments, in response to initiating a door closing event, vehicle door repositioning management system 250a may be configured to automatically raise a door window (e.g., at least partially or completely) after or while rotating the door during a door closing event (e.g., while first rotating the door (e.g., about the Y-axis) to align with the door opening, after rotating the door but before moving the door inwardly towards the vehicle (e.g., along the Y-axis), while moving the door inwardly towards the vehicle, and/or after moving the door inwardly towards the vehicle but before completing the closing process), which may reduce the chance of or prevent the window from impacting an object and breaking the window during the door closing event but may return the window to a closed state (e.g., always or only when the window was in a closed state just prior to the last door opening event).

The referenced piston can include or incorporate a track, and a ring mounted to the mechanism or vehicle with a stationary pin (or ball bearing or wheel) can guide the track such that the piston may rotate as its track curves.

Alternatively, the piston can have the pin (or ball bearing or wheel) be pushed through an outer cylinder that has a track that guides the pin (or ball bearing or wheel) causing the piston to rotate. The cylinder can be cylindrical on the outside or it could be cylindrical on the inside but be molded or milled out of a rectangular or other outer shape.

In certain implementations, the referenced cylinder or ring can be constructed as separate components that may be attached to the vehicle or pushing mechanism. Alternatively, the referenced cylinder or ring can be part of the pushing mechanism housing or be part of the vehicle. For example, a carbon fiber vehicle monocoque can have the cylinder or ring molded into the bottom or side of it.

In certain implementations, the described piston, cylinder, ring, pushing mechanism housing, door mounting components, floor/side mounting components, ball bearing, ring, wheel and/or any other components of door repositioning actuator subsystem 296adfm can be made from aluminum or other metals or composite materials such as carbon fiber. They can also be made from a combination of materials. For example, the described cylinder or ring can be made from carbon fiber but with a titanium pin or ball bearing guiding the track and/or with bolts made of titanium or another metal. It should be understood that the type of metal and materials do not change the functionality of the mechanism but can allow the user to control for weight of the vehicle (e.g., by using titanium components instead of steel to reduce weight).

The door mechanism can also include a counterweight. Such a counterweight can remain in place or move (e.g., slide, raise, and/or lower) on the side of the door as the door rotates (e.g., weight 312w may be configured to move along interior side 294dfmis of the door as it rotates about axis A). Doing so can reduce the torque on the piston and balance the weight of the door as it rotates such that it may remain nearly even above the piston but with the weight slightly higher on the side, which may ease the load on the piston moving mechanism, thereby reducing the torque and power needed.

FIG. 3C depicts a track 320t on an edge 294drmss of door body 294drmb, such that a connection point where a piston of a door repositioning actuator subsystem 296adrm′ may couple to the door can move up and down, thus moving the pivot point of the door. This may allow a door with a curved or angled back side to be pivoted out of the way of the passenger area (e.g., to clear the entryway), even if the piston cannot be located at the ideal pivot point. A slot (e.g., opening) to track 320t where the piston connects can, for example, be on the outside edge of the door (e.g., as shown in FIG. 3C), or on the side of the door (e.g., as shown in FIG. 3D by a door repositioning actuator subsystem 296adrm″). The connection point can move along the track (e.g., up/down) by a gear being turned inside a tooth track or other friction track method (e.g., rubber wheels), magnetic propulsion, or via a swing arm moved by a piston (e.g., as shown in FIGS. 3E and 3F by a swing arm 322a that may be moved by a piston 322p), magnet, motor, and/or the like.

FIG. 3D depicts a track on the side of a door, such that the connection point where the piston of a door repositioning actuator subsystem 296adrm″ connects to the door can move up and down, thus moving the pivot point of the door. This may allow a door with a curved or angled back side to be pivoted out of the way of the passenger area (e.g., to clear the entryway), even if the piston cannot be located at the ideal pivot point.

FIGS. 3E and 3F depict how a piston (shown) or motor (not shown) of a door repositioning actuator subsystem 296adrm′″ can rotate an arm to move the pivot point along a track. In certain implementations, the arm can be adjustable in length. Once the pivot point is moved toward the bottom of the door, as shown in FIG. 3F, the door rotates (e.g., left) out of the way of the entry area.

FIG. 3G depicts how a pivot connection point can be attached to a small motor 324m that may move inside the track via gear(s) and teeth, according to certain implementations of a door repositioning actuator subsystem 296adrm″″. Doing so may enable the door to be slid up and down before the pivot point rotates.

In the examples shown in FIGS. 3C-3G, the piston can push out and the door may slide to the new pivot location, and then the piston may rotate. This can be timed (e.g., by the curve of the track guiding the piston, and/or by sensors and a processing device) to be a fluid motion, so the door may be slid to the correct position just as the piston arm begins to rotate.

FIG. 3H depicts an example embodiment in which the piston of a door repositioning actuator subsystem 296adrm′″″ may push out, and attached to the end of the piston is a track 324t upon which a door can slide, such that a door can be pushed further out from the vehicle and then slide back. The piston can rotate (e.g., to provide more ground clearance as the door slides out) or not. This may enable sliding doors (e.g., for both front and rear doors, and even a trunk) without the need for exposed tracks, or even the need for top and bottom tracks.

The sensors referenced above (e.g., for motion and pressure and/or otherwise) can be mounted on the sides or bottom of the door panel or along the piston or otherwise. In certain implementations, a sensor can be configured to gauge power output and resistance as the door pushes. Doing so can enable an integrated processor or computing system to determine if the door has encountered an obstacle.

In certain implementations, the door mechanism can be controlled in various ways, such as by buttons on the outside and/or inside of the vehicle, key fob, buttons in an app or infotainment system, and/or the like. The described door mechanism can also be activated remotely (e.g., over the internet or wireless control). The door mechanism can also be activated via various communication protocols (e.g., RFID, NFC, etc.), fob, card, ring, bracelet, or other object, such that placing the fob (for example) next to a sensor on the outside of the vehicle may cause the door (or doors) to open and/or close.

The described door mechanism can integrate or operate in conjunction with cameras or other visual sensors on the outside and/or inside of the vehicle, such that recognition of the driver and/or passenger(s) can initiate opening the door (and closing it once they are seated).

The described sensor and camera integrations can be used for a cabinet, such that when an owner of the cabinet approaches, the cabinet door opens automatically. This can be advantageous by enabling opening of the door while the user's hands can remain free to hold items without needing to handle the doors. For example, a cabinet with emergency supplies or food or cleaning equipment can be configured to open automatically upon determining the owner is approaching the cabinet.

The described door mechanisms can use their sensors and power control to sync not only with all the doors and openings on the car (or cabinet) to which they are attached, but to open and close in sync with doors on other vehicles (or cabinets).

A door control mechanism may be provided for connecting a door of a vehicle to the body of the vehicle, wherein the mechanism has a closed state in which the door is closed and an open state in which the side door is open, the door control mechanism including: (a) a mount to connect the door to a piston, (b) a track to guide the piston such that it pushes in/out and turns at times along the track, wherein the track may be embedded or attached to the piston, or may be in an outer cylinder, (c) an outer cylinder or ring containing the track or pin, (d) an inner cylinder, the piston, containing the track or pin, (e) a pin which inserts into the track, wherein the pin may be solid or a wheel or ball bearing, and it may be attached to or molded-into or fit-into the piston or the outer cylinder/ring, (f) a mechanism for pushing (“pushing mechanism”) out the piston, which may be an electronic linear actuator, hydraulic actuator, or magnetic propulsion. These may push the piston, or which may be attached to a piston which pushes the above mentioned rotating piston via a rotating joint. In some embodiments, the door control mechanism may include sensors (such as push switches) which tell the control mechanism the position of the door (such as when it is fully opened, fully closed, about to turn, and the like. In some embodiments, the door control mechanism may include sensors which tell the control mechanism the rotation of the door. In some embodiments, the door control mechanism may include sensor(s) to detect if any object(s) block the path of the door, for example to prevent the door from opening into a wall or curve. In some embodiments, the door control mechanism may include sensors which detect objects between the door edges and the vehicle (or cabinet) so as to prevent crushing these objects. In some embodiments, the door control mechanism may include a sensor to detect a change in electric current on the door via metallic material in the paint such as to detect human touch on the door. In some embodiments, the door control mechanism may include a circuit for controlling the speed and direction of the mechanism, for gathering and processing sensor data, and/or for interacting with other devices (such as the car's infotainment system, main computer, navigation system, etc.). In some embodiments, the door control mechanism may include camera(s) to detect if any object is or will block the path of the door, the same camera(s) can be used to detect a person approaching the door(s) and to open the appropriate door(s). For example, the cameras and integrated image recognition may detect the owner of the car and open the driver's door. These cameras may be placed on the sides of the vehicle, the roof, the inside, the mirror, the edges of the door, and may be placed in different locations so as to capture the full area around the vehicle without obstruction. In some embodiments, the door control mechanism may include a sensor to detect pressure, so as to determine if the door has hit an object and stop and reverse movement to avoid damage. In some embodiments, the door control mechanism may include a pressure or sound sensor to detect a tap or pattern of tapping on the door so as to open the door without needing a button or handle. In some embodiments, the door control mechanism may include a mechanism to push out and extend an umbrella after the door opens. This mechanism may be activated by the car's computer or by the press of a button or via an app (on the user's phone or the car's system). In some embodiments, the door control mechanism may include cameras to detect that the owner is carrying bags and open the door and trunk, and/or the cameras may detect the owner is walking toward the vehicle with a child and open the rear door (and optionally do other things such as unfold a child seat, switch to quiet mode to turn off audio prompts so the child doesn't wake, etc.). In some embodiments, the door control mechanism may communicate with other door control mechanisms so all doors (and even hoods, trunks, roof, etc.) on the vehicle can open/close at the same pace. In some embodiments, the door control mechanism may include a camera to detect that the person is fully seated and the door automatically closes. In some embodiments, the door control mechanism may include a voice recognition system that allows the user(s) to close one or more doors, such as by saying, “close the driver door”, or “close all doors”, or the like. In some embodiments, the car (or cabinets) lighting changes based on the position of the door, for example to light the ground around the vehicle as the door opens and to turn the lights off as it closes. Another example, the car might change the color and/or intensity of the lighting inside and outside as the doors open and close, to provide stylized and dramatic effects. In some embodiments, the user can adjust and program these effects to their liking via the vehicle's app or infotainment system. In some embodiments, the door control mechanism may include cameras that may detect that the owner is approaching with a bicycle and slide out a bike rack. In some embodiments, the car (or cabinet/room) can adjust the climate control system and air vents and blowers or any combination of them as the doors open. For example, if it is very cold, as the doors open the car can increase the heat blown as the doors open and decrease as the doors close. In some embodiments, the door may lock components, such as a storage door (for example a “map pocket”) so that items do not fall out. In some embodiments, the door may retract components, such as an armrest, so the door is narrower when it is open and the car does not need as much space on the side to open the door. In some embodiments, the door may lower the windows into the door as the door opens (to prevent the window from hitting anything, for example) and lift the windows as the door closes. In some embodiments, the rotational connection (joint) between the actuator and the piston has a slanted connection such that when it turns the piston tilts up, lifting the bottom of the door off the ground so as to lift the bottom of the door further off the ground. In some embodiments, the connection to the door includes an additional piston inside the door, such that, as the door rotates, the piston lifts the door so that when it pushes out it also lifts up.

A particular object repositioning management system may be a vehicle rack repositioning management system 250b that may be configured to manage the movement of rack 298r between various positions with respect to structural assembly 297 of vehicle 290 (e.g., with respect to a rear portion 297lsmr of lower structural member 297lsm (e.g., underneath rear trunk or cargo space 297trs), C-pillar 297cp, and/or the like). For example, rack 298r may be moved between (i) a fully closed position (e.g., as shown by FIGS. 2, 2A, 2F, and 2N-2T) whereby rack 298r may be completely securely held within rack holding space 298rhs of rack sleeve 298rs that may be positioned at least partially interior to and/or under the housing of the vehicle (e.g., a sleeve that may be coupled to any suitable portion of the vehicle, such as a floorboard or lower structural member 297lsm (e.g., underneath rear trunk or cargo space 297trs)), (ii) a first partially open position (e.g., as shown by FIG. 2H) whereby rack 298r may be at least partially extended out from rack holding space 298rhs of rack sleeve 298rs along a longitudinal axis S of rack 298r (e.g., in the −X direction) by any suitable partial distance d (e.g., a partial distance between exterior rack sleeve opening 298rso and a most distal end point 298rde of rack 298r (e.g., 0<d<D) when the rack is only partially extended out), (iii) a second partially open position (e.g., as shown by FIG. 2I) whereby rack 298r may be fully extended out from rack holding space 298rhs of rack sleeve 298rs along longitudinal axis S of rack 298r by any suitable maximum distance D (e.g., a distance between exterior rack sleeve opening 298rso and a most distal end point 298rde of rack 298r when the rack is fully extended out), (iv) a third partially open position (e.g., as shown by FIGS. 2J and 2K) whereby rack 298r may not only be fully extended out from rack holding space 298rhs of rack sleeve 298rs longitudinally along longitudinal axis S but may also be fully expanded out laterally along a latitudinal axis L of rack 298r (e.g., in the +Y direction and/or −Y direction) by any suitable amount (e.g., a rack element with most distal end point 298rde may rotate (e.g., about a Z-axis (e.g., in an X-Y plane)) in the direction of arrow OL such that rack 298r may expand out laterally (e.g., in the −Y direction and/or the +Y direction), and (v) a fully open position (e.g., as shown by FIGS. 2L and 2M) whereby rack 298r may not only be fully extended out from rack holding space 298rhs of rack sleeve 298rs longitudinally along longitudinal axis S and fully expanded out laterally along latitudinal axis L but may also be fully expanded out vertically along a vertical axis V of rack 298r (e.g., in the +Z direction and/or −Z direction) by any suitable amount (e.g., a rack element with a most vertical end point 298rve may rotate (e.g., about a X-axis (e.g., in a Y-Z plane)) in the direction of arrow OV such that rack 298r may expand out vertically (e.g., in the +Z direction and/or the −Z direction). Similarly, rack 298r may be moved between (i) a fully open position (e.g., as shown by FIGS. 2L and 2M) whereby rack 298r may not only be fully extended out from rack holding space 298rhs of rack sleeve 298rs longitudinally along longitudinal axis S and fully expanded out laterally along latitudinal axis L but may also be fully expanded out vertically along a vertical axis V of rack 298r (e.g., in the +Z direction and/or −Z direction) by any suitable amount (e.g., a rack element with a most vertical end point 298rve may rotate (e.g., about a X-axis (e.g., in a Y-Z plane)) in the direction of arrow 0V such that rack 298r may expand out vertically (e.g., in the +Z direction and/or the −Z direction), (ii) a third partially open position or first partially closed position (e.g., as shown by FIGS. 2J and 2K) whereby rack 298r may not only be fully extended out from rack holding space 298rhs of rack sleeve 298rs longitudinally along longitudinal axis S but may also be fully expanded out laterally along a latitudinal axis L of rack 298r but may be retracted vertically along vertical axis V of rack 298r (e.g., in the +Z direction and/or −Z direction) by any suitable amount (e.g., a rack element with a most vertical end point 298rve may rotate (e.g., about a X-axis (e.g., in a Y-Z plane)) in the direction of arrow CV such that rack 298r may retract vertically (e.g., in the +Z direction and/or the −Z direction), (iii) a second partially open position or a second partially closed position (e.g., as shown by FIG. 2I) whereby rack 298r may be fully extended out from rack holding space 298rhs of rack sleeve 298rs along longitudinal axis S of rack 298r by any suitable maximum distance D but may be fully retracted laterally along latitudinal axis L of rack 298r (e.g., in the +Y direction and/or −Y direction) by any suitable amount (e.g., a rack element with most distal end point 298rde may rotate (e.g., about a Z-axis (e.g., in an X-Y plane)) in the direction of arrow CL such that rack 298r may retract laterally (e.g., in the −Y direction and/or the +Y direction)), (iv) a first partially open position or a third partially closed position (e.g., as shown by FIG. 2H) whereby rack 298r may be at least partially retracted into rack holding space 298rhs of rack sleeve 298rs along longitudinal axis S of rack 298r (e.g., in the +X direction), and (v) a fully closed position (e.g., as shown by FIGS. 2, 2A, 2F, and 2N-2T) whereby rack 298r may be completely securely held within rack holding space 298rhs of rack sleeve 298rs that may be positioned at least partially interior to and/or under the housing of the vehicle (e.g., a sleeve that may be coupled to any suitable portion of the vehicle, such as a floorboard or lower structural member 297lsm (e.g., underneath rear trunk or cargo space 297trs)). In some embodiments, the third partially open position or first partially closed position (e.g., as shown by FIGS. 2J and 2K) may be the fully open position if the rack is not configured to also expand vertically. That third partially open position or first partially closed position of rack 298r (e.g., as shown by FIGS. 2J and 2K) may be configured to provide a substantially flat surface on which any suitable cargo may be placed and supported (e.g., cargo 291cf, which may have a flat bottom to rest on a flat surface provided by the laterally expanded but not vertically expanded configuration of rack 298r). That third partially open position or first partially closed position (e.g., as shown by FIGS. 2J and 2K) may be configured to provide a substantially flat surface (e.g., in an X-Y plane) on which any suitable cargo may be placed and supported (e.g., cargo 291cl of FIG. 2K, which may have a flat bottom to rest on a flat surface provided by the laterally expanded but not vertically expanded configuration of rack 298r (e.g., a cargo box or cooler that may be held against rack 298r using any suitable mechanism(s)). A fully open position of rack 298r (e.g., as shown by FIGS. 2L and 2M) may be configured to provide a substantially flat surface (e.g., in an X-Y plane) on which any suitable cargo may be placed as well as one or more vertical support members (e.g., in one or more Y-Z planes) on and against which any suitable cargo may be placed and supported (e.g., cargo 291cv of FIG. 2M, which may have a flat bottom to rest on a flat surface provided by the laterally expanded portion of rack 298r and which may have a vertical side to rest against a vertical surface provided by the vertically expanded portion of rack 298r (e.g., a bicycle that may be held against rack 298r (e.g., between different vertically expanded portions of the rack and/or using any suitable mechanism(s)))). Such movement of rack 298r between fully open and closed positions may be enabled by any suitable rack repositioning actuator subsystem 296ar of vehicle rack repositioning management system 250b that may be coupled to and extend between any suitable portion of rack 298r and structural assembly 297 of vehicle 290.

When rack 298r is fully closed (e.g., retracted fully within rack holding space 298rhs of rack sleeve 298rs), a protective cover may be biased against and cover exterior rack sleeve opening 298rso (e.g., left and right protective flaps 298hsf, as shown in FIG. 2A) for preventing any debris from entering rack holding space 298rhs and potentially damaging rack 298r. However, when rack 298r is at least partially open, rack 298r may push the protective cover out away from exterior rack sleeve opening 298rso (e.g., in the −X direction and to the side(s) of opening 298rso (not shown)) such that rack 298r may be functionally presented external to rack holding space 298rhs.

While some racks may be removably attached to a vehicle by a user when needed and stored independently from the vehicle when not needed, rack repositioning actuator subsystem 296ar of vehicle rack repositioning management system 250b may enable the controlled extension and retraction (e.g., opening and closing) of its rack 298r without having to manually detach the rack from the vehicle. Therefore, vehicle rack repositioning management system 250b may include technologies relating to rack control mechanisms for controlling the opening and closing of racks, and, more particularly, to rack control assemblies for controlling the opening and closing of vehicle racks and other racks, such as cabinet racks, where extension and retraction from an area of user functionality without manual work on behalf of the user are desirable.

In some embodiments, a rack repositioning actuator subsystem of a rack repositioning management system may include a longitudinally extending and retracting rod that may also be configured to rotate or follow any suitable path with respect to a structural assembly of the vehicle as guided by a track and pin, such that a rack coupled to the rod (e.g., to a free end of the rod) may be pushed out from rack holding space 298rhs of rack sleeve 298rs via exterior rack sleeve opening 298rso (e.g., in a −X direction) and then manipulated or otherwise utilized so that the rack may be fully opened to a functional configuration external to the vehicle for supporting cargo of a user.

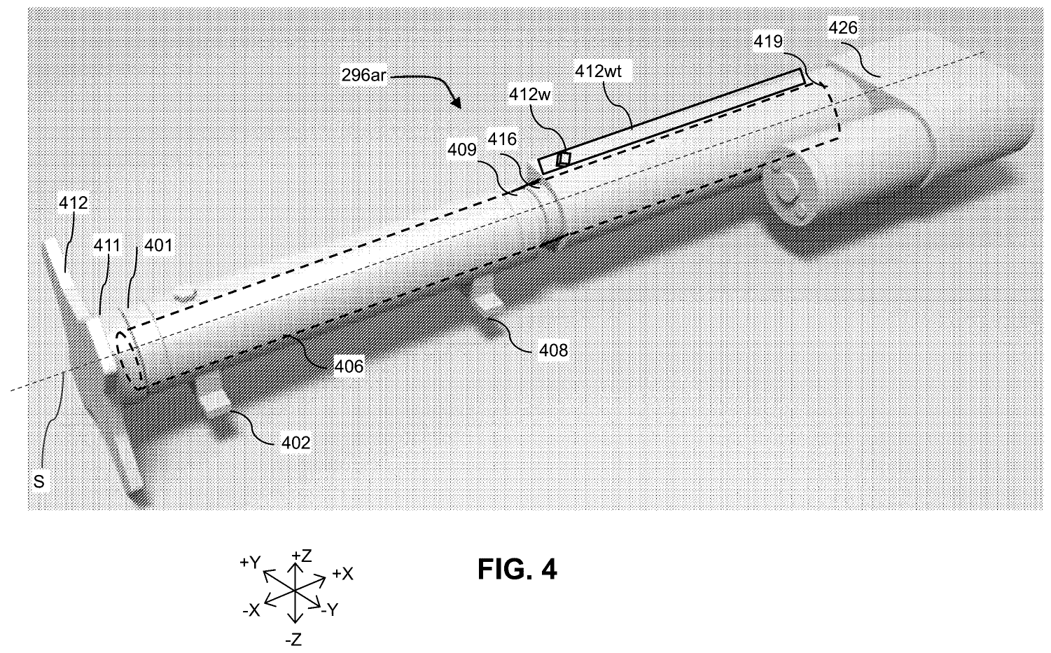

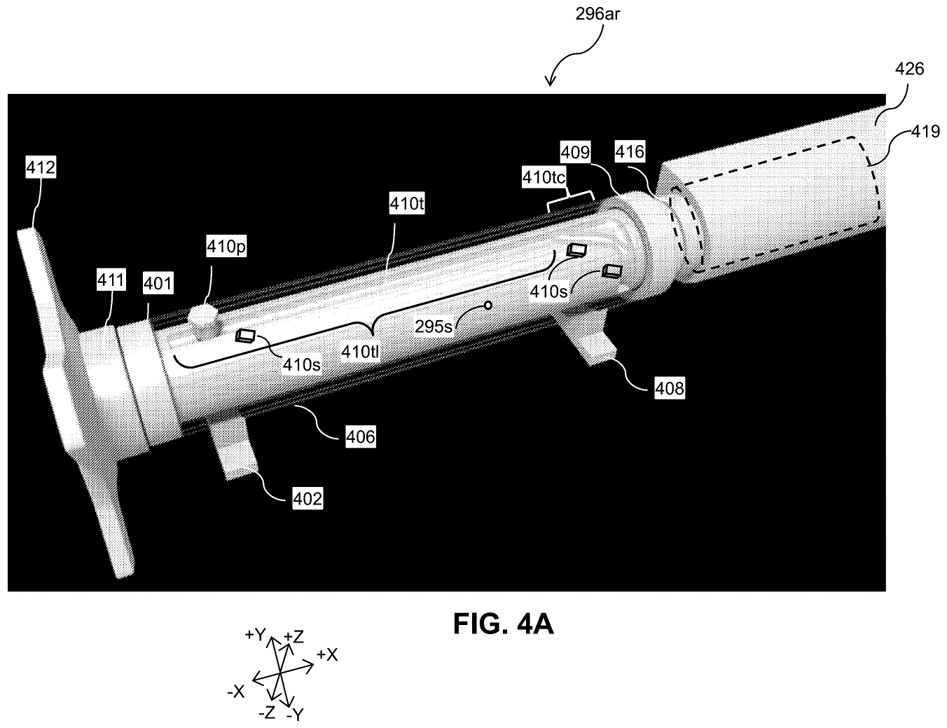

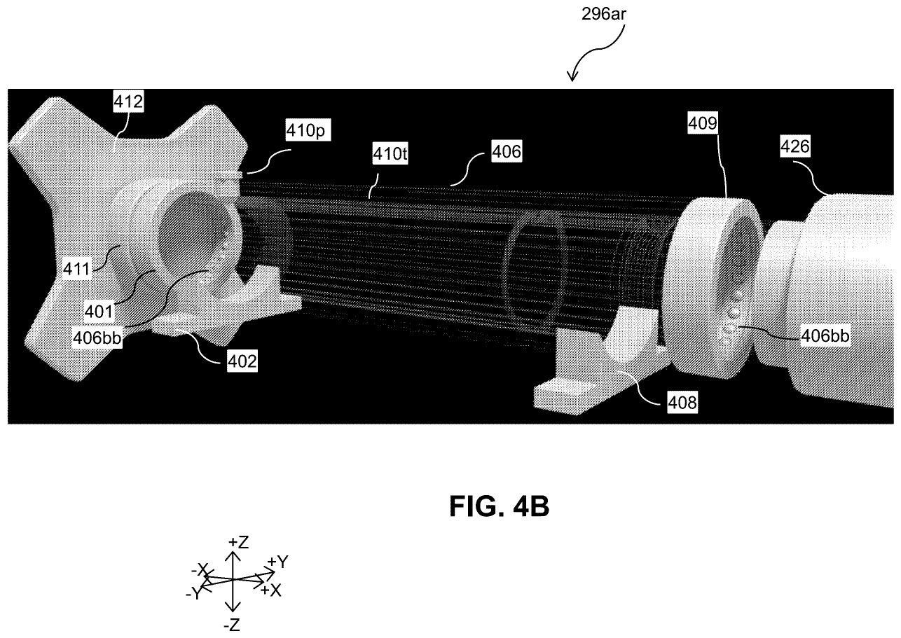

For example, as shown in FIGS. 2H, 2I, 4, 4A, and 4B, rack repositioning actuator subsystem 296ar may include one or more vehicle mounting plates (e.g., plates 402 and 408 (e.g., U-shaped mounting plates)) that may be coupled to any suitable portion(s) of the structural assembly of the vehicle (e.g., to an interior side surface of rack sleeve 298rs within rack holding space 298rhs, while rack sleeve 298rs may be coupled to any suitable portion of the vehicle, such as a floorboard or lower structural member 297lsm (e.g., underneath rear trunk or cargo space 297trs), or directly to any suitable portion of the vehicle, such as a floorboard or lower structural member 297lsm). Rack repositioning actuator subsystem 296ar may also include a hollow outer tube 406 that may extend between an exterior end 401 and an interior end 409 along axis S of actuator subsystem 296ar and define a hollow passageway 405 therealong. Hollow outer tube 406 may be coupled to and supported by vehicle mounting plates (e.g., plates 402 and 408) for fixing the position of hollow outer tube 406 with respect to the structural assembly of the vehicle. Rack repositioning actuator subsystem 296ar may also include an inner piston rod or actuator rod 416 that may extend between an exterior end 411 and an interior end 419 and may be positioned to pass through hollow passageway 405 of hollow outer tube 406 along axis S of actuator subsystem 296ar. Rack repositioning actuator subsystem 296ar may also include a rack mounting plate 412 provided by exterior end 411 of rod 416 that may be coupled to any suitable portion(s) of rack 298r (e.g., to an interior or front side 298rfis of rack 298r or otherwise). Rack repositioning actuator subsystem 296ar may also include any suitable actuator assembly 426 (e.g., any suitable hydraulic actuator, electric actuator, mechanical actuator, linear actuator, and/or the like) that may be configured to push and pull rod 416 along axis S (e.g., using any suitable power sourced by vehicle 290 and under the control of any suitable processor capability of vehicle 290). Rack repositioning actuator subsystem 296ar may also include any suitable pin 410p that may be configured to travel within and with respect to any suitable track 410t. In some embodiments, track 410t may be defined by and/or through an exterior surface of rod 416 between ends 411 and 419, while pin 410p may be coupled to and extend from tube 406 between ends 401 and 409 and into track 410t, such that when rod 416 is pushed or pulled along axis S, pin 410p of tube 406 may interact with moving track 410t of moving rod 416 to dictate any limits or direction or orientation of the movement of rod 416. For example, track 410t may include a linear portion 410tl that extends longitudinally along a portion of tube 406 parallel to axis S (e.g., along an X-axis) and then may stop or transition into a curved or any other suitable geometry portion 410tc (e.g., that may extend about at least a portion of tube 406 about axis S). In some embodiments, a length of linear portion 410tl (see, e.g., FIG. 4A) may be at least equal to distance D (see, e.g., FIG. 2I if not slightly greater, such that movement of pin 410p along linear portion 410tl of track 410t may define the amount that rack 398r may be pushed away from or pulled towards exterior rack sleeve opening 298rso of rack sleeve 298rs when rack assembly 298r is being opened or closed (e.g., extended or retracted). Additionally or alternatively, a circumferential amount by which curved portion 410tc may extend about axis S of tube 406 may be equal to an amount by which rack 298r may be rotated about axis S (e.g., for triggering any suitable mechanism(s) of rack 298r to expand or contract laterally and/or to expand or contract vertically for furthering the opening or closing of the rack assembly). Alternatively, in some embodiments, track 410t may be defined by and/or through tube 406 between ends 401 and 409, while pin 410p may be coupled to and extend from an exterior surface of rod 416 between ends 411 and 419 and into track 410t, such that when rod 416 is pushed or pulled along axis S, track 410t of tube 406 may interact with moving pin 410p of moving rod 416 to dictate any limits or direction or orientation of the movement of rod 416. Therefore, a design of rack repositioning actuator subsystem 296ar may be such that the piston can be installed under or above a floorboard of a vehicle but not within passenger cabin space 297pc so no rack mechanism may be exposed (e.g., visible to a user) until the rack is at least partially opened, and then only a portion of rod 416 and rack mounting plate 412 might be visible to a discerning end user). The rod may be a hydraulic, electric, mechanical, or other linear actuator that has a pin and pushes itself out through a track that may curve at a time the rack may rotate and is guided by the pin, or that has a track that curves at a time the rack may rotate and pushes itself out through an opening with a pin that guides the track. Any suitable counterweight 412w may be coupled to rack repositioning actuator subsystem 296ar or any other suitable portion of the vehicle, such as within a weight track 412wt that may extend along a length of subsystem 296ar and/or vehicle 290 in front of rack mounting plate 412 and rack 298r (e.g., along an X-axis), such that, as plate 412 and rack 298r may be extended out from rack sleeve 298rs and potentially used to support cargo (e.g., in the −X direction (e.g., at the rear of the vehicle)), counterweight 412w may be configured to travel along weight track 412wt (e.g., in the +X direction towards the front of the vehicle) to balance the overall weight and improve handling and control of the vehicle. This movement of counterweight 412w may be done automatically through the use of any suitable actuators and control subsystems of the vehicle (e.g., proportionally to any extension or retraction of rod 416 and/or to weight of any cargo that may be supported by rack 298r (e.g., using any suitable weight sensor(s) (e.g., sensor 295r positioned on rack 298r))). In some embodiments, repositioning actuator subsystem 296ar may include or have access to any suitable sensors to monitor any characteristics of the status of the vehicle (e.g., any suitable vehicle sensor subsystems 295) and such monitoring may be configured (e.g., through any suitable application(s)) to adjust the position or functionality of any suitable switches 410s that may be provided by repositioning actuator subsystem 296ar (e.g., along or adjacent track 410t) to selectively adjust a functional geometry of track 410t (e.g., to selectively adjust a length of linear portion 410tl of track 410t and/or to selectively adjust a circumferential amount by which curved portion 410tc may extend about axis S or otherwise be configured with respect to the geometry of rod 416). Therefore, repositioning actuator subsystem 296ar may be configured to monitor travel and control the start and stop of the actuator rod travel, such that the travel distance may be adjusted by moving the switches or adjusting settings (e.g., to adjust the distance the rack extends or rotates or is otherwise manipulated during opening or closing or otherwise).

In some embodiments, one or more sensors of vehicle 290 may be provided to detect additional tension on the rack such that a voice or alarm system can warn someone to remove their hand from the rack so it may move safely. For example, rack 298r may include any suitable sensor(s) at the bottom and/or sides of the rack (e.g., sensor 295r) and/or in rack sleeve 298rs (e.g., sensor 295r′) to detect any objects that may be positioned within the path of the rack when it is opening or closing (e.g., to ensure no fingers or other items are crushed by the rack closing), and this may also be monitored by sensing additional tension while closing the rack, which a safety algorithm can then utilize to cause the rack to stop its motion and reverse direction slightly.

In some embodiments, one or more sensors of vehicle 290 may be provided to detect a current on the rack (e.g., a change in current from a human touching a rack surface, which may be metallic or treated with conductive metallic material or coated in such a conductive paint or resin) (e.g., sensor 295r), whereby a voice or alarm system can warn someone to remove their hand from the rack so it may move safely.

Rack repositioning actuator subsystem 296ar may be configured to provide a rack opening and closing mechanism that enables the opening and closing of an automotive or other rack via a single, fluid motion by extending or retracting a rod that moves as guided by a track and pin, such that the rack pushes out past any exterior side walls of the vehicle (e.g., in the −X direction past any suitable side walls of rear portion 297lsmr of lower structural member 297lsm and/or exterior side wall(s) 297ewt of a trunk of vehicle 290 or otherwise) and then rotates or otherwise manipulates or is manipulated (e.g., manually by a user) so the rack may extend laterally and/or vertically for being functionally configured as a cargo rack.

The described technologies relate to rack (e.g., cargo (e.g., box, cooler, bicycle) rack) mechanisms for controlling the folding and expanding of racks, and more particularly, to rack control assemblies for controlling to folding and expanding of racks (e.g., bike racks, cargo racks (e.g., racks to hold cargo such as coolers, motorcycles, barbeque grills, trunks, containers, and the like), etc.) where hiding the rack when not in use and not requiring the user to remove the rack to hide for aesthetic, aerodynamic, access, and/or performance increases it are desirable.

Some rack folding and expanding mechanisms include hitch mounts or chassis mounts mounted to the frame or body or hitch of the vehicle, or mounted by straps and/or hooks and/or suction cups, or which is bolted to the vehicle roof, such that the rack is visible when attached to the vehicle, even when it is not needed for carrying cargo.

Other rack folding and expanding mechanisms may lift the rack upwards and forward by a hinge affixed to the front of the rack such that the rack lifts up and outwards. Such mechanisms may include multiple pivot points such that the rack tilts or pivots in and up. However, these hinges may leave the racks hanging over the rear entryway to the vehicle, potentially blocking access to the cargo area and also making the car effectively longer and presenting an obstacle when turning and one which other vehicles may hit.

Other rack folding mechanisms can pivot the rack outward on a hinge and then rotate the rack after it pivots out. However, while this may enable some clearance, it also may require the mechanism to be visible, require additional weight, and/or present the same challenges of making the vehicle longer and more prone to impact. This may limit design options and/or add weight to a vehicle.

It is advantageous and desirable to achieve a rack folding that may completely hide itself within or under the vehicle without the rack protruding into the street or otherwise endangering passengers or pedestrians. It can also be advantageous to control the angle and pivot of the rack and the depth of extension, and to be able to control the movement based on sensors. In addition to operational improvement, a more compact rack control mechanism that does not detract from the aesthetic appearance of the vehicle may be provided and may be useful and desirable. In addition to these improvements, utilization of a cavity of the underside of the vehicle may be provided and useful, especially as electric vehicles increase cargo room and enable more storage, and/or to protect the rack from rain and other elements when not in use.

In one aspect of the described technologies, a rack control assembly may be provided that may include an extending and retracting rod that may be guided by a track and pins, such that the rack pushes out through a hole in the rear of the vehicle, a rack opening, past any the rear wall of the vehicle and then expands so the rack is now open to the side of the rear rack opening.

The disclosed rack expanding and folding control mechanism can include a mounting plate or plates attached to the floor, roof, or wall of the opening, and a rod atop the plate(s). The rod can be a hydraulic, electric, mechanical or other linear actuator. The end of the piston or rod may include a mounting plate for mounting the rack to the piston. The design may be such that the piston can be installed under the floorboard of a vehicle so no piston or rod is exposed when the rack is opened, and then only the rack is exposed, and that when the rack is closed neither the rack nor the rod are visible. The rack or rod or track may have switches (e.g., switches 410s) and/or sensors (e.g., sensors 295s) to monitor travel and control the start and stop of the actuator rod travel, such that the travel distance may be adjusted by moving the switches or adjusting settings (e.g., to adjust the distance the rack extends or control when on the path it extends).

In certain implementations, sensors can be configured to detect additional tension on the piston or rack such that a voice system can warn someone to remove their hand from the rack so it may move safely. The rack may include a sensor at the bottom and/or sides or in the sleeve of the rack to ensure no fingers or other items are crushed by the rack closing or opening, and this may also be monitored by sensing additional tension while closing the rod, and a safety algorithm can then cause the rod to stop its motion and reverse direction slightly.

In another embodiment, sensors can detect a current on the rack (e.g., a change in current from a human touching the surface that may be metallic or treated with conductive metallic material or coated in such a conductive paint or resin), such that a voice system can warn someone to remove their hand from the rack so it may move safely.

In another embodiment, additional pistons or rods may expand from the outer sides of the rear of the vehicle to support the ends of the rack when they are expanded laterally or to support mounting wide accessories.

In another embodiment, the rod extension may be adjustable by the user such that they can push the rod out farther to fit a wider bicycle or other cargo, such as a cooler, on the rack, without the object hitting the rear of the vehicle, or simply to gain access to the rear cargo area of the vehicle.

Disclosed herein in certain implementations is a rack expanding and folding mechanism that may enable the expanding and folding of an automotive or other rack via a single, fluid motion by extending or retracting a rod that may push the rack out from under the vehicle or inside the vehicle, such that the rack pushes out past any side walls or rear walls (e.g., of a rack sleeve or otherwise of the vehicle) and then unfolds sideways so the rack may now be expanded to the left and right of the rack opening, with only the thickness of rack door plus an adjustable gap the added width of the vehicle or cabinet.

In certain implementations, the described rack folding and expanding mechanism may include a mounting plate or plates that can attach to the floor, roof, or wall of the rack opening, with a rod atop the plate(s). The rod may be a hydraulic, electric, mechanical or other linear actuator that may have a pin and pushes itself out through a track such that when the rod reaches a certain distance, the rack may expand outward (e.g., automatically (e.g., due to passing out through the exterior rack sleeve opening and/or any suitable spring release mechanism(s) or otherwise) or manually (e.g., through user manual manipulation of adjustable part(s) of the rack (e.g., folding out or up any suitable arm features or otherwise))). The end of the piston (or rod or actuator) may include a mounting plate for mounting the rack to the piston.

The described mechanism may be designed such that the piston can be installed under the floorboard of a vehicle so no rack mechanism is exposed when the rack is pushed out and unfolded, and then only the rack holding the bicycle is exposed. Of course, if the user chooses to push or pull the rack out farther from the vehicle, some of the piston rod (or actuator rod) may be exposed. The piston or rack may have switches and/or sensors to monitor movement and control the start and stop of the actuator rod travel, such that the movement distance can be adjusted by moving the switches or adjusting settings (e.g., to adjust the distance the rod extends or where along the travel the rack expands).

Such sensors can also detect additional tension on the rack, enabling an integrated notification system to warn someone to remove their hand from the rack so it may move safely. The rack control assembly can include a sensor at the bottom and/or sides and/or in the rack sleeve opening at the rear of the vehicle to ensure no fingers or other items are crushed by the rack closing. This may also be monitored by sensing additional tension while closing the rack which a safety algorithm may then be configured to cause the rack to stop its motion and reverse direction slightly.

The described technologies may provide considerable technical advantages and improvements over existing solutions. For example, the vehicle or cabinet or other suitable carrier can provide a bicycle rack without needing to attach one when needed because the rack is always there, hidden inside the carrier ready to push out and expand. Thus, a taxi service, for example, could have bicycle racks in all their vehicles, and the driver could press a button or audibly instruct a vehicle rack repositioning management system to expand the bike rack to pick up a tired cyclist, and then press a button or audibly instruct a vehicle rack repositioning management system to hide the rack inside the vehicle after the trip, without ever needing to attach or detach a bike rack. Although, it is to be understood that the rack may be configured to be removable from the end of a piston of a rack repositioning actuator subsystem for cleaning, maintenance, and/or replacement thereof by a user in some embodiments.

The ability to hide the rack entirely under the floorboard of the car, out of reach of dirt, debris, or fingers, thus protecting fingers from being caught in mechanisms, and protecting the rack from rain, snow, dirt, etcetera when not in use may be advantageous.

The described technologies allow fully powered, automatic opening and closing of the bike rack or cargo rack at a controlled and safe pace, providing additional comfort and convenience to passengers.

The described technologies protect hands and other body parts from being “jammed” when sliding heavy bike racks onto hitch mounts or bolting them to a vehicle, and, because there may be no need to remove the rack, it may eliminate the risk of dropping a heavy rack onto a foot or other body part during such removal.

The described technologies may move the rack completely inside the car under the cargo area when not in use, as opposed to other systems that may fold them against the door or leave them as-is and block cargo access and make the entire vehicle longer even when the rack is not carrying anything. The described technologies may return the vehicle to normal appearance and length without the user needing to lift, lower, add, or remove any rack or other object.

The described technologies allow rack to be recessed into the vehicle so the rack is not at risk of impact or inclement weather.

The described technologies may enable movement of the rack to be electronically controlled, whereby sensors can determine if a finger or other object is caught between the rack opening and the rack or any other nearby object, such as a wall or curb, to stop and reverse movement to prevent injury.

The described rack may expand out laterally (e.g., 90 degrees on each side, 180 degrees total), whereby any suitable cargo object 291cl with pins or any other suitable coupling mechanism(s) 291cm may be configured to line up and/or otherwise mate or functionally interact with any suitable holes or teeth or coupling mechanism(s) 298cm on rack 298 for securely mounting the cargo to the rack (e.g., such that a cooler or trunk or storage container or BBQ grill or any object with compatible mounting pins can lock onto the rack). This gives the additional advantage of allowing the vehicle to carry additional cargo outside the vehicle using the same rack.

The described technologies may prevent a folded and retracted rack from swinging out into traffic, which is a frequent cause of injury to cyclists and others who can come into contact with an exposed rack, often because it is lower than they are looking or the driver does not remember the rack is still on the vehicle and swings the car and thus the rack into someone or something.

It can therefore be appreciated that the described technologies provide numerous advantages and improvements over existing solutions.

Rack repositioning actuator subsystem 296ar of rack repositioning management system 250b may be configured to provide considerable technical advantages and improvements over other solutions. For example, rack repositioning actuator subsystem 296ar may be configured to provide the ability to hide the mechanisms entirely under the vehicle (e.g., out of reach of dirt, debris, or fingers, thus protecting fingers from being caught in mechanisms until and if needed for providing a functional cargo rack). The described technologies may allow fully powered, automatic opening and closing of a rack at a controlled and safe pace, providing additional comfort and convenience to passengers. The described technologies may protect hands and other body parts from being “jammed” by the rack. As the described technologies may enable movement of a rack to be electronically controlled, sensors can determine if a finger or other object is caught between the elements of the rack and/or between the rack and other portions of the vehicle, to stop and reverse movement to prevent injury. It can therefore be appreciated that the described technologies provide numerous advantages and improvements over existing solutions.

FIGS. 2A and 2H-2M may depict an example implementation of rack repositioning actuator subsystem 296ar installed into a vehicle 290. As shown, the rack repositioning actuator subsystem may enable the rack to extend and expand open, allowing unobstructed access to the rack and enable the rack to retract into a rack holding space defined by a rack sleeve that may be coupled to the vehicle in a location that is out of the way of a passenger and their normal interaction with the vehicle when the rack is not in use. As shown and described herein, implementing rack control mechanism 296ar may enables the rack to push out from inside the vehicle through a rack opening similar in appearance to a vehicle exhaust opening, and then expand out. It may expand out automatically as pins hit stops on a track (e.g., releases any suitable spring mechanism(s) of the rack or otherwise), or by the user manually folding and unfolding arms or any other suitable feature(s) of the rack. The described rack control mechanism can be mounted or affixed to the bottom (or side or top) of a vehicle or cabinet. As shown, additional hold-down arms may ratchet up and down to hold bicycle tires down and from falling sideways, thus locking the bike in place.

FIG. 2M is a depiction of the described door control mechanism in accordance with certain implementations and showing it holding a bicycle.

FIG. 2I depicts the rack mechanism folded so that it can slide in or out of the rack opening.

FIG. 2J depicts the rack mechanism expanded but without the hold-down arms expanded. In this form, the rack can be used to support cargo other than bicycles such as a cooler or trunk or BBQ grill.

FIG. 2K depicts the rack with its arms folded down holding a container such as a cooler or trunk where locking pins fit into holes in the rack arms such that the container stays attached to the rack.

As described and depicted herein, the rack control mechanism can include components to push a piston out, and components to guide the rack to expand or fold at designated time(s), and components for the piston to connect to the inside of the vehicle and the rack. In this way, the piston may be pushed out such that the arms of the rack may clear the opening and outer sides of the vehicle or cabinet and then rotate such that the rack may be rotated to expand fully to hold a bicycle or other cargo.

FIG. 2H depicts an example implementation of a rack control mechanism that can be concealed under the floor of the vehicle (or positioned even lower so the floor is flat).

As also shown in FIG. 1, the rack expands once the rod is pushed out to hold the bike.

As shown in FIG. 2L, the rack can accommodate 2 bicycles. The rack may be offered with 1 or more bicycle holding arm sets, and in FIG. 2M, 2 sets of arms to hold 2 bikes may be depicted. It may be possible to have additional arms, such as to hold 3 or 4 bicycles by repeating the pattern of mounting as shown.

FIG. 4 is a close-up depiction of rack repositioning actuator subsystem 296ar in accordance with certain implementations.

FIG. 4A depicts internal components of rack repositioning actuator subsystem 296ar (e.g., including an interior rod and a cutaway showing the pin that may guide a track, as described herein).

FIG. 4B depicts the referenced pin and the tracks rendered in outlines, as well as ball bearings 406bb (e.g., within end 401 and/or end 409 of tube 406), which may allow rod 416 to rotate smoothly therein.

As described and depicted herein, the door control mechanism can include components to push a piston out, and components to guide the piston to move at designated time(s) in designated ways, and components for the piston to connect to the rack. In this way, the piston may be pushed out such that the rack may clear the opening and sides of the vehicle and then expand such that the rack may be functionally used to support cargo.

In certain implementations, the rack can be pushed in or pulled out and manipulated with manual power (e.g., by a user). Alternatively or additionally, a piston can be powered by an electric motor (e.g., comparable to a linear actuator), hydraulics, electromagnets, or other such components (e.g., actuator 426).

Any suitable power source can be integrated with feedback mechanisms, including stop switches. Such components can be configured to stop pushing (e.g., opening) and/or pulling (e.g., closing) the rack once the rack has reached a desired position. Any suitable sensors, such as pressure sensors and motion sensors, can also be integrated. Such components can be configured to adjust or stop the motion of the rack upon determining whether the rack is likely to come into contact with a human or obstacle (e.g., to prevent it from closing on a hand or smashing into a curb).

A piston or mechanism can incorporate a position sensor or sensors that may provide feedback for other components. For example, lighting of the vehicle (e.g., lighting output components or lighting actuator subsystems 296) can be configured to change based on a determined position of the rack (e.g., to light the ground around the vehicle as the rack opens and/or to turn the lights off as it closes). In another example, the vehicle may be configured to change the color and/or intensity of the lighting inside and/or outside as a rack opens and/or closes (e.g., to provide stylized and dramatic effects, where such effects can be customized (e.g., via the vehicle's app or infotainment system on any suitable subsystem 220)).

In another example, the car can adjust the vehicle's airflow control system. For example if the rack is open and has weight on it, the car can direct a spoiler (e.g., adjacent fans 296af) to move air over the cargo so wind is not pushing against the cargo. As another example, if the sensors detect excessive strain from wind, the vehicle may raise windows or roof (e.g., if the vehicle is a convertible), so that the wind gets lifted up and passes over the cargo.

In another example, the vehicle rack repositioning management system 250b can be configured to close and/or lock certain vehicle features when the rack is being opened (e.g., locking a trunk so it may not be improperly or dangerously accessed when a rack is being opened).

The referenced piston can include or incorporate a track, and a ring mounted to the mechanism or vehicle with a stationary pin (or ball bearing or wheel) can guide the track such that the piston may rotate or otherwise move according to geometry of the track.

Alternatively, the piston can have the pin (or ball bearing or wheel) be pushed through an outer cylinder that has a track that guides the pin (or ball bearing or wheel) causing the piston to move. The cylinder can be cylindrical on the outside or it could be cylindrical on the inside but be molded or milled out of a rectangular or other outer shape.

In certain implementations, the referenced cylinder or ring can be constructed as separate components that may be attached to the vehicle or pushing mechanism. Alternatively, the referenced cylinder or ring can be part of the pushing mechanism housing or be part of the vehicle. For example, a carbon fiber vehicle monocoque can have the cylinder or ring molded into the bottom or side of it.

The referenced rod can include or incorporate a track and a pin mounted to the mechanism or vehicle (or cabinet) that can guide the track such that the rack opens when the pins in the rack mechanism touch stop points on the track forcing the rack arms to pivot or a level attached to the rack arms to pivot.

In certain implementations, the referenced rack sleeve and rack opening can be constructed as separate components which are attached to the vehicle or pushing mechanism. Alternatively, the referenced rack sleeve or rack opening can be part of the pushing mechanism housing or be part of the vehicle. For example, a carbon fiber vehicle monocoque can have the sleeve and track of the mechanism molded into it. As another example, the sleeve may be a separate component which is bolted to the bottom of an existing vehicle.

In certain implementations, the described piston, cylinder, ring, pushing mechanism housing, door mounting components, floor/side mounting components, ball bearing, ring, wheel and/or any other components of rack repositioning actuator subsystem 296ar can be made from aluminum or other metals or composite materials such as carbon fiber. They can also be made from a combination of materials. For example, the described sleeve can be made from carbon fiber but with a titanium pin or ball bearing guiding the track and/or with bolts made of titanium or another metal. It should be understood that the type of metal and materials do not change the functionality of the mechanism but can allow the user to control for weight of the vehicle (e.g., by using titanium components instead of steel to reduce weight).

The rack mechanism can also include a counterweight. Such a counterweight can remain in place or push toward the opposite end of the vehicle as the piston expands. Doing so can balance the weight of the vehicle, such that, as weight is added to the rear of the vehicle by adding items to the rack, a weight may be pushed toward the front of the vehicle to balance the weight to improve handling and control of the vehicle.

The sensors referenced above (e.g., for motion and pressure and/or otherwise) can be mounted on the sides or bottom of the sleeve and/or the rack and/or along the piston or otherwise. In certain implementations, a sensor can be configured to gauge power output and resistance as the rack opens or closes. Doing so can enable an integrated processor or computing system to determine if the rack has encountered an obstacle.

In certain implementations, the rack mechanism can be controlled in various ways, such as by buttons on the outside and/or inside of the vehicle, key fob, buttons in an app or infotainment system, and/or the like. The described door mechanism can also be activated remotely (e.g., over the internet or wireless control). The rack mechanism can also be activated via various communication protocols (e.g., RFID, NFC, etc.), fob, card, ring, bracelet, or other object, such that placing the fob (for example) next to a sensor on the outside of the vehicle may cause the rack to open and/or close.

The described rack mechanism can integrate or operate in conjunction with cameras or other visual sensors on the outside and/or inside of the vehicle, such that recognition of the driver and/or passenger(s) and/or an object such as a bicycle or a driver carrying a bicycle can initiate opening the rack. It might also close the bike rack it if it recognizes the driver has fully removed the bicycle(s) from the rack and biked away, so that others cannot stand and jump on the rack. The same cameras may be used to detect if a human or animal is standing on the rack to stop the vehicle because it is often unsafe for someone to ride a vehicle like it is a skateboard by standing on a rack.

The described sensor and camera integrations can be used for a cabinet or workstation or any other suitable carrier, such that when an owner of the cabinet or workstation or carrier approaches, a rack may extend from the carrier automatically. This can be advantageous by enabling opening of the rack while the user's hands can remain free to hold items without needing to handle the rack. For example, a rack below a cabinet with emergency supplies or food or cleaning equipment can be configured to open automatically upon determining the owner is approaching the cabinet. The described sensor and camera integrations can be used for a cabinet, such that when an owner of the cabinet approaches, the rack opens automatically. This can be advantageous by enabling opening of the rack while the user's hands can remain free to hold items without needing to handle the rack. For example, a cabinet that holds a laptop or other heavy object can be configured to open a rack for holding the laptop or other heavy object automatically upon determining the owner is approaching the cabinet. For example, the same rack mounted to a kitchen cabinet might automatically push out and expand arms for someone to hang grocery bags and the two arms enable the bags to be held open as they empty the bags into a nearby refrigerator or other cabinets.

The described rack mechanisms can use their sensors and power control to sync not only the rack with any or all other racks and/or doors and openings on the car (or cabinet) to which they may be relatively positioned, but to open and close in sync with racks and/or doors on other vehicles (or cabinets).

While described with respect to extending rearwardly from rear portion 297lsmr of lower structural member 297lsm, rack 298r and rack repositioning actuator subsystem 296ar of vehicle rack repositioning management system 250b may be positioned in any other suitable manner with respect to vehicle 290 for selectively presenting a rack to a user at any suitable location about the vehicle (e.g., rack 298r may be extended forwardly out from a front portion of lower structural member 297lsm for providing a front rack (e.g., for cargo that is not tall enough to block the view of a driver), or a left side or a right side, etc.).

A rack control mechanism may be provided for connecting a bicycle rack for a vehicle to the body of the vehicle, wherein the mechanism has a closed state in which the rack is closed and hidden inside the vehicle (inside a sleeve) and an open state in which the rack is pushed out from the vehicle and expanded, the rack control mechanism including (a) a mount to connect the rack to a piston, wherein the mount may tilt to flip the rack up or down, and wherein the rack may include one or more sets of arms, (b) arms which may be curved or bent so that bicycle wheels fit into them, and which may have slots and/or holes and/or teeth such that ratchet down arms and other accessories can attach and be moved along the arms, (c) a mount to connect the piston to the sleeve, (d) a track to guide the piston such that it pushes in/out and stops at designated points, wherein the track may be embedded into the sleeve or attached to the piston, or may be in an outer cylinder, (e) pins on the arms or on levers attached to the arms, which hit stops along the track, such that, as the piston or rod reaches a certain point, the pins hit stops and this causes the arms to pivot out or in, so as to open or close, (f) a mechanism for pushing (“pushing mechanism”) out the piston, which may be an electronic linear actuator, hydraulic actuator, or magnetic propulsion, these may push the piston, or which may be attached to an additional piston which pushes the above mentioned piston via a rotating joint. In some embodiments, the rack control mechanism may further include sensors (such as push switches) which tell the control mechanism the position of the rack (such as when it is fully opened, fully closed, about to close, and the like. In some embodiments, the rack control mechanism may further include sensors which tell the control mechanism the rotation of the rack arms. In some embodiments, the rack control mechanism may further include a sensor(s) to detect if any object(s) block the path of the rack, for example to prevent the rack from opening into a wall or curve. In some embodiments, the rack control mechanism may further include sensors which detect objects between the rack edges and the vehicle (or cabinet) so as to prevent crushing these objects. In some embodiments, the rack control mechanism may further include a sensor to detect a change in electric current on the rack via metallic material in the paint such as to detect human touch on the rack. In some embodiments, the rack control mechanism may further include a circuit for controlling the speed and direction of the mechanism, for gathering and processing sensor data, and/or for interacting with other devices (such as the car's infotainment system, main computer, navigation system, etc.). In some embodiments, the rack control mechanism may further include camera(s) to detect if any object is or will block the path of the rack, where the same camera(s) can be used to detect a person approaching the rack(s) and to open the appropriate door(s). For example, the cameras and integrated image recognition may detect the owner of the car and open the driver's rack. These cameras may be placed on the sides of the vehicle, the roof, the inside, the mirror, the edges of the door, and may be placed in different locations so as to capture the full area around the vehicle without obstruction. In some embodiments, the rack control mechanism may further include a sensor to detect pressure, so as to determine if the rack has hit an object and stop and reverse movement to avoid damage. In some embodiments, the rack control mechanism may further include a pressure or sound sensor to detect a tap or pattern of tapping on the rack so as to open or close the rack without needing a button or handle. In some embodiments, the rack control mechanism may further include a mechanism to push out and extend additional support arms toward the outer sides of the vehicle after the rack opens to offer additional support. This mechanism may be activated by the car's computer or by the press of a button or via an app (on the user's phone or the car's system) or by switches that may be hit as pin(s) on the main piston go past them. The rack control mechanism may further include cameras to detect that the owner is carrying bags and open the rack, and/or the cameras may detect the owner is walking toward the vehicle with a bike and open the rack (and optionally do other things such as roll out weather mats on the floor, seats, etc., turn on warning blinkers, etc.). The control mechanism may communicate with other door control mechanisms so all doors (and even hoods, trunks, roof, etc.) on the vehicle can open/close at the same pace. In some embodiments, the rack control mechanism may further include a camera to detect that the bicycle or cargo is fully removed and the rack automatically closes (meaning it folds and retracts into the vehicle or cabinet). In some embodiments, the rack control mechanism may further include a voice recognition system that allows the user(s) to close one or more racks, such as by saying, “close the rear bike rack”, or “open the front bike rack”, or “close all bike racks”, or the like. In some embodiments, the car (or cabinets) lighting may be configured to change based on the position of the rack, for example to light the ground around the vehicle as the rack opens and to turn the lights off as it closes. As another example, the car might change the color and/or intensity of the lighting inside and outside as the rack opens and closes, to provide stylized and dramatic effects. The user can adjust and program these effects to their liking via the vehicle's app or infotainment system. In some embodiments, the rack control mechanism may further include cameras that may detect that the owner is approaching with a bicycle and slide out a bike rack. The car (or cabinet/room) can adjust the airflow control system, such as spoilers, flaps, windows, roof, fans, or any combination of them as the racks open. For example, if there is a lot of air flowing against cargo on the rack, the car can increase the speed of a fan which pushes the airflow up and over the cargo. In another example, if the car uses jets or fans to push the car faster or create downforce, these fans or jets can be terminated automatically when the rack is opened to prevent excessive side winds against the bike or cargo. The rack may automatically lock or unlock components, such as a storage door (for example a “bike tools box” in the trunk) so that items are accessible or locked into place. For example, when the bike rack is expanded, the vehicle may be programmed such that a box may automatically unlock inside the trunk of the vehicle that may contain additional straps, pads, and the like for holding the bike or other objects securely. The mechanism may be configured to automatically lower the windows as the rack opens (to prevent bicycles from hitting glass in a rear window of an SUV, for example) and automatically lift the windows once the rack is fully retracted or the new load on the rack stays constant for a period of time indicating the load is secure and no longer at risk of falling into a glass window. In some embodiments, the connection (joint) between the piston and the rack may have a slanted connection such that when the piston is pushed out fully, the joint is tilted, lifting the bottom of the rack off the ground so as to lift the bottom of the rack further off the ground. In some embodiments, the connection to the rack may include an additional piston inside the sleeve, such that, as the rack pushes out rotates, the piston lifts the rack so that when it pushes out it also lifts up.

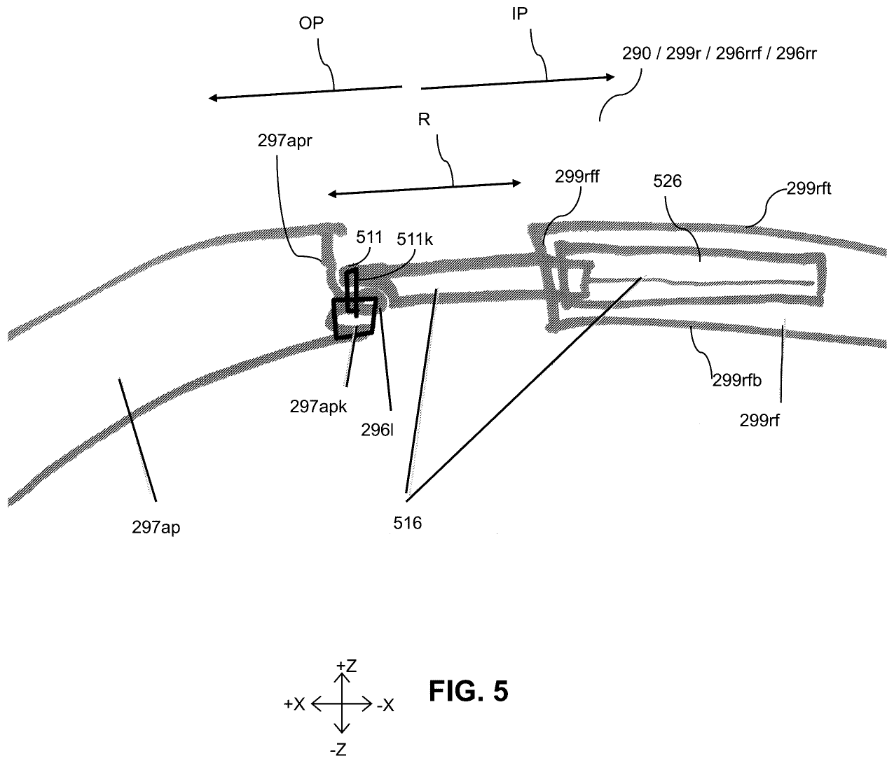

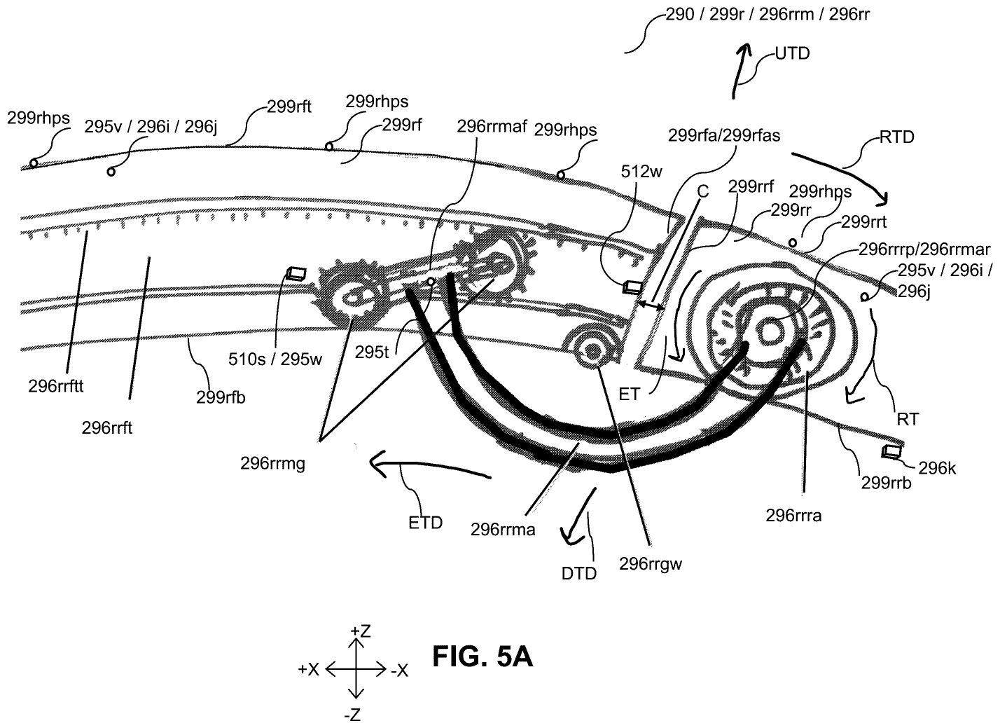

A particular object repositioning management system may be a vehicle roof repositioning management system 250c that may be configured to manage the movement of roof 299r between various positions with respect to structural assembly 297 of vehicle 290 (e.g., with respect to A-pillar 297ap, B-pillar 297bp, C-pillar 297cp, upper structural member 297usm, lower structural member 297lsm, and/or the like). Whether structural assembly 297 of vehicle 290 is provided with full B-pillar(s) 297bp and a full C-pillar 297cp and continuous left and right roof support structures 297lrs and 297rrs (see, e.g., FIGS. 2B-2H) or with only a half-height C-pillar 297cp and only half-height B-pillar(s) 297bp or no B-pillars and no continuous left and right roof support structure (see, e.g., FIGS. 2, 2A, and 2N-2X), roof assembly 299r, which may include at least a first or front roof panel 299rf and a second or rear roof panel 299rr, may be moved between various suitable positions, including, but not limited to, (i) a fully closed position (e.g., as shown by FIGS. 2A-2N) whereby door 299r may be securely held (e.g., latched) in a position against and/or by portion(s) of A-pillar 297ap, portion(s) of any B-pillar(s) 297bp, portion(s) of any upper structural member(s) 297usm, portion(s) of C-pillar 297cp, trunk 294tr, and/or the like of structural assembly 297 for protecting the top of passenger cabin space 297pc and any passenger(s) therein from any suitable external environmental factors, such as rain, snow, sun rays, noise, smells, and/or the like (e.g., a front side 299rff of front roof panel 299rf may be coupled to or otherwise held physically in contact with a rear side 297apr of A-pillar 297ap (e.g., along the top/rear surface of windshield 294wfw) for preventing fluid travel therebetween, a rear side 299rfr of front roof panel 299rf may be coupled to or otherwise held physically in contact with a front side 299rrf of rear roof panel 299rr for preventing fluid to travel therebetween, and a rear side 299rrr of rear roof panel 29rr may be coupled to or otherwise held physically in contact with a top side 297cpt of C-pillar 297cp for preventing fluid to travel therebetween), (ii) a first partially open position (e.g., as shown by FIGS. 2O, 2U, and FIG. 5) whereby at least a portion of the front of roof 299r may be decoupled or otherwise physically removed from contact with A-pillar 297ap (e.g., front side 299rff of front roof panel 299rf may be moved away from rear side 297apr of A-pillar 297ap towards the rear of the vehicle (e.g., in the −X direction or along a curved or angled path substantially in that direction (e.g., by any suitable dimension R))) for creating any suitable fluid channel therebetween (e.g., for providing a slightly open sunroof feature or the like with a length R) and whereby at least a portion of the rear of front roof panel 299rf may be decoupled from or otherwise physically removed from contacting the front of rear roof panel 299rr (e.g., rear side 299rfr of front roof panel 299rf may be moved up away from front side 299rrf of rear roof panel 299rr (e.g., in the +Z direction or along a curved or angled path substantially in that direction (e.g., by any suitable dimension F between a bottom side 299rfb of front roof panel 299rf and a top side 299rrt of rear roof panel 299rr))) for creating any suitable fluid channel therebetween (e.g., for providing an open vent feature or the like with a height F), (iii) a second partially open position (e.g., as shown by FIG. 2P and partially by FIG. 2V) whereby the front of roof 299r may be completely decoupled or otherwise physically removed from contact with A-pillar 297ap (e.g., front side 299rff of front roof panel 299rf may be decoupled from and further moved away from rear side 297apr of A-pillar 297ap towards the rear of the vehicle (e.g., in the −X direction or along a curved or angled path substantially in that direction (e.g., by any suitable dimension R′))) for creating any suitable fluid channel therebetween (e.g., for providing a wide open sunroof feature or the like with a length R′) and whereby the bottom of at least a portion of front roof panel 299rf may be physically moved back over the top of at least a portion of rear roof panel 299rr (e.g., bottom side 299rfb of front roof panel 299rf may be moved rearwardly along top side 299rrt of rear roof panel 299rr (e.g., in the −X direction or along a curved or angled path substantially in that direction (e.g., by any suitable dimension W′ (e.g., that may be similar or the same as dimension R′)))), (iv) a third partially open position (e.g., as shown by FIG. 2Q and partially by FIG. 2V) whereby rear trunk door 294dtr may be opened (e.g., through rotation of door 294dtr about a rear hinge 294dtrh (e.g., along a Y axis) in the direction of arrow RO) for exposing a rearward entry path to rear trunk space 297trs (it is to be noted that, when a user may desire to access rear trunk space 297trs for storing cargo, rear trunk door 294dtr may be alternatively opened (e.g., through rotation of door 294dtr about a front hinge 294dtrh′ (e.g., along another Y axis) for exposing a frontward entry path to rear trunk space 297trs)), (v) a fourth partially open position (e.g., as shown by FIG. 2R) whereby door 299r may be at least partially physically moved rearward and/or downward partially into rear trunk space 297trs (e.g., rear side 299rra of rear roof panel 299rr may be moved with respect to top side 297cpt of C-pillar 297cp in the −X direction and/or −Z direction), (vi) a fifth partially open position (e.g., as shown by FIGS. 2S and 2W) whereby door 299r may be physically moved rearward and/or downward fully into rear trunk space 297trs (e.g., rear side 299rra of rear roof panel 299rr may be moved with respect to top side 297cpt of C-pillar 297cp further in the −X direction and/or −Z direction), and (vii) a fully closed position (e.g., as shown by FIGS. 2T and 2X) whereby rear trunk door 294dtr may be closed (e.g., through rotation of door 294dtr about rear hinge 294dtrh (e.g., along a Y axis) in the direction of arrow RC) for blocking the rearward entry path to rear trunk space 297trs and protecting retracted roof 299r within rear trunk space 29trs. Such movement of roof assembly 299r may be enabled by any suitable roof repositioning actuator subsystem 296rr of vehicle roof repositioning management system 250c, which may include a front roof repositioning actuator subsystem 296rrf that may be configured to control the relationship between front roof panel 299rf and A-pillar 297ap (see, e.g., FIG. 5), a middle roof repositioning actuator subsystem 296rrm that may be configured to control the relationship between front roof panel 299rf and rear roof panel 299rr (see, e.g., FIG. 5A), and a rear roof repositioning actuator subsystem 296rrr that may be configured to control the relationship between rear roof panel 299rr and C-pillar 297cp (see, e.g., FIGS. 2R and 2S).

Therefore, the described technologies of vehicle roof repositioning management system 250c may relate to convertible roof mechanisms for controlling the opening and closing of vehicle roofs, and more particularly, to convertible roof control assemblies for controlling the opening and closing of vehicle roofs (e.g., hardtop vehicle roofs) where storing the roof in a compact form requiring minimal height in the rear cargo area for aesthetic, aerodynamic, access, and/or performance improvements are desirable.

The described technologies of vehicle roof repositioning management system 250c may be implemented as roof control mechanisms and hinge systems for controlling the opening and closing of vehicle roofs and, more particularly, to convertible roof control assemblies for controlling the opening and closing of hardtop convertible roofs that can support weight and be made of solid, strong, wind- and sound-blocking materials and still slide into a rear cargo area (e.g., boot or trunk) of the vehicle while leaving the cargo area with maximum cargo space available for other cargo. While some vehicle roofs may not open at all, and while some convertible vehicle roofs may utilize fabric in order to fold compactly and/or may utilize many complicated parts to fold and/or open in ways that may require significant height clearance and/or open in ways that may consume excessive cargo space, vehicle roof repositioning management system 250c may be configured to overcome such limitations.

Some convertible roof opening and closing mechanisms may be configured such that the roof folds with a hinge or series of hinges, whereby a curved roof may become a biconvex shape including two circular arcs, thus becoming even taller in the center when folded over each other (e.g., similar to an ellipse), and thus consuming more cargo space when slid or flipped again into the trunk, even though much of the space used may be empty space between the two convex curves (e.g., the middle of an ellipse). Other convertible roof opening and closing mechanisms may be configured such that many hinges and bars may be used to fold fabric or hardtop roofs into complicated shapes, which may prevent the vehicle from enjoying large glass panels in the roof (e.g., to give riders pleasant views even in cold weather), and/or which may add incredible amounts of complexity and weight to roofs that may be operated in windy and rainy weather and that may be prone to humidity, where metal mechanisms may be prone to breaking, from strain, water, win, and other weather damage, and/or which may add significant weight to the vehicles which may in turn require extra fuel or electricity and thus may be bad for the environment. Other convertible roof mechanisms may be configured to move part of the roof flat back onto the rear of the vehicle or into a pocket but may require the vehicle to retain a full rear window and window frame (e.g., the Porsche Targa may include a rear frame that remains even when the roof is removed, which may eliminate much of the fun of a convertible, where people wish to have a fully open rooftop and feel the air and see unobstructed views. Other convertible roof mechanisms may be simply manual panels that are removed from a Targa-like configuration, where the roof panel must be then manually stored outside of the car, or under the hood or trunk, carefully, which can present a great risk for human error, such as dropping an expensive roof or improperly storing it such that it breaks.

However, vehicle roof repositioning management system 250c may be configured to achieve a convertible roof mechanism that may slide a front portion of the roof (e.g., front roof panel 299rf) onto a second portion of the roof (e.g., rear roof panel 299rr), such that, when the two portions each have a convex shape, the convex shape of the front portion of the roof may overlap the convex shape of the rear portion of the roof such that they are both concave in a stacked manner (e.g., a portion of the rear portion of the roof is positioned within the concavity of the front portion of the roof (e.g., the downward facing concavity of each roof panel)) rather than becoming biconvex (e.g., where the concavity of the front portion would be facing the concavity of the rear portion), and thus retains a C-shape instead of becoming an ellipse. That means the C-shape of the overlapping roof panels fit over a cargo area inside the trunk, such that the curve inside the C-shape may remain as cargo area for the trunk. It should be noted that the described technologies can have more than two roof panels. For example, if implemented with three panels, a front panel may be configured to slide over a middle panel, which may be configured to slide over a rear panel.

Vehicle roof repositioning management system 250c may be configured to eliminate or reduce the number of hinges and/or other parts that may be commonly used by other convertible roof mechanisms, as vehicle roof repositioning management system 250c may include middle roof repositioning actuator subsystem 296rrm that may be configured to slide front roof panel 299rf over rear roof panel 299rr using any suitable track mechanism(s) 296rrmg (e.g., gear(s) (e.g., motorized gear(s)) and/or wheel(s) (e.g., grippy wheel(s))) that may be positioned within a track 296rrft that may be provided along any suitable portion of front roof panel 299rf (e.g., along a right side (e.g., a −Y side) (e.g., along right support structure 299rfrs) of front roof panel 299rf and/or along a left side (e.g., a +Y side) (e.g., along left support structure 299rfls) of front roof panel 299rf or otherwise), which may be covered such that no mechanism may be exposed to rain or snow, and/or such that the top of the roof may be seamless with no hinges or tracks protruding therefrom. Vehicle roof repositioning management system 250c may be configured such that, as the bottom of the front roof panel slides over the top of the rear roof panel (e.g., using middle roof repositioning actuator subsystem 296rrm) and then both together slide into the trunk space (e.g., using rear roof repositioning actuator subsystem 296rrr (e.g., both halves may slide down a track, or may be flipped by control arms or levels, into the trunk of the car), the roof may not need to be lifted up substantially high during roof opening and, thus, may only need a few inches of clearance above a height of the vehicle with a fully closed roof (e.g., roof 299r may only extend up by a dimension H+ above its normal height H to an extended height H′ (e.g., dimension H+ may be dimension F between bottom 299rfb of front roof panel 299rf and top 299rrt of bottom roof panel 299rr (e.g., a dimension of one or more wheels 296rrgw that may extend downwardly from front roof panel 299rf) combined with dimension FT between bottom 299rfb of front roof panel 299rf and a top side 299rft of front roof panel 299rf), thereby making it possible to use vehicle roof repositioning management system 250c to open and close a roof in garages with low ceilings. Beyond such operational improvements, vehicle roof repositioning management system 250c may be configured to provide a more compact convertible roof control mechanism that does not detract from the aesthetic appearance of the vehicle, to enable utilization of a cavity of the underside of the roof for further trunk space, to protect the convertible roof mechanisms from rain and other elements when opening and closing, to support weight for things such as roof racks, suction-cup bike racks, rooftop cargo carriers, and the like on the closed roof, and/or to provide large glass panels in a convertible roof to allow panoramic sky views even when the roof is closed. Front roof panel 299rf may include a main panel 299rfmp that may extend between a top surface 299rft and a bottom surface 299rfb and that may be supported on its periphery by any suitable front support structure 299rffs along front side 299rff of front panel 299rf, any suitable left support structure 299rfls along left side 299rfl of front panel 299rf, any suitable front support structure 299rffs along front side 299rff of front panel 299rf, and any suitable rear support structure 299rfas along rear side 299rfa of front panel 299rf, while rear roof panel 299rr may include a main panel 299rrmp that may extend between a top surface 299rrt and a bottom surface 299rrb and that may be supported on its periphery by any suitable front support structure 299rrfs along front side 299rrf of rear panel 299rr, any suitable left support structure 299rrls along left side 299rrl of rear panel 299rr, any suitable front support structure 299rrfs along front side 299rrf of rear panel 299rr, and any suitable rear support structure 299rras along rear side 299rra of rear panel 299rr.

As shown in FIG. 5A, for example, middle roof repositioning actuator subsystem 296rrm may be configured to control the relationship between front roof panel 299rf and rear roof panel 299rr and may include an arm 296rrma (e.g., a curved arm or an arm of any other suitable geometry) that may extend between (i) a rear end 296rrmar on or otherwise coupled to a pivot 296rrrp that may be coupled to any suitable portion near the front of rear roof panel 299rr (e.g., along a front portion of a right side (e.g., a −Y side) (e.g., along right support structure 299rrrs) of rear roof panel 299rr and/or along a front portion of a left side (e.g., a +Y side) (e.g., along left support structure 299rrls) of rear roof panel 299rr) and (ii) a front end 296rrmaf coupled to any suitable track mechanism(s) 296rrmg (e.g., gear(s) (e.g., motorized gear(s)) and/or wheel(s) (e.g., grippy wheel(s))) that may be functionally positioned within a track 296rrft that may be provided along any suitable portion of front roof panel 299rf (e.g., along a right side (e.g., a −Y side) (e.g., along right support structure 299rfrs) of front roof panel 299rf and/or along a left side (e.g., a +Y side) (e.g., along left support structure 299rfls) of front roof panel 299rf or otherwise), such that arm 296rrma may be configured to connect the front and rear roof panels and to rotate (e.g., by either motor or piston, such as by any suitable actuator 296rrra, which may be configured to rotate pivot 296rrrp and rear end 296rrmar of arm 296rrma). Middle roof repositioning actuator subsystem 296rrm may be configured such that, when rear end 296rrmar of arm 296rrma is rotated in a first direction (e.g., in the direction of arrow RT (e.g., about a Y-axis)), front end 296rrmaf of arm 296rrma may be configured to lift up such that track mechanism(s) 296rrmg coupled thereto may be configured to push against any suitable teeth 296rrftt or otherwise of track 296rrft that may run along at least a portion of the length of front roof panel 299rf such that front roof panel 299rf may be forced to slide upwards along front side 299rrf of rear roof panel 299rr (e.g., in the direction of arrow UTD) and then slide rearwards along top side 299rrt of rear roof panel 299rr (e.g., in the direction of arrow RTD), and such that, when rear end 296rrmar of arm 296rrma is rotated in a second direction (e.g., in the direction of arrow ET (e.g., about a Y-axis)), front end 296rrmaf of arm 296rrma may be configured to pull down such that track mechanism(s) 296rrmg coupled thereto may be configured to push against any suitable teeth 296rrftt or otherwise of track 296rrft that may run along at least a portion of the length of front roof panel 299rf such that front roof panel 299rf may be forced to slide forwards along top side 299rrt of rear roof panel 299rr (e.g., in the direction of arrow ETD) and then to slide downwards along front side 299rrf of rear roof panel 299rr (e.g., in the direction of arrow DTD). Such a middle roof repositioning actuator subsystem 296rrm may be provided on each side of roof 299r (e.g., along not only left support structure 299rfls and left support structure 299rrls but also along right support structure 299rfrs and right support structure 299rrrs) or just along one side of roof 299r (e.g., along only left support structure 299rfls and left support structure 299rrls but not also along right support structure 299rfrs and right support structure 299rrrs, or along only right support structure 299rfrs and right support structure 299rrrs but not also along left support structure 299rfls and left support structure 299rrls) or additionally or alternatively along a middle portion of each one of front roof panel 299rf and rear roof panel 299rr. One or more wheels 296rrgw (e.g., glider wheels) may be coupled to (e.g., rotatably coupled to) and extend from bottom 299rfb of front roof panel 299rf (e.g., at or near rear 299rfa of front roof panel 299rf) for contacting and protecting top 299rrt of rear roof panel 299rr as front roof panel 299rf may slide or roll therealong (e.g., in the direction of arrow RTD when the roof is being opened and/or in the direction of arrow ETD when the roof is being closed). Wheel(s) 296rrgw may be made of any suitable material(s), such as a non-abrasive material, such as nylon or silicone.

As shown in FIG. 5, front roof repositioning actuator subsystem 296rrf may be configured to control the relationship between front roof panel 299rf and A-pillar 297ap and may include any suitable piston or pistons that may be hydraulic, or linear actuators at front 299rff of front roof panel 299rf and/or at the rear 297apr of A-pillar 297ap (e.g., a piston subsystem that may be similar to repositioning actuator subsystem 296adfm and/or repositioning actuator subsystem 296ar and/or the like). For example, as shown in FIG. 5, front roof repositioning actuator subsystem 296rrf may include any suitable actuator assembly 526 (e.g., any suitable hydraulic actuator, electric actuator, mechanical actuator, linear actuator, and/or the like) that may be coupled to and supported by front roof panel 299rf for fixing the position of actuator assembly 526 with respect to the structural assembly of roof 299r (e.g., actuator assembly 526 may be coupled to and/or provided along any suitable portion of front roof panel 299rf (e.g., along a right side (e.g., a −Y side) (e.g., along right support structure 299rfrs) of front roof panel 299rf and/or along a left side (e.g., a +Y side) (e.g., along left support structure 299rfls) of front roof panel 299rf and/or otherwise (e.g., along a middle portion of front roof panel 299rf between sides 299rfl and 299rfr))). Front roof repositioning actuator subsystem 296rrf may be configured to pull rod 516 in the direction of arrow IP towards actuator assembly 526 (e.g., to a fully closed position whereby free end 511 of rod 516 may be held in a position aligned with front 299rff or just forward of front 299rff or just rearward of front 299rff) and to push an inner piston rod or actuator rod 516 in the direction of arrow OP away from actuator assembly 526 (e.g., to a fully open position whereby free end 511 of rod 516 may be any suitable maximum distance R away from front 299rff of front roof panel 299rf (e.g., a distance at which front roof panel 299rf may be safely supported by rear roof panel 299rr without any aid from A-pillar 297ap)). Front roof repositioning actuator subsystem 296rrf may be configured to use any suitable power sourced by vehicle 290 and may be configured to be under the control of any suitable processor capability of vehicle 290. Any suitable locking mechanism 511k may be provided at or near free end 511 of rod 516 for selectively removably coupling with any suitable locking mechanism 297apk at or near rear side 297apr of A-pillar 297ap in any suitable manner (e.g., magnets, retractable pin and socket, etc.), such that, when mechanisms 511k and 297apk are coupled to each other, free end 511 of rod 516 and, thus, actuator assembly 526 and, thus, front roof panel 299rf may be physically supported by A-pillar 297ap (e.g., a portion of the weight of front roof panel 299rf may be supported by A-pillar 297ap (e.g., as dimension R between rod end 511 and front roof panel front side 299rff grows during extension of rod 516 from actuator 526)). Alternatively, a front roof repositioning actuator subsystem 296rrf may be configured such that actuator 526 is fixed to A-pillar 297ap (e.g., within a rear center windshield console 297apc and/or along a left side 297apl and/or along a right side 297apr of A-pillar 297ap) and mechanism 511k of free end 511 of rod 516 may be configured to be selectively removably coupled to a locking mechanism at or near front side 299rff of front roof panel 299r. Alternatively, a first front roof repositioning actuator subsystem may include an actuator assembly fixed to the front roof panel and a second front roof repositioning actuator subsystem may include an actuator assembly fixed to the A-pillar, such that a free end of a rod extending from the first front roof repositioning actuator subsystem may selectively couple to a free end of a rod extending from the second front roof repositioning actuator subsystem (e.g., such that maximum dimension R may be defined partially by a length of the rod extending from the first front roof repositioning actuator subsystem and partially by a length of the rod extending from the second front roof repositioning actuator subsystem (e.g., such that each rod may be shorter in length than when only a single rod is used to create maximum dimension R)). Any suitable front roof repositioning actuator subsystem may be provided on each side of roof 299r (e.g., along not only left support structure 299rfls of front roof panel 299rf and left side 297apl of A-pillar 297ap but also along right support structure 299rfrs of front roof panel 299rf and right side 297apr of A-pillar 297ap) or just along one side of roof 299r (e.g., along only left support structure 299rfls of front roof panel 299rf and left side 297apl of A-pillar 297ap but not also along right support structure 299rfrs of front roof panel 299rf and right side 297apr of A-pillar 297ap, or along only right support structure 299rfrs of front roof panel 299rf and right side 297apr of A-pillar 297ap but not also along left support structure 299rfls of front roof panel 299rf and left side 297apl of A-pillar 297ap) or additionally or alternatively along a middle portion of each one of front roof panel 299rf and A-pillar 297ap. Therefore, in some embodiments, a piston or rod of a front roof repositioning actuator subsystem may be configured to push out from the front of the front roof panel and may be connected by electronic locks or pins to the rear end of the windshield frame (e.g., A-pillar) and extend out as the roof begins to slide back, and also retract in as it returns when closing, so that the rod may support the weight of the front roof panel as the majority of the weight shifts forward, so as to prevent the front roof panel from falling into the passenger compartment. The electronic lock or pin (e.g., locking mechanism(s) 511k/297apk) can be configured to release the piston(s) when the front roof panel has slid back sufficiently so that the weight of the front roof panel may now be resting on the rear roof panel and will not fall into the passenger compartment.

Therefore, roof repositioning actuator subsystem 296rr of vehicle roof repositioning management system 250c may be configured to use gears that may rotate against a toothed track inside the front panel, and/or wheels made of a material that may have grip (e.g., rubber) that may pull the track back, or a mix of both gear(s) and grippy wheel(s), or any other suitable track mechanism(s). The track may be toothed or textured or smooth but with the ability for the track mechanism(s) (e.g., grippy wheels) to grip the track.

Vehicle roof repositioning management system 250c may include glass panels, carbon fiber, aluminum, steel, fiberglass, and/or other solid material panels, or a mix thereof. For example, tracks may be provided on the edges of front roof panel 299fr or inset from the edges, with panels of glass in the center and on the sides, or one solid sheet of glass across a frame. Glass may be automotive glass or a polymer or mix. Main panels 299rfmp and 299rrmp may be glass, while support structure(s) 299rffs, 299rfas, 299rfls, 299rfrs, 299rrfs, 299rras, 299rrls, and/or 299rrrs may be carbon fiber, aluminum, steel, fiberglass, and/or the like that may be coupled to and extend along the periphery of the main panels or may provide frame structures on top of which the main panels may extend and be coupled to (e.g., by glue, etc.).

Rear roof repositioning actuator subsystem 296rrr may be configured to control the relationship between rear roof panel 299rr and C-pillar 297cp (see, e.g., FIGS. 2R and 2S). Rear roof repositioning actuator subsystem 296rrr may include a track 296rrrt that may be defined by trunk 294tr (e.g., by an interior left side wall and/or by an interior right side wall that may partially define trunk space 297trs) that may be configured to guide any suitable track mechanism(s) 296rrrg (e.g., gear(s) (e.g., motorized gear(s)) and/or wheel(s) (e.g., grippy wheel(s))) that may be coupled to rear roof panel 299rr (e.g., at or near the rear portion of left support structure 299rrls and/or at or near the rear portion of right support structure 299rrrs of rear roof panel 299rr) and that may be functionally positioned within track 296rrrt to slide therealong during the opening and closing of roof 299r (e.g., track mechanism(s) 296rrrg may be motorized wheels at the bottom of the rear roof panel and may be configured to slide rearward and downward into the trunk along a set path of track(s) 296rrrt) and back upward and forward along the set path). This may be safe for the users to place cargo underneath this path within trunk space 297trs and know the roof will not impact the cargo as the roof moves along the path. An additional advantage is that, because the roof is sliding back and down rather than rotating high up, it can be opened while the vehicle is in motion because it does not risk large amounts of wind force against any roof panel(s), and because if both panels are mostly glass, the driver's view will not be obstructed as the roof is sliding down.

In some embodiments, the rear roof repositioning actuator subsystem may include swing arms instead of a rear track (e.g., track(s) 296rrrt) such that once the front panel is slid over the rear panel, both panels may be lifted and placed by the swing arms down into the trunk space. Rear roof repositioning actuator subsystem may have the advantage of keeping the C-shape opening at the bottom of the roof (e.g., the downward concavity of each stacked roof panel) such that the space defined by the downward concavity of the bottom of the rear roof panel may be fully usable as it can be lowered down over any suitable cargo in trunk space 297trs). This can be enabled by either track embodiments or swing arm embodiments, as the track (e.g., track(s) 296rrrt) may be configured with a shape that can include a curve up in the middle (e.g., center) of the track to maintain that same clearance.

In some embodiments, rear roof repositioning actuator subsystem 296rrr may include a panel 296rrrn that may be positioned under rear roof panel 299rr that may be configured to slide or rotate forward or backward onto the vehicle passenger area or onto the hood of the vehicle, such that the space under the rear roof panel may be cleared and the roof can slide down into the trunk. At the same time or nearly at the same time, the trunk of the vehicle may be configured to lift up the forward side, pivoting at the rear of the trunk, to create additional room for the roof to slide into the trunk.

In some embodiments, any suitable sensors, such as sensors 295t, may be positioned in any suitable location(s) (see, e.g., FIG. 5A) and may be configured to detect additional tension on track mechanism(s) 296rrmg and/or track mechanism(s) 296rrrg and/or arm(s) 296rrma such that a user may be warned (e.g., such that a voice system can warn someone to remove their hand from the roof so it may move safely). In some embodiments, any suitable sensors, such as sensors 295u, may be positioned in any suitable location(s), such as at the top and bottom and sides or in the frame of the trunk opening (see, e.g., FIG. 2V), and may be configured to detect any suitable objects that may be in the closing or opening path of the roof such that a user may be warned (e.g., to ensure no fingers or other items are crushed by the roof closing or opening), and this may also or alternatively be monitored by sensing additional tension while opening or closing a piston rod or the like of any suitable actuator(s) of roof repositioning actuator subsystem 296rr and such sensed information may be processed by any suitable safety algorithm(s) or other suitable control application(s) of the vehicle to cause the actuator(s) to stop and/or revers their motion (e.g., slightly). In some embodiments, any suitable sensors, such as sensors 295v, may be positioned in any suitable location(s), such as in main panels 299rfmp and 299rrmp and/or trunk door 296dtr (see, e.g., FIGS. 2S and 5A), and may be configured to detect a current on the roof panels or trunk panels (e.g., the change in current from a human touching the surface that may be metallic or treated with conductive metallic material or coated in such a conductive paint or resin) and/or to detect any suitable pressure thereon, such that a user may be warned during a roof opening and/or closing event (e.g., such that a voice system can warn someone to remove their hand from the roof or trunk panels so it may move safely).

In some embodiments, any suitable actuator(s) of front roof repositioning actuator subsystem 296rrf may be configured to create a distance R between the front of the front roof panel and the rear of the A-pillar such that one or more piston rod(s) of front roof repositioning actuator subsystem 296rrf may be used to hold the front roof panel secure to the A-pillar but also open by that distance R so as to create a sunroof opening for the vehicle (e.g., a small distance of one or a few inches to perhaps a foot or more long), so the passengers can get some fresh air without opening the full roof and placing it into the trunk. This may be ideal in a situation where the trunk is full and the riders do not know what they are going to do with its contents, so they just open the roof slightly. This may provide a convertible rooftop that can also be opened slightly to provide a sunroof.

In some embodiments, a sunroof or moonroof panel may be provided by one or each of the front roof panel and/or the rear roof panel.

In some embodiments, any suitable lights (e.g., light-emitting diode (“LED”) lights), such as lights 296i, may be positioned in any suitable location(s), such as in the front and/or rear roof panels (see, e.g., FIG. 5A), and may be configured to illuminate the passenger cabin when the roof is closed.

In some embodiments, any suitable speakers, such as speakers 296j, may be positioned in any suitable location(s), such as in the front and/or rear roof panels (see, e.g., FIG. 5A), and may be configured to provide richer sound in the passenger cabin when the roof is closed.

In some embodiment, any suitable curtains or other suitable shade or privacy mechanism(s) 296k, which may be controlled automatically (e.g., based on any suitable detected conditions) and/or manually by a user, may be provided on an underside of the roof panels to provide privacy or shade when the panels are largely glass.

In some embodiments, an angle at which a curved arm of middle roof repositioning actuator subsystem 296rrm (e.g., arm 296rrma) may be rotated can be adjusted by a user such that the user can open the front panel slightly to vent the vehicle without even extending the piston(s) or otherwise of front roof repositioning actuator subsystem 296rrf at the front of the car. In such embodiments, attachment of the front roof panel to the A-pillar may be configured to include a pivot (e.g., pivot 296l (e.g., at mechanism(s) 511k/297apk)) that may be configured to allow the front panel to rotate upwards slightly toward the rear (e.g., such that a driver or passenger may get some ventilation without wind blowing into the car).

Therefore, vehicle roof repositioning management system 250c may include any suitable convertible roof opening and closing mechanism(s) that may enable the opening and closing of an automotive or other convertible roof via a smooth, fluid motion, such as by rotating an arm (e.g., a curved arm) that may lift up the rear of a front roof panel and that may have any suitable track mechanism(s) (e.g., motorized gears or wheels) onside it that may push against a track that may run a length of the front roof panel, such that the front roof panel may slide back over a rear roof panel, with only the front roof panel plus a small gap being added to the height of the vehicle during the opening and closing, and/or with one or more actuator(s) (e.g., piston rod(s)) that may extend from the front of the front panel and/or top of the windshield frame to support the weight of the front of the front panel until a portion (e.g., the majority) of the weight of the front panel is over and/or supported by the rear panel.

Any suitable counterweight 512w may be coupled to or otherwise provided by front roof panel 299rf (e.g., at or near rear 299rfr of front roof panel 299rf (e.g., at a rear end of track(s) 296rrft)), such that, as the front roof panel is lifted up (e.g., once arm 296rrma may be initially rotated in the direction of arrow RT so that the rear of the front panel is lifted up), a significant portion of the weight of the front panel (e.g., the majority of its weight (e.g., due to weight 512w)) may be over the arm already. This may be possible, especially if the front panel is made of lightweight materials such as carbon fiber and other composite materials.

In some embodiments, an arm (e.g., arm 296rrma) may be a curved arm that may be configured to be rotated back by a piston or a linear actuator or any other suitable actuator such that it may be locked into place or rotated by a motor or any other suitable actuator but then be locked into place (e.g., by the motor's torque or by a pin and hole mechanism), such that it can support the entire weight of the front panel without the front panel requiring the front pistons to support the front of the weight.

In some embodiments, rear roof repositioning actuator subsystem 296rrr may include a mounting plate or plates that can couple to the floor, roof, or wall of the trunk opening, with track 296rrrt coupled to or otherwise provided by the plate(s), or where the track may be both the plate and track (e.g., if the track is molded from aluminum or composite materials and can have the mounting plates integrated). The track may include gears or texture such that electronic wheels or gears at the bottom of the rear panel (e.g., mechanism(s) 296rrrg) may drive along the track and slide the roof up and down the track. The track may have two paths, with the rear path thicker than the front path, such that two differently sized wheels or mechanism(s) 296rrrg can slide back along the track and the large wheel (e.g., mechanism 296rrrg′) may pass over a smaller hole (e.g., hole 296rrrto) and then drop down where the track needs to make a sharp curve downward. The track may be installed under the trunk cover of a vehicle so no mechanism is exposed when the roof is pushed out and up or in and down. The tracks inside the front panel and inside the trunk may have switches (e.g., switch(es) 510s of track(s) 296rrft and/or switch(es) 510s′ of track(s) 296rrrt) and/or sensors (e.g., sensor(s) 295w of track(s) 296rrft and/or sensor(s) 295w′ of track(s) 296rrrt) to monitor movement and control the start and stop of the wheel and gear travel, such that the movement distance can be adjusted by moving the switches or adjusting settings (e.g., to adjust the distance the roof slides along the track, such as that different car models can use the same track molds even if one roof will not slide as deeply down into the trunk as another). Such sensors can also detect additional tension on the roof or track or wheels or piston controlling the arm or other components, enabling an integrated notification system to warn someone to remove their hand from the roof or trunk so it may move safely. The roof control assembly can include a sensor at the front or bottom and sides or in the trunk opening of the rear of the vehicle to ensure no fingers or other items are crushed by the roof opening, and also at the front of the front panel and rear of the windshield frame to prevent such finger crushing when the roof is closing. This may also be monitored by sensing additional tension while closing the roof which a safety algorithm would then cause the roof to stop its motion and reverse direction slightly. Such sensors can also detect if there is cargo in the trunk or cargo area, or objects on the trunk, or objects on the roof panels, which might prevent the roof from opening or closing safely.

The described technologies of vehicle roof repositioning management system 250c may provide considerable technical advantages. The described technologies can provide a convertible roof rack without needing to consume most of the trunk cargo space when the roof is opened. A roof can be opened and stowed, and closed, without complex and heavy mechanisms. The described technologies can provide the ability to hide the roof and its mechanisms entirely in the trunk of the car, and under the front panel inside tracks that may open to the bottom by less than a finger's width, out of reach of dirt, debris, or fingers, thus protecting fingers from being caught in mechanisms, and protecting the tracks from rain, snow, dirt, and/or the like when opening and closing. This is also more aesthetically pleasing as there are no visible mechanisms outside the vehicle, and only two small slits running front-back on the bottom of the front panel, and/or the two arms may be visible (and the arms can be covered by a molded cover that can be upholstered or otherwise decorated to fit in with the styling of the vehicle).

The described technologies of vehicle roof repositioning management system 250c may allow fully powered, automatic opening and closing of the convertible roof at a controlled and safe pace, providing additional comfort and convenience to passengers.

The described technologies of vehicle roof repositioning management system 250c can protect hands and other body parts from being “jammed” when sliding the roof open and may prevent injury to body and roof parts when opening the roof as opposed to roofs where the user must manually remove and stow the roof and replace the roof panel.

The described technologies of vehicle roof repositioning management system 250c can move the roof completely inside the car under the trunk over cargo area when not in use, as opposed to other roof systems that may fold the roof into biconvex or very tall multiple-folded shapes that may consume most of the cargo space. Here, the majority of the cargo space remains usable, and the roof can slide over cargo safely.

The described technologies of vehicle roof repositioning management system 250c can allow the roof and its mechanisms to be recessed into the vehicle, so the roof mechanisms are not at risk of impact or inclement weather.

The described technologies of vehicle roof repositioning management system 250c can enable movement of the roof panels to be electronically controlled, whereby sensors can determine if a finger or other object is caught between the roof panels openings and the windshield or trunk or any other nearby object, to stop and reverse movement to prevent injury.

The described roof mechanism of vehicle roof repositioning management system 250c can enable a strong, solid roof, whereby it can include mounting holes or pins 299rhps or the like such that any object with pins or holes that line up with the holes or pins can be mounted, such as a roof rack, cargo container, bicycle mount, ski mount, and similar. Sensors (e.g., sensors 295v or otherwise) may detect if these mounts are in use or if there is weight on the vehicle or a camera may detect if there are objects on the roof, so the user cannot open the roof until the objects are cleared. The same sensors and or cameras may detect if a passenger or object is sticking up in the passenger compartment to prevent the roof from closing and possibly impacting them and injuring them.

The described technologies of vehicle roof repositioning management system 250c can prevent a folded and retracted roof from opening while a passenger or object would block its path, which could injure the passenger or object.

FIGS. 2N-2X depict an example implementation of vehicle roof repositioning management system 250c installed into a four-door sedan. As shown and described herein, implementing vehicle roof repositioning management system 250c may enable roof 299r to have front roof panel 299rf slide over rear roof panel 299rr, as it begins in FIG. 2O, which also shows one or more piston(s) connecting the front of the front roof panel to the rear of the windshield or A-pillar for added weight support and security. The driver might only open the front panel this much to create ventilation.

FIG. 2O may show an arm (e.g., curved arm 296rrma) now rotated to lift the rear of the front roof panel up so it can slide over the rear roof panel. FIGS. 2O and 5A show the front of the arm has two gears (e.g., mechanisms 296rrmg) that may fit into a track inside the front panel and that may rotate, pushing the track back over the wheels, and thus pushing the front panel over the rear panel. FIGS. 2O and 5A show glider wheels that may enable the rear of the front panel to slide over the rear panel without scratching it.

As shown in FIG. 2P, the front panel may slide over the rear panel.

As show in in FIG. 2Q, a horizontal panel under the rear panel of the roof may slide forward to open the space under the roof, and the trunk may lift its forward side up, so as to open the space for the roof to slide into the cargo area.

FIG. 2R shows tracks on the inside sides of the trunk or cargo space, such that the rear panel track mechanism(s) (e.g., motorized gears or grippy wheels or the like) at the bottom of the rear panel may slide down and back along the track. A front track mechanism (e.g., mechanism 296rrrg) and track may be narrower (smaller), and a rear mechanism (e.g., mechanism 296rrrg′ (e.g., gear) and track may be wider or taller, so the rear gear can slide over a small front gap and then downward into a wider track in the event of a straight drop, and the smaller wheel straight down into the narrower track.

FIG. 2S shows the roof panels at the top of the cargo area guided into position by the track mechanism(s) at the bottom of the rear panel following the track.

FIG. 2T shows the vehicle with the roof fully down or opened.

FIG. 2U shows the front panel lifting and beginning to slide over the rear panel, the horizontal panel under the rear panel sliding forward, and the trunk lifting up front-side up to create a cavity for the roof to slide into. This is an example of how the above steps may happen concurrently and not only one after the other, to speed up the opening and closing of the roof. For example, the same can happen in reverse, whereas the roof may lift up out of the trunk as the trunk is closing on the roof so that as the rear panel completes its journey the trunk and horizontal platform under the roof close immediately after, and the front panel and windshield frame lock together at the same time as the curved arm rotates itself down.

FIG. 2V depicts the front and rear panels folded atop each other, the trunk open, and the horizontal platform under the rear panel slid open, so that the cargo cavity (e.g., trunk space 297trs) is exposed to accept the roof.

FIG. 2W shows a horizontal platform or panel (e.g., panel 296rrrn) that may slide out from under the roof and then back once the roof is closed.

FIG. 2X shows the vehicle once the roof is open all the way, and the trunk and horizontal platform are closed.

FIG. 5 shows piston(s) extended from the front of the front panel and rest on a lip (e.g., lip 296l) on the rear of the windshield frame, such that the lip may hold up the piston(s) and thus support the weight of the front panel as it slides back. FIG. 5 may also show a lock or pin that may lock into the piston(s) that can lock the front panel securely into place when rotated up but not slid back for when the driver wishes to only vent the car by lifting the front panel slightly.

FIG. 6 is a side view that shows a curved arm, where it may pivot inside the rear panel, and the front of the arm may hold two motorized gears, where the front gear may slide through a slot into the track and then the gears may push against teeth at the top of the track (and perhaps also on the bottom), thus pushing the front panel backwards. In this example, the arm may pivos by a motor power, but this pivot can also be accomplished by having the circle of the pivot pulled back around the axel by a piston or actuator or magnetic force. Two or more holes around the circumference of the pivoting circle may be configured to accept a pin that may be extended electronically to lock the arm from rotating once it is raised or lowered to a set position, for example: open, closed, vent.

FIG. 6 also shows a glider wheel or ball bearing, that may be made of nylon or silicon, at the rear of the front panel that may allow the rear of the front panel to glide across the rear panel without scratching it.

As also shown in FIG. 6, the front panel may lift and slide back slightly as the curved arm(s) rotate.

In some embodiments, the roof can be pulled or pushed out and expanded with manual power, and also folded and pushed in with manual power. For example, someone wishing to reduce weight for a race car might eliminate motors and actuators and solenoids and manually unlatch the front panel from the windshield frame, then push up the front panel and slide it back manually, lift up the trunk manually, and slide the roof mechanism into the trunk manually. This may have an advantage of maintaining the car in production configuration but eliminating weight for racing. Otherwise, the motorized gears and pistons may make things much more convenient and faster.

A power source can also be integrated with feedback mechanisms including stop switches (e.g., switch(es) 510s and/or 510s′). Such components can be configured to stop pushing (opening) or pulling (closing) the roof panels once the panels reach a desired position. Sensors, such as pressure sensors and motion sensors, can also be integrated (e.g., sensor(s) 295w and/or 295w′). Such components can be configured to adjust or stop the motion of the roof upon determining that the roof is likely to come into contact with an object or human (e.g., to prevent a panel from pinching a hand).

The referenced gears and/or pistons and/or any other suitable actuators of vehicle roof repositioning management system 250c can incorporate a position sensor or sensors that may provide feedback for other components. For example, the car's lighting can be configured to change based on the position of the roof panels (e.g., to light the interior and or the ground around the vehicle as the roof opens and to turn the lights off as it closes). In another example, the car can change the color and/or intensity of the lighting inside and outside as the roof opens and closes, to provide stylized and dramatic effects. Such effects can be customized (e.g., via the vehicle's app or infotainment system).

In another example, the car can adjust the vehicle's airflow control system. For example, if the roof is open, the car may be configured to automatically direct a spoiler to move air differently to adjust for the change in aerodynamics. In another example, if any sensor(s) detect excessive strain from wind, the vehicle may be configured to automatically raise windows or roof, so that the wind gets lifted up and passes over the vehicle or cargo.

The referenced tracks inside the trunk can include or incorporate any suitable sensors and circuits that can guide the wheels on the track such that the roof may open when the pin in the roof mechanism touch stop points on the track forcing the roof or swing arms to pivot or a lever attached to the rear panel to pivot.

In certain implementations, the referenced track and trunk cargo area can be constructed as separate components. Alternatively, the referenced track and cargo area opening can be one part or even be part of the vehicle structural assembly. For example, a carbon fiber vehicle monocoque can have the track(s) molded into it. Similarly, the tracks in the front panel can also be molded or CNC carved into the frame, such as out of aluminum, carbon fiber, and/or other suitable material(s). As another example, the track and trunk and horizontal panel control mechanisms may be a separate module that may be bolted to the bottom into an existing vehicle so as to retrofit another vehicle into a convertible.

In some embodiments, the described tracks, panels, piston, locks, tracks, trunk cover, trunk, cargo container, gears, motorized wheels, motorized gears, locks, solenoids, curved arm, axes of the circular arm pivot point, pushing mechanism housing, track mounting components, floor/side mounting components, ball bearings, rings, wheels, and/or any other components can be made from aluminum or other metals or composite materials, such as carbon fiber. They can also be made from a combination of materials. For example, the described front panel track can be made from carbon fiber but with a titanium track or teeth or liner guiding an aluminum or titanium motorized wheel attached to a titanium or another metal curved arm. It is to be understood that the type of metal and materials do not change the functionality of the mechanism but can allow the user to control for weight of the vehicle (e.g., by using titanium components instead of steel to reduce weight).

The front panel or curved arm mechanism can also include a counterweight. Such a counterweight can remain in place or push toward the opposite end of the vehicle as the front panel moves in either direction. Doing so can balance the weight of the front panel, such as that, as the front panel slides forward, weight slides back to keep the weight on the rear side of the panel.

The sensors referenced above (e.g., for motion and pressure) can be mounted on the sides or bottom of the panels, or along the tracks in the front panel, and or along the tracks in the cargo area, or at points on the tracks. In some embodiments, a sensor can also gauge power output and resistance as the wheels push, and/or as the motor or piston rotating the curved arm moves. Doing so can enable an integrated processor or computing system to determine if the roof has encountered an obstacle or if another component of the mechanism should begin to move or stop moving.

In some embodiments, the convertible roof mechanism can be controlled in various ways, such as by buttons on the outside and/or inside of the vehicle, key fob, buttons in an app or infotainment system, voice control, and/or the like. The described roof mechanism can also be activated remotely (e.g., over the internet or wireless control). The roof mechanism can also be activated via various communication protocols (e.g., RFID, NFC, etc.), fob, card, ring, bracelet, or other object, such that placing the fob (for example) next to a sensor on the outside of the vehicle may cause the roof (or roof and doors) to open and/or close.

The described roof mechanism can integrate or operate in conjunction with cameras or other visual sensors on the outside and inside of the vehicle, such that recognition of the driver and/or passenger(s) can initiate opening the roof or closing the roof. It can also close the roof if it recognizes clouds or rain or snow or people throwing objects or dust or any obstacle that might harm the passengers or the interior. The same cameras can be used to detect if a human or animal is standing on the roof to stop the vehicle because it is often unsafe for someone to ride a vehicle like it is a skateboard by standing on a roof.

The described roof mechanisms can use their sensors and power control to sync not only with all the doors and openings on the car to which they are attached, but to open and close in sync with roofs, racks, and/or doors on other vehicles (and or cabinets or garage doors and the like).

The described roof repositioning management system 250c can be used for a roof of a cabinet or workstation or room or house or any other suitable carrier.

A convertible roof control mechanism may be provided for connecting a convertible roof for a vehicle to the body of the vehicle, wherein the mechanism has an open state in which the front panel of the roof slides over the rear panel and then both panels slide into the vehicle trunk (cargo area), and an open state in which the panels from an arch and the roof covers the vehicle, the roof control mechanism including: (a) a curved arm which connects the front and rear panel, and where the arm pivots inside the front of the rear panel such that the front of the curved arm is lifted, (b) the front of the curved arm has one or more motorized gears which after the front of the curved up is pivoted upwards spin and the teeth of the gears (or the grippiness of the grippy wheels) slide a track inside the front panel backwards, so that the front panel slides over the rear panel, (c) pistons which slide out from the front of the front panel and lock into the rear of the windshield frame so as to secure the front panel of the roof to the vehicle and also to support the weight of the front panel and roof as it slides forward until the front of the front panel can rest on a ledge integrated into the rear of the windshield frame, (d) tracks on the side of the cargo area to guide motorized gears (or grippy wheels) on the bottom of the rear panel so that the rear panel (and entire roof when folded over each other) slides into the rear cargo area along the path designated by the track, (e) a track inside the front panel to guide the motorized gear(s) at the front end of the curved arm such that when the motorized gears turn the front panel slides forwards or backwards, (f) holes in the circle at the end of the curved arm at certain points such that a piston or solenoid pin can pop into the holes to lock the curved arm at a set position such as open (for when the front panel will slide over the rear), closed, or venting (for when the front panel may lift just a little to vent the car at the top), (g) a mechanism for pushing (“pushing mechanism”) out the pistons, which may be an electronic linear actuator, hydraulic actuator, or magnetic propulsion, where these may push the piston, or which may be attached to an additional piston which pushes the above mentioned piston via a rotating joint. In some embodiments, the convertible roof control mechanism may also include sensors (such as push switches) which tell the control mechanism the position of the roof (such as when it is fully opened, fully closed, about to close, and the like. In some embodiments, the convertible roof control mechanism may also include sensors which tell the control mechanism the position of the panels. In some embodiments, the convertible roof control mechanism may also include sensor(s) to detect if any object(s) block the path of the roof or panels, for example to prevent the roof from opening into an object or fingers. In some embodiments, the convertible roof control mechanism may also include sensors which detect objects between the roof panel edges and the vehicle edges so as to prevent crushing these objects. In some embodiments, the convertible roof control mechanism may also include a sensor to detect a change in electric current on the rack via metallic material in the paint such as to detect human touch on the roof panels or trunk panel. In some embodiments, the convertible roof control mechanism may also include a circuit for controlling the speed and direction of the mechanism, for gathering and processing sensor data, and/or for interacting with other devices (such as the car's infotainment system, main computer, navigation system, etc.). In some embodiments, the convertible roof control mechanism may also include camera(s) to detect if any object is or will block the path of the roof panels. The camera(s) can be used to detect a person approaching the vehicle and to open the appropriate door(s) or roof panels. For example, the cameras and integrated image recognition may detect the owner of the car and open the driver's door and the roof. These cameras can be placed on the sides of the vehicle, the roof, the inside, the mirror, the edges of the door, and may be placed in different locations so as to capture the full area around the vehicle without obstruction. In some embodiments, the convertible roof control mechanism may also include a sensor to detect pressure, so as to determine if the roof has hit an object, or if an object or animal is on the roof, and stop and reverse movement to avoid damage. In some embodiments, the convertible roof control mechanism may also include a pressure or sound sensor to detect a tap or pattern of tapping on the roof and/or trunk so as to open or close the roof and/or trunk without needing a button or handle. In some embodiments, the convertible roof control mechanism may communicate with other door control mechanisms so all doors (and even hoods, trunks, etc.) on the vehicle can open/close at the same pace. In some embodiments, the convertible roof control mechanism may also include a camera to detect that an object, such as a bicycle or cargo, on top or behind the vehicle is fully removed before the roof can be opened or closed. In some embodiments, the convertible roof control mechanism may also include a voice recognition system that allows the user(s) to close one or more panels or doors, such as by saying, “close the roof”, or “open the roof”, or “vent the roof” or “sunroof open” or “sunroof closed”, or the like. In some embodiments, the car (or cabinets) lighting changes based on the position of the roof panels, for example to light the ground around the vehicle as the roof opens and to turn the lights off as it closes. Another example, the car might change the color and/or intensity of the lighting inside and outside as the roof panels open and close, to provide stylized and dramatic effects. In some embodiments, a user can adjust and program these effects to their liking via the vehicle's app or infotainment system. In some embodiments, the convertible roof control mechanism may also include cameras detect that the owner is approaching with a bicycle and pop-out a rooftop bike mount, or close the roof so that the owner can place the bike and mount. In some embodiments, the convertible roof control mechanism may also include cameras or other sensors detect rain or other weather conditions and close the roof even if the driver is not nearby. In some embodiments, the car (or cabinet/room) can adjust the airflow control system, such as spoilers, flaps, windows, roof, fans, or any combination of them as the roof opens or closes. In some embodiments, the convertible roof control mechanism may lock or unlock components, or activate a component, such as a cargo cover which pulls out over the cargo and under the roof to prevent objects from bouncing up and into the roof. Another example may be that with the roof opening doors or mounts inside the trunk are locked to prevent them from being opened and impeding or impacting the roof as it slides into the trunk. In some embodiments, the mechanism lowers the windows as the roof opens to prevent the roof from impacting the windows and lifts the windows once the roof is closed. In this example, the windows would automatically be lowered when the roof is closing to prevent the roof from impacting the edge of a glass window as the roof slides closed.

As mentioned, although many aspects of repositioning management systems may be described with respect to repositioning objects (e.g., doors, roofs, racks, etc.) of a vehicle, it is to be understood that these systems may be used with respect to repositioning such objects of any suitable object carrier, such as a cabinet (e.g., a kitchen cabinet), a home or room (e.g., with a retractable roof or door or exterior rack), a wall with a rack or door, and/or the like.

One, some, or all of the processes described with respect to FIGS. 1-6 and otherwise may each be partially or entirely implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of FIG. 1A). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one subsystem to another directly or via any suitable network or bus or the like. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of system 1 may be stored in or otherwise accessible to a subsystem (e.g., subsystem 120) in any suitable manner (e.g., in memory 13 (e.g., as at least a portion of application 19)). Any or each module of system 1 may be implemented using any suitable technologies (e.g., as one or more integrated circuit devices), and different modules may or may not be identical in structure, capabilities, and operation. Any or all of the modules or other components of system 1 may be mounted on an expansion card, mounted directly on a system motherboard, or integrated into a system chipset component (e.g., into a “north bridge” chip).

Any or each module of system 1 may be a dedicated system implemented using one or more expansion cards adapted for various bus standards. For example, all of the modules may be mounted on different interconnected expansion cards or all of the modules may be mounted on one expansion card. With respect to system 1, by way of example only, modules of system 1 may interface with a motherboard or processor assembly 12 (e.g., of subsystem 120) through an expansion slot (e.g., a peripheral component interconnect (“PCI”) slot or a PCI express slot).

Alternatively, modules of system 1 need not be removable but may include one or more dedicated modules that may include memory (e.g., RAM) dedicated to the utilization of the module. In other embodiments, modules of system 1 may be at least partially integrated into a subsystem (e.g., subsystem 120 (e.g., a server)). For example, a module of system 1 may utilize a portion of memory 13 of a subsystem. Any or each module of system 1 may include its own processing circuitry and/or memory. Alternatively, any or each module of system 1 may share processing circuitry and/or memory with any other module of system 1 and/or processor assembly 12 and/or memory assembly 13 of a subsystem (e.g., subsystem 120).

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM.

The computer-readable medium also can include any non-volatile semiconductor memory, such as ROM, PROM, EPROM, EEPROM, NVRAM, flash, nvSRAM, FeRAM, FeTRAM, NIRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both, To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As may be used in this specification and any claims of this application, the terms “base station,” “receiver,” “computer,” “server,” “processor” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item), The phrases “at least one of” does not require selection of at least one of each item listed; rather, the phrase allows a meaning that includes at least one of any one of the items, and/or at least one of any combination of the items, and/or at least one of each of the items, By way of example, the phrases “at least one of A, B, and C” or “at least one of A, B, or C” may each refer to only A, only B, or only C; any combination of A. B, and C; and/or at least one of each of A, B, and C, The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As may be used herein, the terms “computer,” “personal computer,” “device,” “computing device,” “router device,” and “controller device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As may be used herein, the terms “component,” “module,” and “system,” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more, Pronouns in the masculine (e.g., his) include the feminine and neuter/neutral gender (e.g., her and its and they) and vice versa, Headings and subheadings, if any, are used for convenience only and do not limit the subject disclosure.

While there have been described systems, methods, and computer-readable media for object repositioning management, many changes may be made therein without departing from the spirit and scope of the subject matter described herein in any way. It should also be noted that while the technologies described herein may be illustrated primarily with respect to control mechanisms (e.g., door control mechanisms, rack control mechanisms, and roof control mechanisms) of a vehicle, the described technologies can also be implemented in any number of additional or alternative settings or contexts (e.g., carriers, such as cabinets, rooms, etc.) and towards any number of additional objectives. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

Therefore, those skilled in the art will appreciate that the concepts of the disclosure can be practiced by other than the described embodiments, which are presented for purposes of illustration rather than of limitation.

1-24. (canceled)

25. A vehicle comprising:
a structural assembly defining at least a portion of a passenger cabin space;
a rack assembly;
a rack sleeve coupled to the structural assembly and defining a rack holding space; and
a rack repositioning management system configured to:
longitudinally move the rack assembly by an extension distance along a longitudinal axis between:
a first rack assembly position where an expandable portion of the rack assembly is positioned inside the rack holding space in a contracted rack assembly configuration; and
a second rack assembly position where the expandable portion of the rack assembly is positioned outside the rack holding space in the contracted rack assembly configuration; and
laterally move a lateral portion of the expandable portion of the rack assembly by a lateral expansion distance along a latitudinal axis between:
the second rack assembly position; and
a third rack assembly position where the expandable portion of the rack assembly is positioned outside the rack holding space in a laterally expanded rack assembly configuration.

26. The vehicle of claim 25, wherein the rack repositioning management system comprises:
a tube coupled to the structural assembly, wherein the tube defines a hollow passageway extending between a first tube end and a second tube end along the longitudinal axis;
a rod extending between a first rod end and a second rod end coupled to the rack assembly, wherein a portion of the rod extends through the hollow passageway between the first tube end and the second tube end; and
an actuator assembly coupled to the first rod end and configured to move the rod along the longitudinal axis.

27. The vehicle of claim 26, wherein:
a track is defined by an exterior surface of the rod; and
the tube comprises a pin that extends into the track.

28. The vehicle of claim 26, wherein:
a track is defined by the tube; and
the rod comprises a pin that extends into the track.

29. The vehicle of claim 26, wherein the tube is coupled to the structural assembly below a floorboard of the vehicle.

30. The vehicle of claim 26, wherein the tube is coupled to the structural assembly outside of the passenger cabin space.

31. The vehicle of claim 26, further comprising:
a weight track extending through a portion of the vehicle along the longitudinal axis; and
a counterweight, wherein the rack repositioning management system is further configured to move the counterweight along the weight track when the rack assembly is longitudinally moved between the first rack assembly position and the second rack assembly position.

32. The vehicle of claim 26, wherein the actuator assembly comprises a hydraulic actuator configured to move the rod along the longitudinal axis.

33. The vehicle of claim 26, wherein the actuator assembly comprises an electric actuator configured to move the rod along the longitudinal axis.

34. The vehicle of claim 26, wherein the actuator assembly comprises a mechanical actuator configured to move the rod along the longitudinal axis.

35. The vehicle of claim 26, wherein the actuator assembly comprises a linear actuator configured to move the rod along the longitudinal axis.

36. The vehicle of claim 25, wherein:
the structural assembly comprises a vehicle monocoque; and
the rack sleeve is molded into the vehicle monocoque.

37. The vehicle of claim 25, further comprising a sensor subsystem configured to determine when cargo is no longer supported by the rack assembly and a user is no longer withing a threshold distance of the rack assembly, wherein, in response to that determination, the rack repositioning management system configured to automatically move the rack assembly from the second rack assembly position to the first rack assembly position.

38. The vehicle of claim 25, wherein the latitudinal axis is perpendicular to the longitudinal axis.

39. The vehicle of claim 25, wherein the rack repositioning management system is further configured to vertically move a vertical portion of the expandable portion of the rack assembly by a vertical expansion distance along a vertical axis between:
the third rack assembly position; and
a fourth rack assembly position where the expandable portion of the rack assembly is positioned outside the rack holding space in a vertically expanded rack assembly configuration.

40. The vehicle of claim 39, wherein the vertical axis is perpendicular to the longitudinal axis.

41. The vehicle of claim 39, wherein the vertical axis is perpendicular to the latitudinal axis.

42. The vehicle of claim 39, wherein:
the latitudinal axis is perpendicular to the longitudinal axis
the vertical axis is perpendicular to the longitudinal axis; and
the vertical axis is perpendicular to the latitudinal axis.

43. A vehicle comprising:
a structural assembly;
a rack assembly; and
a rack repositioning management system for moving the rack assembly with respect to the structural assembly, the rack repositioning management system comprising:
a tube coupled to the structural assembly, wherein the tube defines a hollow passageway extending between a first tube end and a second tube end along an extension axis;
a rod extending between a first rod end and a second rod end coupled to the rack assembly, wherein a portion of the rod extends through the hollow passageway between the first tube end and the second tube end; and
an actuator assembly coupled to the first rod end and configured to move the rod along the extension axis.

44. A method for managing a vehicle that comprises a structural assembly; a rack sleeve coupled to the structural assembly and defining a rack holding space, a rack assembly, and a rack repositioning management system, the method comprising:
using the rack repositioning management system, longitudinally moving the rack assembly by an extension distance along a longitudinal axis between:
a first rack assembly position where an expandable portion of the rack assembly is positioned inside the rack holding space in a contracted rack assembly configuration; and
a second rack assembly position where the expandable portion of the rack assembly is positioned outside the rack holding space in the contracted rack assembly configuration; and
using the rack repositioning management system, expanding a portion of the expandable portion of the rack assembly between:
the second rack assembly position; and
a third rack assembly position where the expandable portion of the rack assembly is positioned outside the rack holding space in an expanded rack assembly configuration.
